(19) United States
(12) Patent Application Publication
(10) Pub. No.: US 2026/0057203 A1
(43) Pub. Date: Feb. 26, 2026

(54) CODE READER SYSTEM, READING STABILITY ESTIMATION METHOD, AND SIMULATION DEVICE

(71) Applicant: Keyence Corporation, Osaka (JP)

(72) Inventors: Yusuke HANADA, Osaka (JP); Hiroyuki MAEDA, Osaka (JP); Hiroomi OHORI, Osaka (JP)

(73) Assignee: Keyence Corporation, Osaka (JP)

(21) Appl. No.: 19/251,858

(22) Filed: Jun. 27, 2025

(30) Foreign Application Priority Data
Aug. 21, 2024 (JP) 2024-140101
Jan. 24, 2025 (JP) 2025-010338

(51) Int. Cl. G06K 7/14; G06T 7/00; G06T 7/62; G06T 7/70; G06T 11/20

(52) U.S. Cl. CPC G06K 7/1443; G06T 7/0004; G06T 7/62; G06T 7/70; G06T 11/206; G06T 2200/24; G06T 2207/20021; G06T 2207/30164

(57) ABSTRACT

To prevent reading errors of codes attached to workpieces being transported in logistics. A code reader system comprises: one or more sensors that detect a workpiece and measure dimensions of the workpiece; one or more cameras that capture at least one image of the workpiece; a decoding unit that performs decoding processing on at least one image; an output unit that outputs information indicating the reading stability for each surface of the workpiece using one or more cameras, based on installation information of the one or more sensors, installation information of the one or more cameras, conveying speed, and the workpiece dimensions; and a screen generation unit that generates a screen to display on a display device the results of the decoding processing of the code attached to the workpiece and information indicating the reading stability for each surface of the workpiece.

### CROSS-REFERENCE TO RELATED APPLICATIONS

The present application claims foreign priority based on Japanese Patent Application No. 2024-140101, filed Aug. 21, 2024 and No. 2025-010338, filed Jan. 24, 2025, the contents of which are incorporated herein by references.

### BACKGROUND OF THE INVENTION

### 1. Technical Field

The present disclosure relates to a code reader system, a reading stability estimation method, and a simulation device.

### 2. Description of the Related Art

For example, the code reader system disclosed in JP 2014-157519 A is configured to execute decoding processing of captured images taken by a camera, calculate the reading margin when decoding is successful, and be capable of transmitting the calculated reading margin to a setting device.

The reading margin transmitted to the setting device is displayed on a display unit along with the captured image and the success or failure of decoding.

By displaying the reading margin on the display unit as in JP 2014-157519 A, the user can adjust the mounting position and installation angle of the code reader, as well as the position and inclination of the printing surface of the workpiece, while observing the reading margin. This can prevent reading errors in advance at production sites where the same type of workpieces with the same type of codes attached at common positions are transported in alignment.

However, in logistics sites, for example, the size and shape of workpieces (packages/luggage), the distance between workpieces, and the position (surface) where codes are attached are not as well-aligned as in production sites. Therefore, adopting the reading stability described in JP 2014-157519 A in logistics sites could be difficult relative to production sites.

### SUMMARY OF THE INVENTION

The present disclosure has been made in view of such points, and its objective is to prevent in advance reading errors of codes attached to workpieces transported in logistics.

To achieve the above objective, one aspect of this disclosure can be premised on a code reader system that reads codes attached to workpieces conveyed on a conveyor. The code reader system includes one or more cameras that capture images of the workpiece and generate at least one image, and a controller connected to the one or more cameras that acquires the at least one image. The controller can, based on coordinate transformation coefficients between the imaging coordinate system of the one or more cameras and the conveyor coordinate system, identify at least one surface of multiple surfaces of the workpiece in the at least one image, measure evaluation data including at least either capture information including at least either the area of the imaged region within at least one surface of the multiple surfaces of the workpiece captured by the one or more cameras based on the at least one image and the number of times the at least one surface was imaged, or information related to reading the code attached to the at least one surface, and output information indicating the stability of reading using the one or more cameras for each of the at least one surface of the workpiece based on the evaluation data.

Another aspect of this disclosure can be premised on a reading stability estimation method for a code reader system that estimates the stability of reading a code attached to a workpiece conveyed on a conveyor. The reading stability estimation method for the code reader system includes:
a step of capturing at least one image of the workpiece using one or more cameras;
a step of identifying at least one surface of multiple surfaces of the workpiece in the at least one image based on coordinate transformation coefficients between an imaging coordinate system of the one or more cameras and a conveyor coordinate system;
a step of measuring evaluation data including at least one of capture information, which includes at least one of an area of the imaged region within at least one surface of the multiple surfaces of the workpiece and the number of times the at least one surface was captured by the one or more cameras based on the at least one image, and information related to reading the code attached to the at least one surface;
and a step of outputting information indicating the stability of reading using the one or more cameras for each of the at least one surface of the workpiece based on the evaluation data.

In another aspect of this disclosure, a simulation device can be premised that performs a simulation of a code reader system that reads codes attached to workpieces conveyed on a conveyor using one or more cameras. The simulation device includes an input acceptance unit that accepts input information for use in the simulation from a user, including installation conditions of the one or more cameras and transport conditions of the workpieces, and a control unit that executes the simulation based on the input information accepted by the input acceptance unit. The control unit can transport a virtual workpiece having multiple surfaces based on the transport conditions, acquire an existence area of the virtual workpiece in an image when captured by one or more virtual cameras virtually installed based on the installation conditions, specify at least one surface of the multiple surfaces of the virtual workpiece in at least one virtual image based on coordinate transformation coefficients between the imaging coordinate system of the one or more virtual cameras and the virtual conveyor coordinate system, measure evaluation data including at least either capture information including at least either the area of the captured region within at least one surface of the multiple surfaces of the virtual workpiece and the number of times the at least one surface was captured by the one or more virtual cameras, or information related to reading the code attached to the at least one surface, based on at least one virtual image, and output information indicating the stability of reading using the one or more virtual cameras for each of the at least one surface of the virtual workpiece based on the evaluation data.

Therefore, even in logistics sites where, for example, the size and shape of workpieces being transported, the distance between transported workpieces, and the position (surface) where codes are attached to workpieces are not as well-aligned as in production sites, it is possible to acquire evaluation data including at least one of capture information including at least one of the area of the imaged region within at least one surface of multiple surfaces of the workpiece and the number of times at least one surface was imaged, and information related to reading the code attached to the at least one surface. Based on this evaluation data, information indicating the stability of reading using a camera can be output, allowing for the adjustment of the camera's mounting position and installation angle in advance to prevent reading errors.

As explained above, even in logistics sites where the sizes, etc. of workpieces are varied, it is possible to prevent in advance reading errors of codes attached to the workpieces.

### BRIEF DESCRIPTION OF THE DRAWINGS

FIG. 1 is a schematic configuration diagram of a code reader system according to an embodiment of the present invention.

FIG. 2 is a diagram explaining operation example 1 of the code reader system.

FIG. 3 is a plan view explaining operation example 2 of the code reader system.

FIG. 4A is a plan view explaining operation example 2 of the code reader system.

FIG. 4B is a side view explaining operation example 2 of the code reader system.

FIG. 5 is a block diagram of the code reader.

FIG. 6 is a diagram showing the positional relationships from the trigger point to the output point.

FIG. 7 is a diagram showing an example of the connection form between the controller and the code reader.

FIG. 8 is a diagram explaining the positional relationship between the code reader and the conveyor.

FIG. 9 is a block diagram of the controller.

FIG. 10 is a timing chart in the case where multiple code readers are provided.

FIG. 11 is a diagram explaining the details of the timing chart shown in FIG. 10.

FIG. 12 is a timing chart in the case where the illumination units of multiple code readers are simultaneously turned on.

FIG. 13 is a timing chart in the case where the illumination cycle and imaging cycle are common for all code readers.

FIG. 14 is a timing chart in the case where the illumination cycle and imaging cycle differ for each

FIG. 15 is a timing chart in the case where the illumination cycle and imaging cycle differ for each code reader and for each code reader unit.

FIG. 16 is a diagram explaining the imaging area when multiple workpieces are approaching in the conveying direction.

FIG. 17 is a diagram explaining the mask area when multiple workpieces are approaching in the conveying direction.

FIG. 18 is a diagram showing the imaging area when using a custom sensor.

FIG. 19 is a diagram showing the readout direction of the custom sensor.

FIG. 20 is a diagram showing the installation information acquired by the acquisition unit during calibration.

FIG. 21 is a diagram showing the calculation results of the position and installation angle of each code reader in the conveyor coordinate system.

FIG. 22 is a diagram showing the camera information acquired by the acquisition unit during calibration.

FIG. 23 shows the conversion formula used when converting the conveyor coordinate system to the imaging unit coordinate system.

FIG. 24 shows the conversion formula used when converting the imaging unit coordinate system to the image sensor coordinate system.

FIG. 25 is a diagram showing an example of the calibration model.

FIG. 26 is an equivalent figure to FIG. 25 after accepting changes to the position parameters of the code reader.

FIG. 27 is an equivalent figure to FIG. 25 showing an example of displaying an image of a conveyed workpiece.

FIG. 28 is an equivalent figure to FIG. 27 when the edge display line is aligned with the workpiece.

FIG. 29 is an equivalent figure to FIG. 25 in the case where the code reader is installed to capture images from the upstream side at the side of the workpiece.

FIG. 30 is an equivalent figure to FIG. 29 showing an example of displaying an image of a conveyed workpiece.

FIG. 31 is an equivalent figure to FIG. 25 in the case where the code reader is installed to capture images from the downstream side at the side of the workpiece.

FIG. 32 is an equivalent figure to FIG. 31 showing an example of displaying an image of a conveyed workpiece.

FIG. 33 is a diagram related to a variation where the code reader is installed to capture images from the upstream side at the side of the workpiece.

FIG. 34 is an equivalent figure to FIG. 33 showing an example of displaying an image of a conveyed workpiece.

FIG. 35 is a diagram related to a variation where the code reader is installed to capture images from the downstream side at the side of the workpiece.

FIG. 36 is an equivalent figure to FIG. 35 showing an example of displaying an image of a conveyed workpiece.

FIG. 37 is a block diagram of the collection and analysis device.

FIG. 38 is a flowchart showing an example of the process flow from image capture to image storage.

FIG. 39 is a diagram showing an example of the image display user interface screen.

FIG. 40 is a flowchart showing an example of the procedure from decoding process to log appending.

FIG. 41 is a block diagram showing the case where images are accumulated in each collection and analysis device.

FIG. 42 is a flowchart showing an example of the controller's control flow during the setup of the code reader system.

FIG. 43 is a flowchart showing an example of the controller's control flow during the operation of the code reader system.

FIG. 44 is a flowchart showing an example of the capture information calculation process.

FIG. 45 is a diagram explaining the case where the top surface of the workpiece is divided into multiple grid cells.

FIG. 46 is a diagram explaining an example of the capture count map after the first count up is completed.

FIG. 47 is a diagram explaining an example of the capture count map after the second count up is completed.

FIG. 48 is a diagram explaining an example of the capture rate calculation method.

FIG. 49 is a diagram explaining an example of the capture count calculation method.

FIG. 50 is a diagram explaining another example of the capture rate calculation method.

FIG. 51 is a diagram explaining an example of calculating the capture score by the code reader installed downstream in the workpiece conveying direction.

FIG. 52 is a diagram explaining an example of calculating the capture score by the code reader installed upstream in the workpiece conveying direction.

FIG. 53 is an equivalent figure to FIG. 51 in the case where the capture count is averaged.

FIG. 54 is an equivalent figure to FIG. 52 in the case where the capture count is averaged.

FIG. 55 is a block diagram of a controller with simulation function.

FIG. 56 is a diagram showing an example of the display screen for the simulation function.

FIG. 57 is a diagram showing an example of the display screen for the virtual conveyor and virtual workpiece.

FIG. 58 is a diagram showing an example of the display screen for the estimated reading stability.

FIG. 59 is a block diagram of the simulation device.

FIG. 60 is a diagram showing an example of a screen displaying the workpiece being conveyed in animation format.

FIG. 61 is an equivalent figure to FIG. 60 including a screen displaying information indicating the stability of reading.

FIG. 62 is a diagram showing a view from the right side of the workpiece with reading stability indicated.

FIG. 63 is a diagram showing a view from the rear of the workpiece with reading stability indicated.

FIG. 64 is an example of information indicating the reading stability of codes attached to each surface of the workpiece.

FIG. 65 is an example of probability information indicating the probability of codes being attached to each surface of the workpiece.

FIG. 66 is an example of displaying the estimated reading probability per workpiece.

FIG. 67 is an equivalent figure to FIG. 61 in the case of confirming the reading stability of multiple workpieces.

FIG. 68 is an equivalent figure to FIG. 67 showing the case where workpieces with tight gaps between loads are being conveyed.

### DETAILED DESCRIPTION

The following is a detailed explanation of the embodiments of the present invention based on the drawings. It should be noted that the description of the following preferred embodiments is essentially illustrative and is not intended to limit the invention, its applications, or its uses.

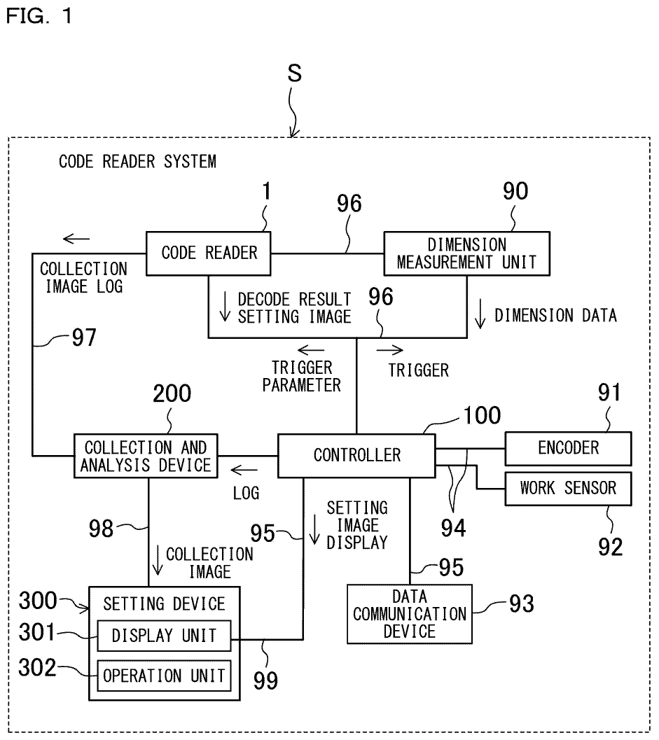

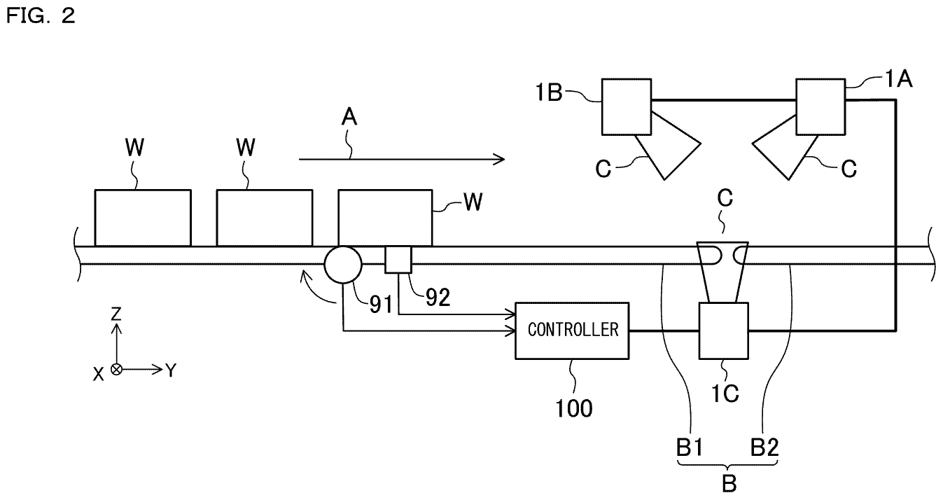

FIG. 1 is a diagram showing the schematic configuration of a code reader system S having a code reader 1 according to an embodiment of the present invention. FIGS. 2, 3, 4A, and 4B are diagrams explaining operation examples 1 and 2 of the code reader system S. These operation examples 1 and 2 show cases where the code reader system S is used in a logistics site handling multiple workpieces W.

In logistics sites, there may be cases where the size of the conveyed workpieces W, the distance between conveyed workpieces W, the position (surface) where codes are attached to workpieces W, and the types of codes attached to workpieces W are all varied. Regarding the size of workpieces W, for example, the height dimension, width dimension, and depth dimension of workpieces W may be varied. Concerning the distance between conveyed workpieces W, there may be cases where the distance between workpieces W is short or long. As for the position (surface) where codes are attached to workpieces W, codes may be attached to the side surface, top surface, or bottom surface of workpieces W. In logistics sites, there may also be cases where only the size of workpieces W is varied, only the distance between workpieces W is varied, only the position (surface) where codes are attached to workpieces W is varied, or only the types of codes attached to workpieces W are varied.

Regarding the types of codes attached to the workpiece W, they can be broadly divided into barcodes and two-dimensional codes. Among these, examples of two-dimensional codes include QR code (registered trademark), Micro QR code, Data matrix (Data code), Veri code, Aztec code, PDF417, Maxi code, and others. Two-dimensional codes can be either stacked or matrix type. The code may be attached by directly printing or engraving on the workpiece W, or by printing on a label and then affixing it to the workpiece W, and there are various means and methods for doing so. The code reader system S of this embodiment is capable of handling these various cases.

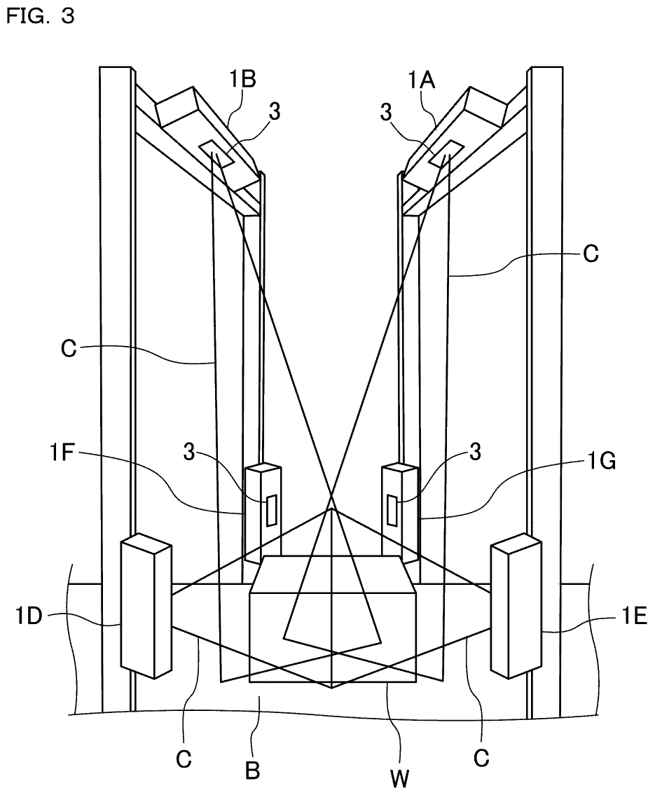

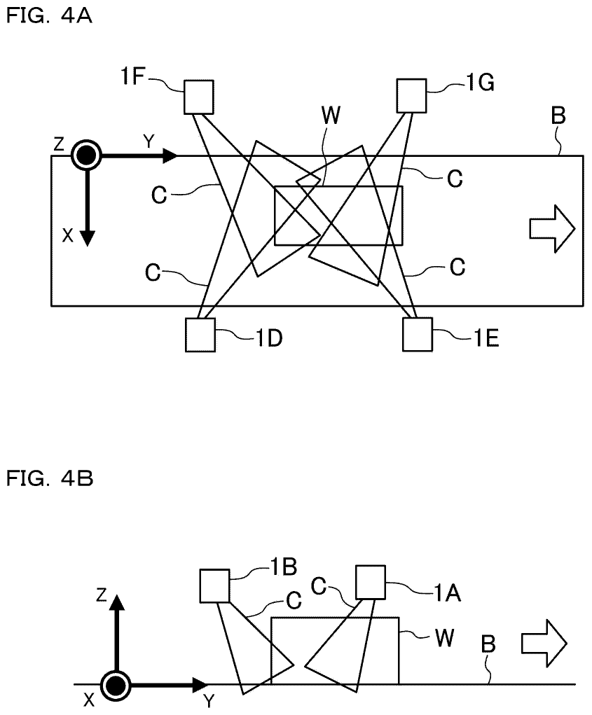

A conveyor B for sequentially transporting multiple workpieces W in a predetermined conveying direction is installed at the logistics site. The conveying direction of the workpieces W is indicated by arrow A in FIG. 2, and therefore, the left side in FIG. 2, FIG. 3, FIG. 4A, and FIG. 4B corresponds to the upstream side of the conveying direction, while the right side corresponds to the downstream side of the conveying direction.

As shown in FIG. 2, the conveyor B has multiple conveying mechanisms B1, B2. Each conveying mechanism B1, B2 is composed of, for example, a belt conveyor or roller conveyor, and includes an upstream conveying mechanism B1 and a downstream conveying mechanism B2. The top surfaces of the upstream conveying mechanism B1 and the downstream conveying mechanism B2 serve as the conveying surface. In this embodiment, the conveying direction of the workpiece W is defined as the Y direction, the direction perpendicular to the Y direction on the conveying surface is defined as the X direction, and the direction perpendicular to both X and Y directions is defined as the Z direction. In logistics sites, the X and Y directions are often approximately horizontal, but there are cases where the Y direction is inclined relative to the horizontal plane. The X direction can also be called the width direction of the conveying mechanisms B1, B2, or the longitudinal direction of the gap in the conveyor B. Also, the Z direction can be called the height direction (vertical direction). It should be noted that this definition of directions is for the convenience of explanation and does not limit the direction during use.

The upstream conveying mechanism B1 and the downstream conveying mechanism B2 are provided with a spacing in the conveying direction. The size (dimension) of the spacing between the upstream conveying mechanism B1 and the downstream conveying mechanism B2 is not particularly limited, but it is set so that the smallest workpiece W to be conveyed does not fall through the gap and is smoothly transferred from the upstream conveying mechanism B1 to the downstream conveying mechanism B2. The longitudinal dimension (X-direction dimension) of the gap is about the same as the width (X-direction dimension) of the conveying mechanisms B1 and B2, but this is also not particularly limited.

The number of code readers 1 included in the code reader system S may be one or multiple. The code reader 1 in this embodiment is stationary. The operation time of this stationary code reader 1 is when it is performing the action of sequentially reading codes of workpieces W conveyed by the conveyor B. The code reader 1 is fixed to an unillustrated frame, stand, bracket, etc. In this embodiment, we will explain the case where the code reader system S has multiple code readers 1. In the operation example 1 shown in FIG. 2, three code readers 1 are used, and the field of view of each code reader 1 is indicated by the symbol C.

In the case of having multiple code readers 1, the multiple code readers 1 can be installed so as to surround the workpiece W. Specifically, the code reader 1 in operation example 1 includes an upstream oblique reading code reader 1A installed to be able to read the code attached to the workpiece W from the upstream side above the workpiece W, a downstream oblique reading code reader 1B installed to be able to read the code attached to the workpiece W from the downstream side above the workpiece W, and a bottom reading code reader 1C. The bottom reading code reader 1C is installed below the conveyor B so that the gap between the upstream conveying mechanism B1 and the downstream conveying mechanism B2 is within its field of view C.

Since the gap between the upstream conveying mechanism B1 and the downstream conveying mechanism B2 is within the field of view C of the bottom-reading code reader 1C, when the bottom surface of the workpiece W being conveyed passes through the gap, the bottom surface can be captured by the code reader 1C. A code may be attached to the bottom surface of the workpiece W. When a code is attached to the bottom surface of the workpiece W, since the code reader 1 is installed at a position below the conveying surface of the conveyor B, the code attached to the bottom surface of the workpiece W can be read through the gap from below the conveying surface of the conveyor B.

The imaging unit 3 of the bottom reading code reader 1C is a bottom camera that continuously captures images of the bottom surface of the workpiece W exposed through gaps in the conveyor B and included in the depth of field of the imaging unit 3, outputting multiple images containing parts of the code attached to the bottom surface of the workpiece W. After multiple images containing parts of the code in the conveying direction are sequentially output from the image sensor 31b, these images can be combined to obtain the code image attached to the bottom surface of the workpiece W.

Multiple bottom-reading code readers 1C can be installed. In this case, a configuration can be adopted where multiple imaging units 3 and multiple illumination units 2 corresponding to these multiple imaging units 3 are provided, targeting the gap of the common conveyor B as the reading target from below the conveying surface of the conveyor B.

FIG. 3 shows the arrangement of code readers 1A, 1B, 1D, 1E, 1F, and 1G in operation example 2. FIG. 4A shows a view of code readers 1D to 1G in operation example 2 as seen from above conveyor B, and FIG. 4B shows a view of code readers 1A and 1B in operation example 2 as seen from the side of conveyor B. In operation example 2, six code readers are used. Specifically, code reader 1A targets the top surface and front surface of workpiece W for imaging, code reader 1B targets the top surface and rear surface of workpiece W for imaging, code reader 1D targets the side surface (right side in the conveying direction) and rear surface of workpiece W for imaging, code reader 1E targets the side surface (right side in the conveying direction) and front surface of workpiece W for imaging, code reader 1F targets the side surface (left side in the conveying direction) and rear surface of workpiece W for imaging, and code reader 1G targets the side surface (left side in the conveying direction) and front surface of workpiece W for imaging.

The code reader system in this embodiment is not limited to operation examples 1 and 2, but can also combine operation examples 1 and 2 arbitrarily. For instance, in operation example 2, the bottom-reading code reader 1C from operation example 1 may be additionally installed. The code reader 1 can also be installed in locations other than those in operation examples 1 and 2. In operation examples 1 and 2, multiple code readers 1 can capture different work surfaces of the same workpiece W as imaging targets. Furthermore, when using multiple code readers 1, they can all be the same type of code reader or different types of code readers. In the following explanation, it is assumed that all are the same code reader 1.

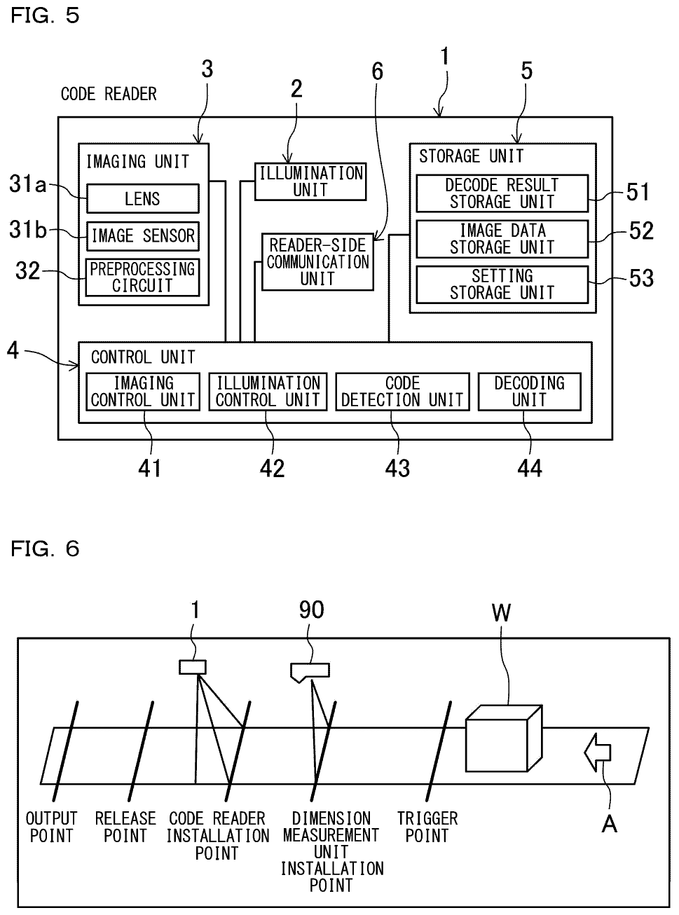

FIG. 5 is a block diagram of the code reader 1. The code reader 1 includes an illumination unit 2, an imaging unit (camera) 3, a control unit 4, a storage unit 5, and a reader-side communication unit 6. The control unit 4 includes an imaging control unit 41 that controls the imaging unit 3, an illumination control unit 42 that controls the illumination unit 2, a code detection unit 43, and a decoding unit (decoder) 44. Additionally, the storage unit 5 has a decode result storage unit 51, an image data storage unit 52, and a setting storage unit 53. The decode result storage unit 51, image data storage unit 52, and setting storage unit 53 can be configured using readable and writable storage devices such as SSDs (Solid State Drives). Although not shown, the decode result storage unit 51, image data storage unit 52, and setting storage unit 53 may be provided in separate storage devices.

The reader-side communication unit 6 is a part that executes communication with various external devices (details will be described later). Setting information etc. transmitted from external devices is received by the control unit 4 via the reader-side communication unit 6. Also, the read start trigger signal from external devices is received by the control unit 4 via the reader-side communication unit 6. The decode result by the code reader 1 is transmitted to external devices via the reader-side communication unit 6. Moreover, the reader-side communication unit 6 also receives, for example, the dimensions of gaps formed between multiple conveying mechanisms B1, B2 that the conveyor B has, and the conveying speed of the conveyor B. The dimensions of gaps and conveying speed can be input in advance by the user to the external device. The input gap dimensions and conveying speed are stored in the external device, and after being transmitted from that external device, the gap dimensions and conveying speed are received and acquired by the reader-side communication unit 6.

The illumination unit 2 is a part that irradiates illumination light onto the workpiece W being transported on the conveyor B. In the case of operation example 1 shown in FIG. 2, since the bottom-reading code reader 1C is installed below the conveying surface of the conveyor B, the illumination unit 2 irradiates illumination light from below the conveying surface towards the gap between the upstream conveying mechanism B1 and the downstream conveying mechanism B2. As a result, when the bottom surface of the workpiece W being transported passes through the gap between the upstream conveying mechanism B1 and the downstream conveying mechanism B2, that bottom surface can be illuminated by the illumination unit 2. If a code is attached to the bottom surface of the workpiece W, the code attached to the bottom surface of the workpiece W can be illuminated by the illumination unit 2. The illumination unit 2 is equipped with a light-emitting body consisting of, for example, a Light Emission Diode (LED), etc.

The illumination unit 2 and the imaging unit 3 may be integrated or may be separate. The illumination unit 2 is controlled by the illumination control unit 42, which switches between turning on and off, and changes the brightness when illuminated. When a read start trigger signal is input from an external device, the illumination control unit 42 turns on the illumination unit 2 for a predetermined time and turns it off after the predetermined time has elapsed.

The imaging unit 3 is a part that generates an image based on reflected light from a code attached to a workpiece W conveyed on the conveyor B. The imaging unit 3 can generate a code image containing the code by capturing an image of the workpiece W, and output it to the control unit 4. The imaging unit 3 has a lens 31a, an image sensor 31b, and a preprocessing circuit 32. The lens 31a is an imaging lens that focuses reflected light from the workpiece W. Light incident on the lens 31a is emitted towards the light-receiving surface of the image sensor 31b and forms an image on the light-receiving surface.

The image sensor 31b includes a light-receiving element such as a CCD (charge-coupled device) or CMOS (complementary metal oxide semiconductor) that converts the image of the code obtained through the lens 31a into an electrical signal. Based on the amount of light received on the light-receiving surface of the image sensor 31b, an image containing the code is generated. The image sensor 31b has multiple imaging elements arranged in row and column directions, that is, multiple pixels arranged in a matrix. In other words, the imaging unit 3 is a so-called area camera. In this embodiment, the image sensor 31b has more pixels in the column direction (U direction) than in the row direction (V direction). The number of pixels, focal length, sensor size, etc. of the image sensor 31b are stored in the storage unit 5 as camera information related to the imaging unit 3. The captured image (hereinafter also simply referred to as “image”) generated by the image sensor 31b capturing the workpiece W, etc. is input to the preprocessing circuit 32. The preprocessing circuit 32 can be provided as needed and is not essential.

The preprocessing circuit 32 is configured with an integrated circuit such as an FPGA (Field Programmable Gate Array), for example, and is a part that executes various preprocessing on the image output from the image sensor 31b. The preprocessing includes, for example, various filter processing. The imaging unit 3 outputs the image preprocessed by the preprocessing circuit 32 to the control unit 4. The preprocessing by the preprocessing circuit 32 can be executed as needed, and it is also possible to output an image without preprocessing to the control unit 4. The image output to the control unit 4 is stored in the image data storage unit 52.

The imaging unit 3 is controlled by the imaging control unit 41. When a read start trigger signal is input from an external device, the imaging control unit 41 generates an image by exposing for a predetermined exposure time. By the imaging control unit 41 controlling the imaging unit 3, it also executes a process of applying a predetermined gain to the image generated by the image sensor 31b and amplifying the brightness of the image through digital image processing.

The control unit 4 controls each part of the code reader 1, detects codes attached to the workpiece W based on multiple images output from the imaging unit 3, and executes decoding processing of the detected codes. As a specific configuration example of the control unit 4, for example, a configuration including a microcomputer with a processor (functioning as a central processing unit), ROM, RAM, etc. can be mentioned. The imaging control unit 41, illumination control unit 42, code detection unit 43, and decoding unit 44 are configured by hardware included in the control unit 4 and software executed by the control unit 4.

The code detection unit 43 of the control unit 4 is a part that identifies the code region based on the code image output from the imaging unit 3 and detects the code from the identified code region. The code detection unit 43 generates multiple edge images by applying multiple edge extraction filters for extracting edges of different frequencies to the image generated by the imaging unit 3, and then performs integration processing of the multiple edge images. After that, the code detection unit 43 determines the code candidate position based on the result of the edge integration processing. In other words, in the edge-processed image, it is possible to estimate the region where many pixels with large brightness values are gathered as the code region.

example, the code detection unit 43 can generate a heat map image representing the likelihood of a code to search for the position of the code within the code image. Specifically, the code detection unit 43 quantifies the characteristic features of the code, generates a heat map by assigning the magnitude of the features to each pixel value, and extracts code candidate regions where the probability of code existence is high on this heat map. As a concrete example, there is a method of obtaining characteristic parts of the code in areas shown as relatively hot (with large feature values) in the heat map. If multiple characteristic parts are obtained, they can be prioritized, extracted, and stored in RAM or the like. By using a heat map image, it becomes possible to detect code regions at high speed.

The decoding unit 44 of the control unit 4 is a part that decodes the code detected by the code detection unit 43, and specifically, since the code is represented by binarized data in black and white, it decodes the binarized data in black and white. For decoding, a table showing the correspondence relationship of encoded data can be used. Furthermore, the decoding unit 44 checks whether the decoded result is correct or not according to a predetermined check method. If an error is found in the data, it uses an error correction function to calculate the correct data. The error correction function differs depending on the type of code.

As shown in FIG. 1, the code reader system S includes, in addition to the code reader 1, a dimension measurement unit 90, an encoder 91, a work sensor 92, a data communication device 93, a controller 100, a collection and analysis device 200, a setting device 300, and others. The dimension measurement unit 90, controller 100, collection and analysis device 200, etc. are examples of external devices.

The setting device 300 is configured, for example, with a personal computer, and has a display unit (display device) 301 composed of a liquid crystal display or the like, and an operation unit 302 composed of various input devices or operation devices such as a keyboard and a mouse. The user can input various information by operating the operation unit 302. When the collection and analysis device 200 is a personal computer, the setting device 300 does not need to be a personal computer, and can be a combination of a display and input devices. In this embodiment, while we explain about the code reader system S that has the function to perform decoding process on codes, this invention can also be applied to devices or systems that do not have the decoding function. For example, in the case of a system where the decoding unit 44 to be described later is omitted or configured to be inoperable, it becomes an image processing device or image processing system that executes various image processing using images generated by capturing the workpiece W.

The encoder 91 and the work sensor 92 are communicably connected to the controller 100 via IO wiring 94. The data communication device 93 is communicably connected to the controller 100 via a host communication line 95, and is configured as a device that executes communication with external networks and the like. The code reader 1 and the dimension measurement unit 90 are communicably connected to the controller 100 via a dedicated control communication line 96.

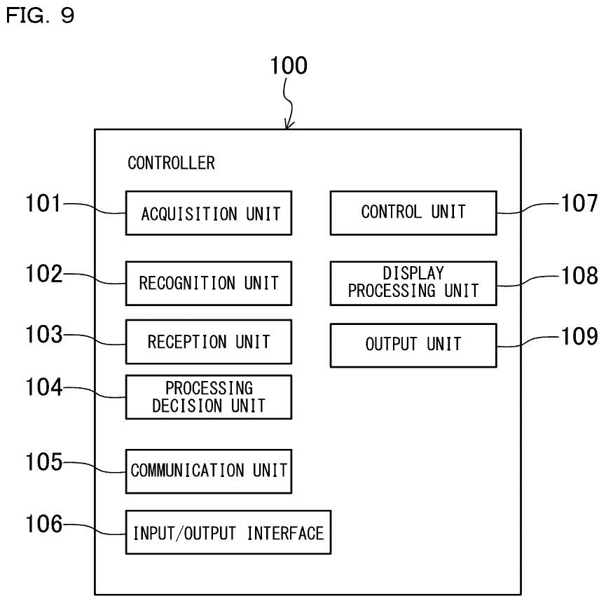

The code reader 1 has an imaging unit 3 and a decoding unit 44, so the imaging unit 3 and the decoding unit 44 are connected to the controller 100. Additionally, the code reader 1 has an illumination unit 2 corresponding to the imaging unit 3, so the illumination unit 2 is connected to the controller 100. As will be described in detail later, in operation examples 1 and 2, the imaging units 3 of multiple code readers 1 receive instructions from the control unit 107 (shown in FIG. 9) of the controller 100 to capture images of the workpiece W from multiple different directions. The illumination units 2 of multiple code readers 1 receive instructions from the control unit 107 of the controller 100 to illuminate the workpiece W from multiple different directions. In other words, the controller 100 is connected to the imaging unit(s) 3 of one or more code readers 1 and acquires multiple images obtained by the imaging unit(s) 3 of one or more code readers 1.

Furthermore, the code reader 1 and the dimension measurement unit 90 are communicably connected to each other via a dedicated control communication line 96. Additionally, the code reader 1 is communicably connected to the collection and analysis device 200 via communication line 97. The setting device 300 is communicably connected to the collection and analysis device 200 via communication line 98, as well as communicably connected to the controller 100 via communication line 99. The collection and analysis device 200, details of which will be described later, is a part that collects and stores chronological logs including images transmitted from the controller 100 and the code reader 1, and is typically a personal computer. It should be noted that the connection form of the aforementioned code reader 1, dimension measurement unit 90, encoder 91, work sensor 92, data communication device 93, controller 100, collection and analysis device 200, and setting device 300 is just an example, and any connection form that can realize the functions to be described later is acceptable.

The dimension measurement unit 90 is configured, for example, by an optical dimension measuring device and is an example of a detection sensor capable of detecting workpiece information including at least one of the position of the workpiece W in the width direction of the conveyor B and the height of the workpiece W. The optical dimension measuring device constituting the dimension measurement unit 90 can use a conventionally known one, for example, it can measure the dimensions of the workpiece W by irradiating measurement light onto the workpiece W and receiving the measurement light reflected from the workpiece W based on the principle of triangulation. The dimensions of the workpiece W that can be measured by the dimension measurement unit 90 include, for example, height, width, and depth. The dimension measurement unit 90 executes the dimension measurement process when it receives a read start trigger signal transmitted from the controller 100 via the dedicated control communication line 96. The dimension measurement unit 90 transmits the generated dimension data to the controller 100 or the code reader 1 via the dedicated control communication line 96. By measuring the dimensions of the workpiece W, it is possible to estimate the loading capacity for loading the workpiece W or calculate the transport volume, for example.

The encoder 91 is a device for detecting the conveying speed of the conveyor B. As shown in FIG. 2, the encoder 91 is attached to the conveyor B. The work sensor 92 is a device (for example, a photoelectric sensor) for detecting when a workpiece W conveyed by the conveyor B has reached a predetermined position, and outputs a detection signal when it detects that the workpiece W has reached the predetermined position. The work sensor 92 can also be attached to the conveyor B. The signals output from the encoder 91 and the work sensor 92 are transmitted to the controller 100 via the IO wiring 94.

FIG. 6 is a diagram showing the positional relationships from the trigger point to the output point. The trigger point is a point where a read start trigger signal for executing imaging and illumination is output. For example, the point at which the work sensor 92 detects that the workpiece W has reached a predetermined position can be set as the trigger point, and at the trigger point, the read start trigger signal can be output to the dimension measurement unit 90 and the code reader 1 via the dedicated control communication line 96. The work sensor 92 is installed upstream of the code reader 1 in the conveying direction. Therefore, the code reader 1 will read the code attached to the workpiece W downstream of the work sensor 92.

The dimension measurement unit 90 is installed at a dimension measurement unit installation point downstream of the trigger point in the conveying direction. Therefore, it is possible to measure the dimensions of the workpiece W that arrives after the read start trigger signal is output. The code reader 1 is installed at a code reader installation point downstream of the dimension measurement unit installation point in the conveying direction. Therefore, it is possible to capture an image of the workpiece W after its dimensions have been measured by the dimension measurement unit 90.

Although the decoding process for the code of the workpiece W will be executed after the read start trigger signal is input, this decoding process and the creation of output data including the decoding result, log, etc. are executed until the release point. When the workpiece W reaches the output point, the output data is output from the code reader 1 to the data communication device 93 via the dedicated control communication line 96. The output point corresponds to, for example, the user's desired timing determined based on the specifications of other systems. The output point and the release point can be set to the same timing. Whether the workpiece W has reached the release point and the output point can also be detected by the work sensor respectively.

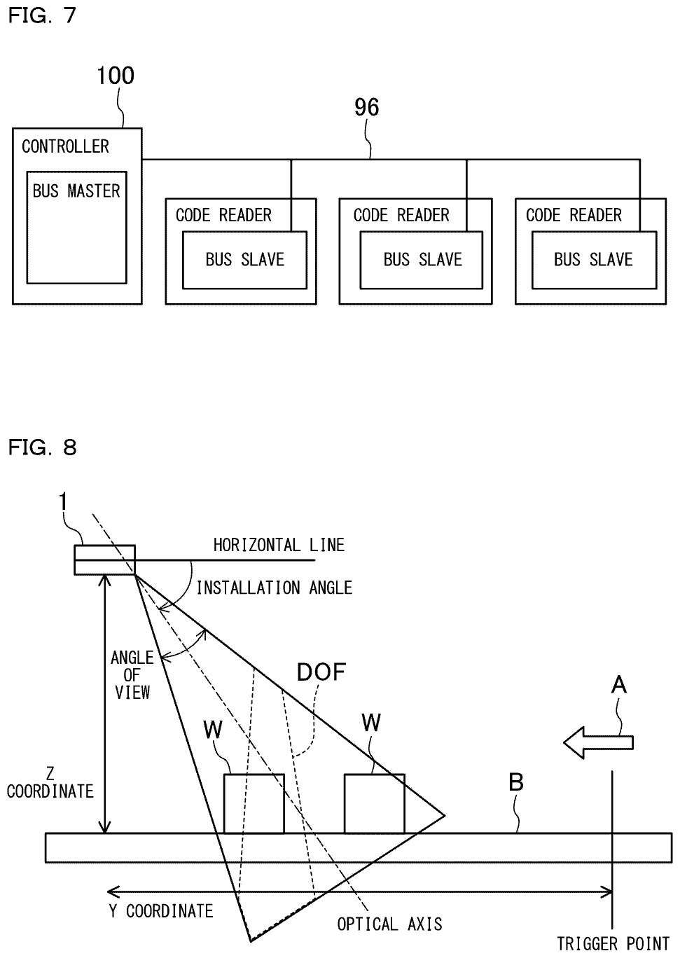

As shown in FIG. 7, when operating multiple code readers 1, the controller 100 is communicably connected to multiple code readers 1 via dedicated control communication lines 96. In this case, the controller 100 becomes the bus master, and each code reader 1 becomes a bus slave. The dedicated control communication line 96 can also be called a bus used to realize the transmission and reception of various data between the bus master and bus slaves.

FIG. 8 is a diagram explaining the positional relationship between the code reader 1 and the conveyor B. The coordinate system of the conveyor B (conveyor coordinate system) can be defined, for example, with the position of the work sensor 92 as the origin, the conveying direction as the Y direction, the width direction of the conveyor as the X direction, and the height direction from the conveying surface as the Z direction. The installation angle of the code reader 1 is determined by the angle formed between the conveying surface (Y direction) and the optical axis. The angle of view of the code reader 1 is predetermined for each model of the code reader 1. The X coordinate, Y coordinate, Z coordinate, installation angle, angle of view, etc. of the code reader 1 are installation information indicating the position and orientation of the imaging unit 3 in the conveyor coordinate system, and include the installation position and installation angle of the imaging unit 3 in the coordinate system of the conveyor B. The code reader 1 is equipped with an imaging unit 3 (camera) that has a shine-proof optical system consisting of a lens 31a that focuses reflected light from a code attached to the work W, and an image sensor 31b with a light-receiving surface inclined with respect to the optical axis of the lens 31a, generates an image containing the code based on the amount of light received on the light-receiving surface, and outputs it. The imaging unit 3 has a depth of field DOF suitable for oblique reading due to the shine-proof optical system. It should be noted that the optical system of the imaging unit 3 is not limited to the shine-proof optical system.

The controller 100 is configured to be connectable to external controlled devices such as a package camera that captures images of the load condition of the workpiece W, in addition to the code reader 1 and the dimension measurement unit 90. It is a controller that oversees the trigger control of the code reader 1, the dimension measurement unit 90, and external controlled devices. When the controller 100 receives signals output from a work sensor 92 that detects the position of the workpiece W or an encoder 91 for tracking the workpiece W, it outputs control parameters and read start trigger signals to the code reader 1, the dimension measurement unit 90, and external controlled devices. Additionally, it aggregates decode results from each code reader 1 and executes uploads to the collection and analysis device 200, setting device 300, and others.

The trigger control logic includes settings such as delay from the point when the work sensor 92 detects the workpiece W, and such settings can be configured in the controller 100. Additionally, processing of read data (such as string manipulation) can be executed in the controller 100. Therefore, the controller 100 has setting and programming elements, and is configured to accommodate different upper-level communication (TCP/IP socket communication, legacy serial) protocol specifications according to the site where it is introduced.

In the standard for dedicated control communication according to this embodiment, it is possible to assign IDs and IP addresses to the code reader 1 via the dedicated control communication line 96, and control of the code reader 1 is possible with only dedicated control communication. For example, after the installation and wiring of the code reader 1 is completed, ID assignment to the code reader 1, which is a bus slave, can be performed from the controller 100, which is the bus master, via the dedicated control communication line 96. Additionally, after the dedicated control communication line 96 becomes communicable, it is possible to assign IP addresses to the code reader 1 or communicate setting information of the code reader 1 via the dedicated control communication line 96 as needed.

The controller 100 and each code reader 1 are synchronized using a dedicated control system with dedicated control communication lines 96. The controller 100 generates a read start trigger signal and transmits the generated read start trigger signal to each code reader 1. The read start trigger signal can be changed according to the type of code reader 1, for example, it can be an edge trigger or a level trigger. The edge trigger is one that triggers per imaging unit, and the trigger instruction can include target ID, imaging time, control parameters, etc. The code reader 1 executes decoding targeting only one workpiece W in one imaging. On the other hand, the level trigger is one that triggers the start and stop of imaging, and the imaging timing is executed by the code reader 1.

When the controller 100 receives the read start trigger signal it has generated, each code reader 1 generates its own illumination timing according to its synchronized guaranteed time. In other words, the controller 100 controls the ON and OFF of the illumination of each code reader 1.

Each code reader 1 performs imaging according to the illumination control timing. In operation example 1 shown in FIG. 2, the imaging cycle of code readers 1A and 1B, other than the bottom reading, is set to a cycle dependent on the decoding time of the decoding unit 44, while the code reader 1C for bottom reading performs imaging at a constant cycle.

The specific configuration of the controller 100 will be explained based on FIG. 9. The controller 100 includes an acquisition unit 101, a recognition unit 102, a reception unit 103, a processing decision unit 104, a communication unit 105, an input/output interface 106, a control unit 107, a display processing unit 108, and an output unit 109. The input/output interface 106 is the part to which the encoder 91, the work sensor 92, the data communication device 93, the setting device 300, the code reader 1, the dimension measurement unit 90, external controlled devices, the collection and analysis device 200, etc. are connected. The input/output interface 106 is connected to the communication unit 105.

The acquisition unit 101 is a part that acquires the detection signal of the workpiece W by the work sensor 92, conveyor information including the conveying speed and conveyor width of the conveyor B, and installation information indicating the position and orientation of each code reader 1 in the conveyor coordinate system of the conveyor B. The conveying speed of the conveyor B may be acquired based on the output signal of the encoder 91, or may be acquired from the travel distance in a predetermined time using multiple work sensors, or may be acquired as the conveying speed of the conveyor B set by the user. It should be noted that when the encoder 91 calculates the transport distance of the workpiece based on the number of pulses during the elapsed time from when the workpiece W is detected until it is imaged and the travel distance per unit pulse, it can be considered that the conveying speed is substantially or indirectly acquired, and the transport distance is calculated based on the elapsed time and the conveying speed.

The recognition unit 102 is a part that recognizes the conveying state of the workpiece W on the conveyor B based on the detection signal and conveying speed acquired by the acquisition unit 101. The conveying state includes, for example, the conveying speed and the position of the workpiece W on the conveyor B (i.e., the position of the workpiece W in the conveyor coordinate system). By using the information obtained from the dimension measurement unit 90, the recognition unit 102 can further recognize the conveying state including the dimensions (width, height, depth) of the workpiece W and the position and orientation of the workpiece W in the conveyor coordinate system.

The reception unit 103 is a part configured to accept from the user a combination of code readers 1 among multiple code readers 1 connected to the controller 100, for which illumination interference prevention is desired. For example, in the operation example 1 shown in FIG. 2, if the illumination of the upstream oblique reading code reader 1A and the downstream oblique reading code reader 1B were to turn on simultaneously, their illuminations might interfere with each other, potentially preventing the acquisition of the desired code image. In cases where such illumination interference needs to be prevented, the combination of code reader 1A and code reader 1B becomes the combination of code readers 1 for which illumination interference prevention is desired. When the user specifies code reader 1A and code reader 1B, this combination is accepted by the reception unit 103.

The processing decision unit 104 acquires the conveying state of the workpiece W recognized by the recognition unit 102 and the installation information of each code reader 1 obtained by the acquisition unit 101. Based on the conveying state of the workpiece W and the installation information of each code reader 1, the processing decision unit 104 determines control parameters corresponding to a predetermined conveying position of the workpiece W on the conveyor B for each of the code readers 1. The processing decision unit 104 can estimate the current position of the workpiece W based on the output signal of the encoder 91 and the detection signal of the work sensor 92. The processing decision unit 104 determines the control parameters in advance before the workpiece W reaches the predetermined conveying position on the conveyor B. In other words, since it is possible to obtain the conveying state of the workpiece W, including what kind of workpiece W is currently located where, the optimal control parameters for each code reader 1 can be updated and prepared in advance. Then, when each code reader 1 becomes capable of capturing images, it executes illumination and imaging control using the latest control parameters at that time. The code reader 1 is not limited to the configuration with one imaging unit 3 shown in FIG. 5, but may have a configuration with multiple imaging units 3 inside the housing of the code reader 1. Also, the code reader 1 is not limited to the configuration where both the imaging unit 3 and the decoding unit 44 are inside the housing, but the decoding unit 44 may be provided as a separate device. In these configurations, the processing decision unit 104 determines control parameters corresponding to a predetermined conveying position of the workpiece W on the conveyor B for each imaging unit 3, based on the conveying state of the workpiece W and the installation information of each imaging unit 3.

The control parameters determined by the processing decision unit 104 include, for example, the exposure time of the imaging unit 3, gain, type of decode target code, read result output timeout, imaging range (imaging range of the image sensor 31b), and processing parameters by the preprocessing circuit 32. The exposure time can be determined based on the conveying speed of the conveyor B obtained from the output signal of the encoder 91. For example, the faster the conveying speed, the shorter the exposure time can be. By automatically optimizing the exposure time by the processing decision unit 104, the brightness of the image generated by the imaging unit 3 becomes suitable for decoding processing. Also, the gain is the gain of the imaging unit 3, and the processing decision unit 104 automatically sets it to an optimal value based on the position of the workpiece W on the conveyor B and the installation information of the code reader 1. By optimizing the gain, the brightness of the image generated by the imaging unit 3 becomes suitable for decoding processing.

The processing decision unit 104 is configured to be able to determine the code to be read for each imaging cycle as a control parameter, based on the conveying state of the workpiece W and the installation information of each code reader 1. The type of decode target code refers to the type of code that the decoding unit 44 decodes, and multiple types can be specified. For example, the processing decision unit 104 determines the type of decode target code as a control parameter when excluding codes that do not need to be read based on the reading results of another code reader 1 installed upstream, or when switching the target code to be read for each imaging. Also, it is possible to determine the control parameters so that the first type of code is read by the first code reader 1 on the upstream side in the conveying direction, and the second type of code is read by the second code reader 1 on the downstream side.

Furthermore, the processing decision unit 104 can also determine whether or not to output the captured image for each imaging cycle based on the conveying speed of the workpiece W as a control parameter. In other words, it is possible to include a control flag for image output to the collection and analysis device 200 in the control parameters.

The processing decision unit 104 determines the imaging cycle for each code reader 1 based on the conveying state and installation information of each code reader 1. When multiple code readers 1 are connected, the processing decision unit 104 generates a reference signal that defines a basic cycle common to all code readers 1, and determines the imaging cycle and illumination cycle for each code reader 1 based on the basic cycle. The basic cycle is the cycle that serves as the reference for the illumination timing, and by controlling the illumination and imaging in accordance with the basic cycle, it becomes possible to prevent interference between multiple illuminations.

The imaging cycle and illumination cycle are composed of one or multiple basic cycles. The illumination cycle is the cycle at which the illumination unit 2 performs illumination, and is set to an integer multiple of the basic cycle. The imaging cycle is the cycle at which the imaging unit 3 executes imaging, and is set to an integer multiple of the illumination cycle.

Furthermore, the processing decision unit 104 determines, for each code reader 1, an offset amount to offset the start timing of the imaging cycle and illumination cycle from the reference signal, based on the conveying state of the workpiece W by the conveyor B and the installation information of each code reader 1. The offset amount is, for example, set to delay the start timing of illumination, and is used to prevent interference between multiple illuminations.

Furthermore, when the reception unit 103 accepts from the user a combination of code readers 1 for which illumination interference prevention is desired, the processing decision unit 104 generates multiple groups for each combination accepted by the reception unit 103, and for each of these groups, determines the imaging cycle and the offset amount of the start timing of the illumination cycle from the reference signal.

While there are combinations of code readers 1 where interference of illumination needs to be prevented, there are also cases where the illumination of multiple code readers 1 needs to be synchronized. For example, as mentioned above, in a configuration where multiple imaging units 3 and multiple illumination units 2 corresponding to these multiple imaging units 3 are provided to read the gaps of a common conveyor B from below the conveying surface of the conveyor B, synchronizing multiple illumination units 2 can secure a larger amount of light. For instance, the processing decision unit 104 can determine control parameters to cause multiple illumination units 2 to irradiate illumination light at overlapping timings.

The communication unit 105 is a part that executes communication with multiple code readers 1 according to the standards of dedicated control communication, and transmits the control parameters determined by the processing decision unit 104 to the corresponding code readers 1. For example, after the control parameters corresponding to the code readers 1 are determined, the communication unit 105 transmits the corresponding control parameters to each code reader 1 at the timing when the workpiece W reaches a predetermined transport position. It should be noted that while it is desirable for this transmission timing to be the moment when the workpiece W reaches the predetermined transport position, it may also be immediately before or after that moment, as long as it is within a range where the control parameters can be effectively utilized.

When multiple code readers 1 are connected, the communication unit 105 transmits the imaging cycle determined by the processing decision unit 104 to each corresponding code reader 1, and transmits the illumination cycle determined by the processing decision unit 104 to each corresponding code reader 1. The preprocessing circuit 32 can execute pre-imaging processing and post-imaging processing according to the control parameters.

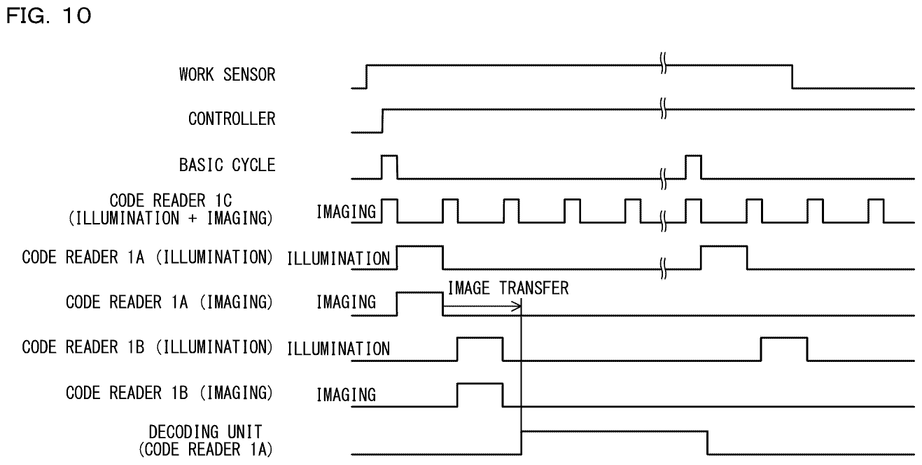

FIG. 10 is a timing chart for operating the upstream oblique reading code reader 1A, the downstream oblique reading code reader 1B, and the bottom reading code reader 1C. The work sensor 92 outputs a detection signal and enters an ON state when the leading edge of the workpiece W reaches the trigger point, and maintains the ON state until detecting the trailing edge. The controller 100 outputs a read start trigger signal upon receiving the detection signal from the work sensor 92. The upstream oblique reading code reader 1A, the downstream oblique reading code reader 1B, and the bottom reading code reader 1C, which have received the read start trigger signal, operate according to a reference signal that defines a basic cycle common to each code reader 1A, 1B, and 1C.

The code reader 1C for bottom reading that has received the read start trigger signal repeatedly executes imaging by the imaging unit 3 and illumination by the illumination unit 2. The imaging cycle and illumination cycle at this time may be composed of one basic cycle or may be composed of multiple basic cycles. The control parameters of the code reader 1C for bottom reading are the control parameters determined by the processing decision unit 104.

The start timing of the imaging cycle and illumination cycle of the upstream oblique reading code reader 1A that received the read start trigger signal is offset from the reference signal, and illumination and imaging are executed according to the imaging cycle and illumination cycle. The image generated by the imaging unit 3 of the upstream oblique reading code reader 1A is transferred to the decoding unit 44. The decoding unit 44 executes decoding processing on the transferred image.

Furthermore, the start timing of the imaging cycle and illumination cycle of the downstream oblique reading code reader 1B, which received the read start trigger signal, is also offset from the reference signal. The offset amount of the start timing of the imaging cycle and illumination cycle of the downstream oblique reading code reader 1B is set larger than the offset amount of the start timing of the imaging cycle and illumination cycle of the upstream oblique reading code reader 1A. The downstream oblique reading code reader 1B also executes imaging and illumination according to the imaging cycle and illumination cycle. The control parameters of the upstream oblique reading code reader 1A and the downstream oblique reading code reader 1B are also control parameters determined by the processing decision unit 104. The imaging order of the upstream oblique reading code reader 1A, the downstream oblique reading code reader 1B, and the bottom reading code reader 1C can be set arbitrarily.

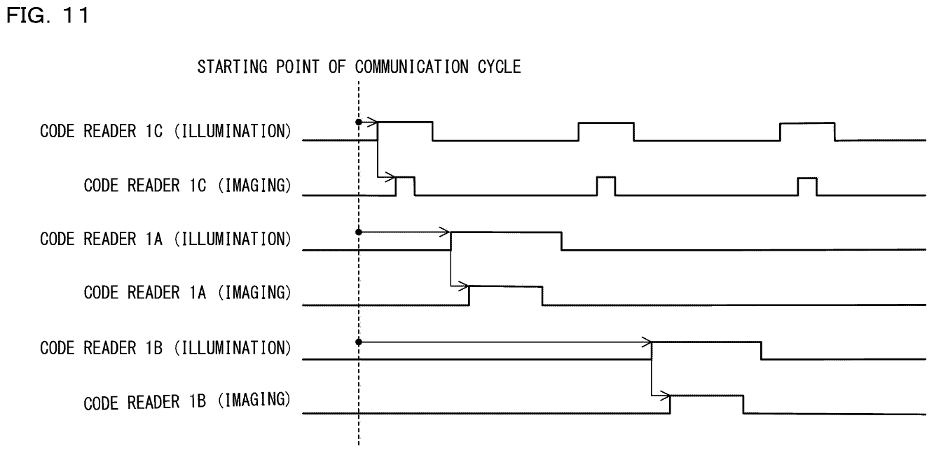

FIG. 11 is a diagram explaining the details of the timing chart shown in FIG. 10. As shown in FIG. 11, synchronous control of the upstream oblique reading code reader 1A, downstream oblique reading code reader 1B, and bottom reading code reader 1C is executed based on the starting point of the communication cycle of the dedicated control communication. The illumination timing of the illumination unit 2 and the imaging timing of the imaging unit 3 are set so that imaging is executed between the illumination start timing and the illumination end timing of the bottom reading code reader 1C. Similarly, for the downstream oblique reading code reader 1B and the bottom reading code reader 1C, the illumination timing of the illumination unit 2 and the imaging timing of the imaging unit 3 are set so that imaging is executed between the illumination start timing and the illumination end timing.

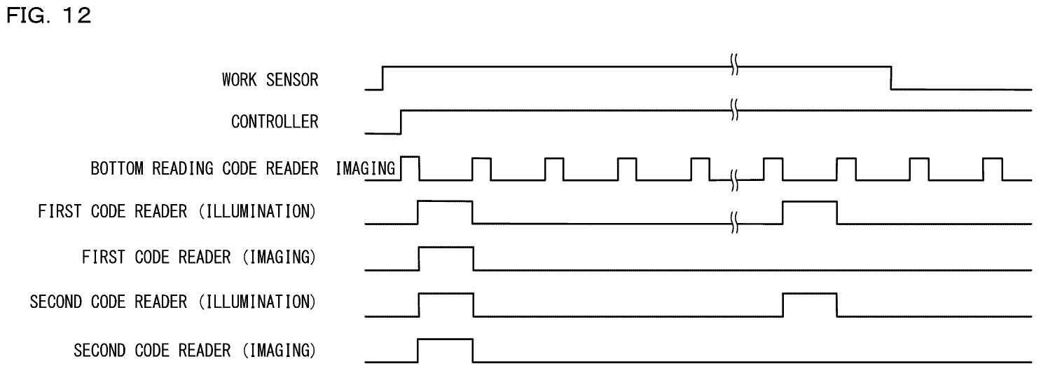

FIG. 12 is a timing chart for simultaneously illuminating the illumination units 2 of the first code reader and the second code reader. In the example shown in this figure, the first code reader and the second code reader are installed to capture the same surface of the workpiece W. Upon receiving the read start trigger signal, the first code reader and the second code reader execute illumination and imaging at a timing offset from the imaging timing of the bottom-reading code reader 1C. At this time, since the illumination of the first code reader and the illumination of the second code reader are executed simultaneously, the workpiece W can be brightly illuminated, and the brightness of the image generated by the imaging unit 3 can be increased.

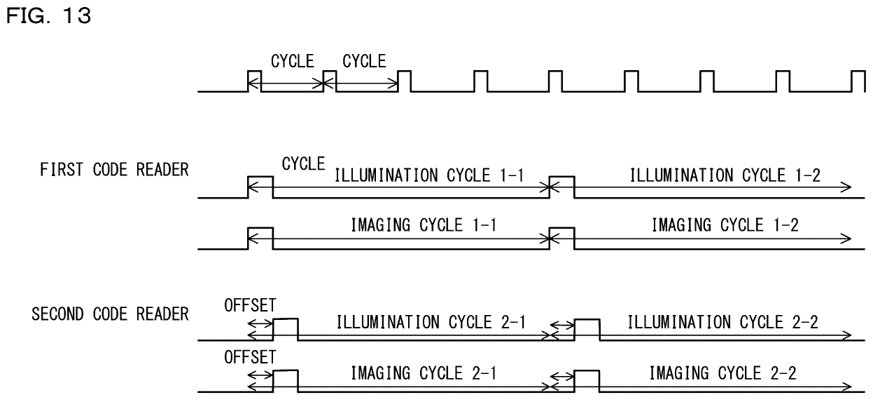

FIG. 13 is a timing chart for a case where the illumination cycle and imaging cycle are common for all code readers (shown as the first code reader and the second code reader in the figure). The illumination cycles 1-1 and 1-2 of the first code reader are the same as the illumination cycles 2-1 and 2-2 of the second code reader. Also, the imaging cycles 1-1 and 1-2 of the first code reader are the same as the imaging cycles 2-1 and 2-2 of the second code reader.

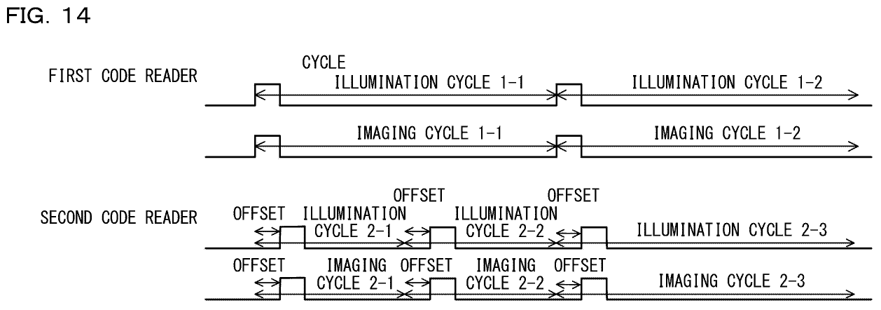

FIG. 14 is a timing chart for a case where the illumination cycle and imaging cycle differ for each code reader, but are common within each code reader unit. Specifically, the illumination cycle 1-1 and illumination cycle 1-2 of the first code reader are the same, and the imaging cycle 1-1 and imaging cycle 1-2 of the first code reader are the same. On the other hand, the illumination cycle 2-1 of the second code reader is different from the illumination cycle 1-1 of the first code reader, and the imaging cycle 2-1 of the second code reader is different from the imaging cycle 1-1 of the first code reader. Additionally, the illumination cycles 2-1 and 2-2 of the second code reader are the same, and the imaging cycles 2-1 and 2-2 of the second code reader are also the same. It is possible to change the illumination cycle and imaging cycle during operation.

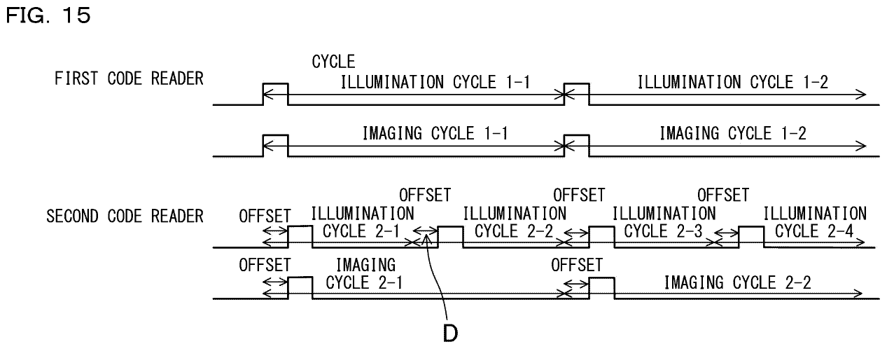

FIG. 15 is a timing chart for cases where the illumination cycle and imaging cycle differ for each code reader and per code reader unit. Specifically, the illumination cycle 1-1 and illumination cycle 1-2 of the first code reader are the same, and the imaging cycle 1-1 and imaging cycle 1-2 of the first code reader are the same. On the other hand, the illumination cycle 2-1 of the second code reader is different from the illumination cycle 1-1 of the first code reader, and the imaging cycle 2-1 of the second code reader is different from the imaging cycle 1-1 of the first code reader. Additionally, the illumination cycles 2-1 and 2-2 of the second code reader are different, and the imaging cycles 2-1 and 2-2 of the second code reader are also different. At the timing indicated by arrow D in FIG. 15, since the imaging unit 3 is not exposing, it is not necessary to offset the illumination cycle.

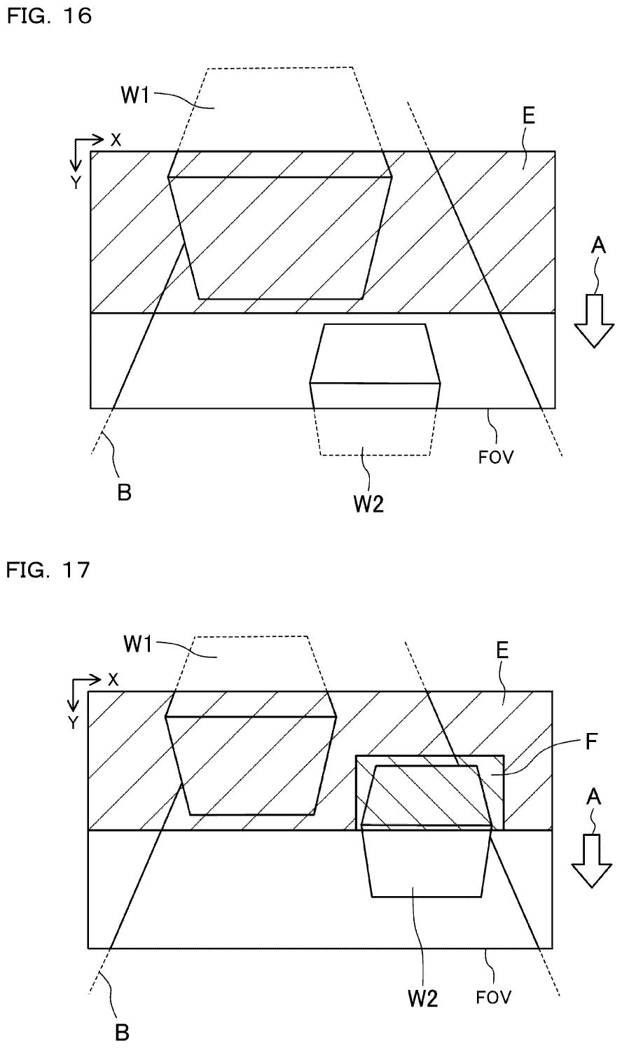

For example, in the logistics industry, while accurate tracking (association of workpiece W with read code) is required, there is also an increasing demand to shorten the distance between workpieces W (packages) during transport for efficiency, as the volume of handled workpieces W is trending upward. Here, since the conveyor B sequentially transports multiple workpieces W, as shown in FIG. 16, there may be cases where multiple workpieces W1, W2 are in close proximity in the conveying direction (indicated by arrow A) of the conveyor B. In other words, in situations where the target workpiece W1 is close to the forward workpiece W2 positioned downstream in the conveying direction, and both the target workpiece W1 and the forward workpiece W2 are simultaneously captured by the imaging unit 3, the code reader 1 may be unable to distinguish whether the read code was attached to the target workpiece W1 or the forward workpiece W2, potentially resulting in incorrect association between the read code and the workpiece.

To suppress such incorrect associations, in this embodiment, the imaging area by the imaging unit 3 is set to a narrow area capable of capturing only the target workpiece W1 for reading, as indicated by symbol E. Specifically, the processing decision unit 104 determines the readout area for each imaging cycle based on the conveying state and installation information of each code reader 1 as a control parameter. When determining the readout area, for example, the position of the code reader 1 is identified by the installation information of the code reader 1. Also, based on the detection signal from the work sensor 92 and the output signal from the encoder 91, the relative positional relationship between the code reader 1 and the target workpiece W1 for reading can be identified. Then, the processing decision unit 104 offsets the imaging area of the imaging unit 3 in the Y direction so that only the target workpiece W1 for reading is included in the imaging area E.

Specifically, the processing decision unit 104 generates control parameters that offset the imaging area of the imaging unit 3 in the Y direction (corresponding to the V direction in the UV coordinate system). Additionally, since the relative positional relationship between the code reader 1 and the target workpiece W1 can be identified as described above, the processing decision unit 104 can specify the size of the imaging area E of the imaging unit 3 based on this positional relationship. As a result, the code of the forward workpiece W2 is no longer imaged, so the code of the forward workpiece W2 will not be decoded, and the decoding result of the forward workpiece W2 can be prevented from being associated with the target workpiece W1. The processing decision unit 104 also generates information regarding the size of the imaging area E of the imaging unit 3 as control parameters.

FIG. 17 shows a case where multiple workpieces W1 and W2 are approaching in the conveying direction (indicated by arrow A) of the conveyor B, and the target workpiece W1 is positioned on one side in the width direction of the conveyor B, while the forward workpiece W2 is positioned on the other side in the width direction of the conveyor B. In this case, even if a narrow imaging area E is used as shown in FIG. 16, at least a part of the forward workpiece W2 may be included in the imaging area E, which may lead to incorrect association between the read code and the workpiece. To address this issue, the processing decision unit 104 determines a mask area F where decoding processing is not executed for each imaging cycle as a control parameter, based on the conveying state, workpiece information, and installation information of each code reader 1. The information about the dimensions of the target workpiece W1 as workpiece information can be obtained by the dimension measurement unit 90. By utilizing the conveying state of the target workpiece W1 based on the detection signal from the work sensor 92 and the output signal from the encoder 91, the workpiece information of the target workpiece W1, and the installation information of each code reader 1, it is possible to determine the position, size, and shape of the mask area F within the imaging area E. For the determined mask area F, the processing decision unit 104 generates control parameters to exclude it from the code search target area or to prevent the decoding unit 44 from executing decoding processing even if a code is found as a result of code search. Therefore, it is possible to avoid associating the decoding result of the forward workpiece W2 with the target workpiece W1.

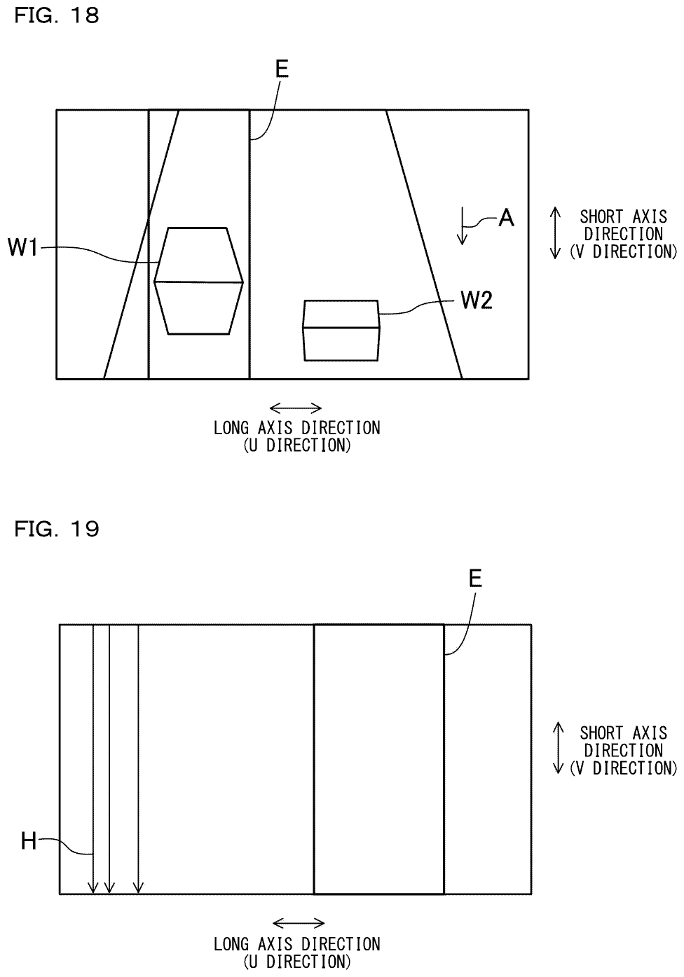

FIG. 18 shows an example of using a custom sensor as the image sensor 31b, where the number of pixels in the column direction is greater than the number of pixels in the row direction. When multiple workpieces W1 and W2 approach in the conveying direction (indicated by arrow A) of the conveyor B, and the target workpiece W1 is positioned on one side of the conveyor B in the width direction, while the forward workpiece W2 is positioned on the other side of the conveyor B in the width direction, it is possible to address this situation using a custom sensor without setting the mask area F shown in FIG. 17. In this embodiment, the processing decision unit 104 determines, as a control parameter, an area for partially reading out only the pixels arranged in some rows of the image sensor 31b for each imaging cycle, based on the conveying state of the workpiece W and the installation information of each code reader 1.

In other words, by making the imaging area E corresponding to the imaging field of view of the image sensor 31b a field of view that is long in the short axis direction rather than in the long axis direction of the image sensor 31b, it is possible to prevent the forward workpiece W2 from entering the imaging area E. While the readout direction of a general image sensor is along the long axis of the image sensor, making it impossible to read out an imaging area E that is long in the short axis direction as shown in FIG. 18, in this embodiment, as shown by the arrow H in FIG. 19, a custom sensor capable of reading out in the short axis direction of the image sensor is used as the image sensor 31b. This accelerates the readout of the imaging area E that is long in the short axis direction of the image sensor. The width of the imaging area E (the length in the long axis direction of the image sensor) is determined by the processing decision unit 104 to correspond to the width of the workpiece W.

### (Setting Support Function)

The code reader system S has a setting support function that assists in configuring the code reader 1. The code reader system S can also be referred to as a setting support device, which is a device with a setting support function. In the case of a setting support device, the decoding process may be executed by an external device, so it is not necessary to include the decoding unit 44.

The following is a detailed explanation of the setting support function. First, as a premise, the code reader system S has a tracking function that associates the workpiece W with the decode result of the code attached to that workpiece W. Since the association between the workpiece W and the decode result needs to be done accurately, calibration is performed to associate the coordinate system of the conveyor B (conveyor coordinate system) with the imaging coordinate system of the code reader 1 in order to improve the accuracy of tracking. The code reader system S has a calibration function that enables easy implementation of this calibration.

The coordinate system of the conveyor B can be defined as an XYZ coordinate system, as shown in FIGS. 3, 4A, and 4B. The unit of the coordinate system of the conveyor B is mm. The imaging coordinate system of the code reader 1, also called the camera coordinate system, is a coordinate system obtained by parallel translating the conveyor coordinate system of the conveyor B to the imaging unit 3 and rotating it, with the Z direction aligned with the optical axis. The unit of the imaging coordinate system of the code reader 1 is mm. The coordinate system of the image sensor 31b (sensor coordinate system) can be defined as a UV coordinate system as shown in FIGS. 18 and 19. The unit of the coordinate system of the image sensor 31b is pixels.

The camera information including the number of pixels, focal length, and sensor size of the image sensor 31b is known and stored in the storage unit 5 of the code reader 1. Calibration is performed using this camera information, information input by the user such as the width of the conveyor B, installation position and orientation of the code reader 1 (X coordinate, Y coordinate, Z coordinate, installation angle), and the travel distance of the workpiece W (=time information x conveying speed). The travel distance of the workpiece W can be used, for example, for installation confirmation.

An example of the preconditions for the code reader system S to perform calibration is as follows:
1. The conveying direction of the workpiece W is the Y direction in the coordinate system of the conveyor B.
2. When the code reader 1 is installed to read the top surface of the workpiece W (in the case of top surface installation), the X direction and the U direction approximately coincide, and the V direction is inclined with respect to the Y direction.
3. When the code reader 1 is installed to read the side surface of the workpiece W (in the case of side surface installation), the Z direction and the U direction approximately coincide, and the V direction is inclined with respect to the Y direction.

Then, the code reader system S generates an initial calibration model (coordinate transformation coefficient) using the known camera information and the information such as the width of the conveyor B, the installation position and orientation of the code reader 1 input by the user. Using the detection signal of the work sensor 92 as a reference in the Y direction and based on the speed conditions, the Y-direction position of the work W at a certain time can be calculated, so the initial calibration model can be adjusted using this calculation result. By adjusting the initial calibration model to generate an adjusted calibration model, the position of the work W in the image can be accurately determined.

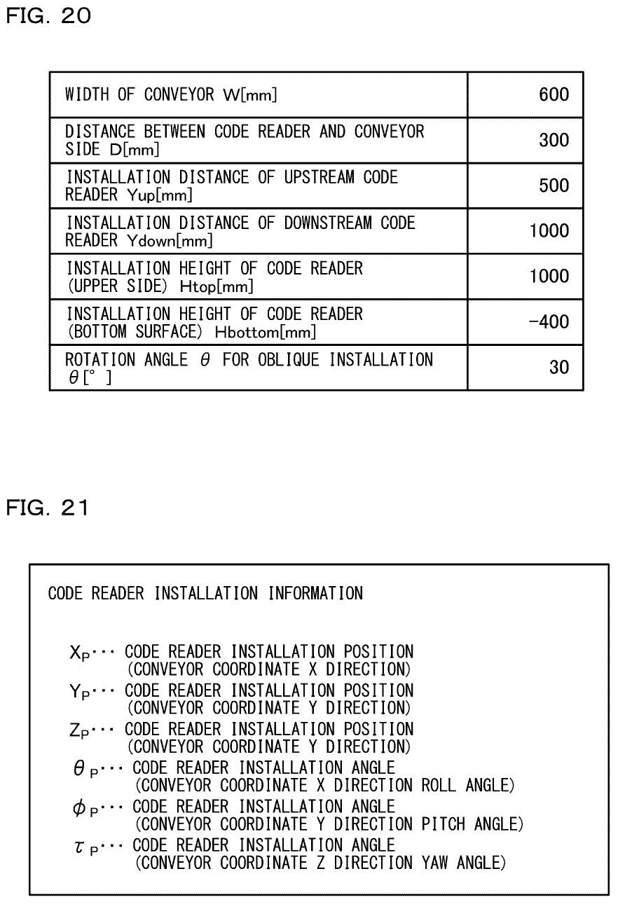

The following describes the calibration procedure. First, the acquisition unit 101 acquires installation information indicating the position and orientation of the code reader 1, i.e., the imaging unit 3, in the conveyor coordinate system of the conveyor B. The installation information includes the X coordinate, Y coordinate, Z coordinate, installation angle, etc. of the code reader 1, which are measured by the user and then input by operating the setting device 300 or the like. Additionally, the user inputs the width of the conveyor B by operating the setting device 300 or the like. Examples of the input values are shown in FIG. 20. Furthermore, the acquisition unit 101 also acquires the detection signal of the workpiece W from the work sensor 92. In addition, the acquisition unit 101 also acquires conveyor information including the width and conveying speed of the conveyor B.

As shown in FIG. 9, the controller 100 has a control unit 107, and the control unit 107 defines a coordinate system of the conveyor B based on the position of the work sensor 92. For example, the Y-coordinate origin of the coordinate system of the conveyor B can be set at the position of the work sensor 92, but this is not limited to this arrangement. Additionally, the control unit 107 calculates the position of the conveyor (conveyor position) in the captured image based on the camera information, conveyor information, and installation information of the code reader 1.

The control unit 107 calculates the position and installation angle of each code reader 1 in the coordinate system of the conveyor B based on the information shown in FIG. 20. An example of calculating the position and installation angle of each code reader 1 is shown in FIG. 21, and as shown in this figure, the control unit 107 calculates the X, Y, and Z coordinates of the code reader 1 in the coordinate system of the conveyor B, as well as the X-direction roll angle, Y-direction pitch angle, and Z-direction yaw angle.

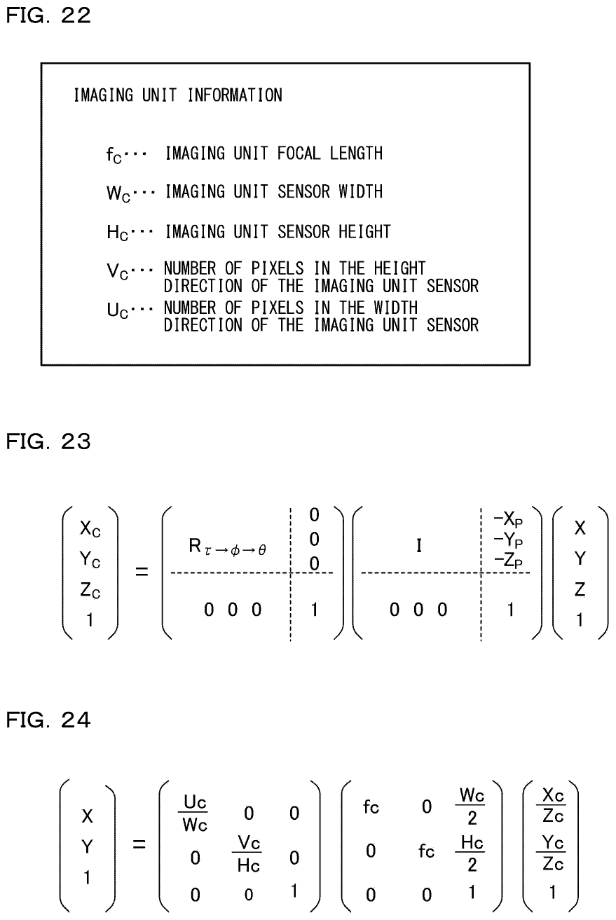

The acquisition unit 101 also acquires camera information. FIG. 22 shows the camera information acquired by the acquisition unit 101, and the camera information includes the focal length of the imaging unit 3, the width (U direction) dimension of the image sensor 31b, the height (V direction) dimension of the image sensor 31b, the number of pixels (number of pixels) in the height direction of the image sensor 31b, the number of pixels (number of pixels) in the width direction of the image sensor 31b, and so on.

The user can also input the size of the workpiece W and code information. The control unit 107 calculates candidate installation positions for the imaging unit 3 based on at least one of the size of the workpiece W, the conveyor width, and the code information input by the user. In this case, the acquisition unit 101 acquires the candidate installation positions calculated by the control unit 107 as installation information.

FIG. 23 is an example of a conversion formula that can be used to convert the conveyor coordinate system of the conveyor B to the imaging coordinate system of the code reader 1. This conversion formula includes a rotation matrix for the installation angle of the code reader 1 (for example, in the order of yaw angle, pitch angle, and roll angle) and a translation matrix for the installation position of the code reader 1. The control unit 107 can convert the coordinate system of the conveyor B to the imaging coordinate system of the code reader 1 by using the rotation matrix and the translation matrix.

FIG. 24 is an example of a conversion formula that can be used when converting the imaging coordinate system of the code reader 1 to the UV coordinate system of the image sensor 31b (corresponding to the XY coordinate system in FIG. 16). This conversion formula includes a matrix for converting mm to unit pixels, and a matrix for scale conversion to the plane of the image sensor 31b and moving the origin position to the upper left of the image sensor 31b. The control unit 107 can convert the imaging coordinate system of the code reader 1 to the UV coordinate system of the image sensor 31b by using these matrices.

As shown in FIG. 23 and FIG. 24, the control unit 107 generates a calibration model indicating the correspondence relationship between the conveyor coordinate system of the conveyor B and the UV coordinate system of the image sensor 31b, based on the camera information, conveyor information, and installation information of the code reader 1 acquired by the acquisition unit 101.

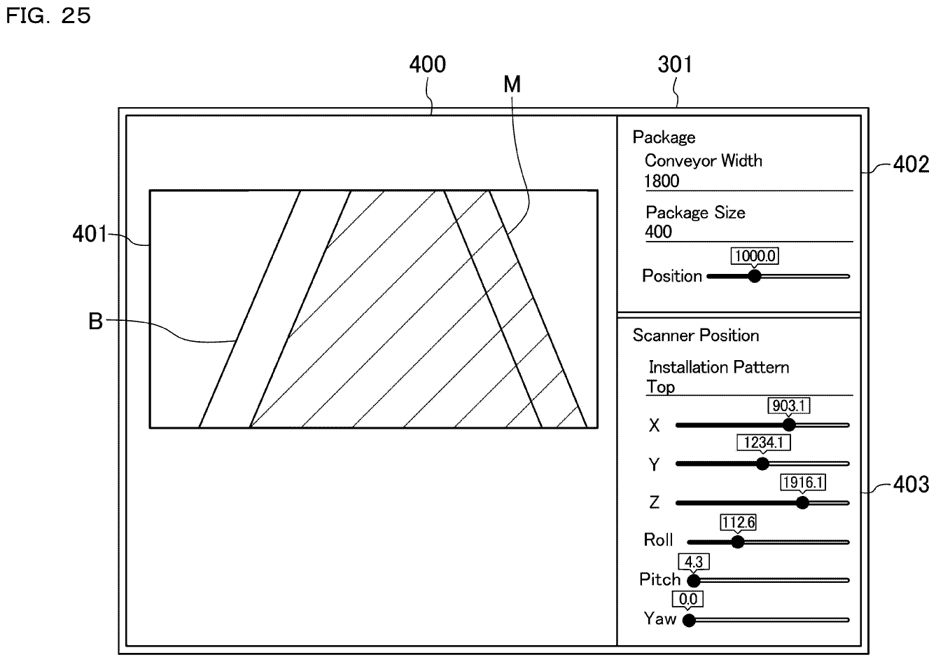

FIG. 25 can display an installation confirmation image using a calibration model showing the correspondence relationship between the coordinate system of the conveyor B and the UV coordinate system of the image sensor 31b on the display unit 301 of the setting device 300. The user interface screen 400 is provided with an image display area 401 for displaying the installation confirmation image, a workpiece information display area 402, and a code reader information display area 403. In this example, the conveyor position M (virtual conveyor position) calculated by the calibration model is superimposed on the captured image of the conveyor (an image having multiple horizontal lines).

The conveyor position M indicates the area estimated to be the conveyor, and the entire area may be displayed in a filled-in form, or only the parts corresponding to the edges of the conveyor may be displayed. Since the conveyor position M indicates the area of the conveyor, by superimposing the conveyor position M on the captured image, the area estimated to be the conveyor can be shown to the user. The image showing the conveyor position M in the captured image is an installation confirmation image for confirming the installation.

Instead of or in addition to the image of the conveyor, a line that serves as a reference for alignment (alignment reference line), such as the center line of the conveyor, may be displayed. The alignment reference line can also be included as part of the installation confirmation image.

In the workpiece information display area 402, the width of the conveyor B, the dimensions of the workpiece W, and the position of the workpiece W are displayed. In the code reader information display area 403, the installation position, installation angle, etc. (position parameters) of the code reader 1 calculated based on the installation information are displayed. Since the code reader 1 captures images of the workpiece W, it can also be called a scanner, and in the example shown in FIG. 25, “Scanner Position” is displayed in the code reader information display area 403.

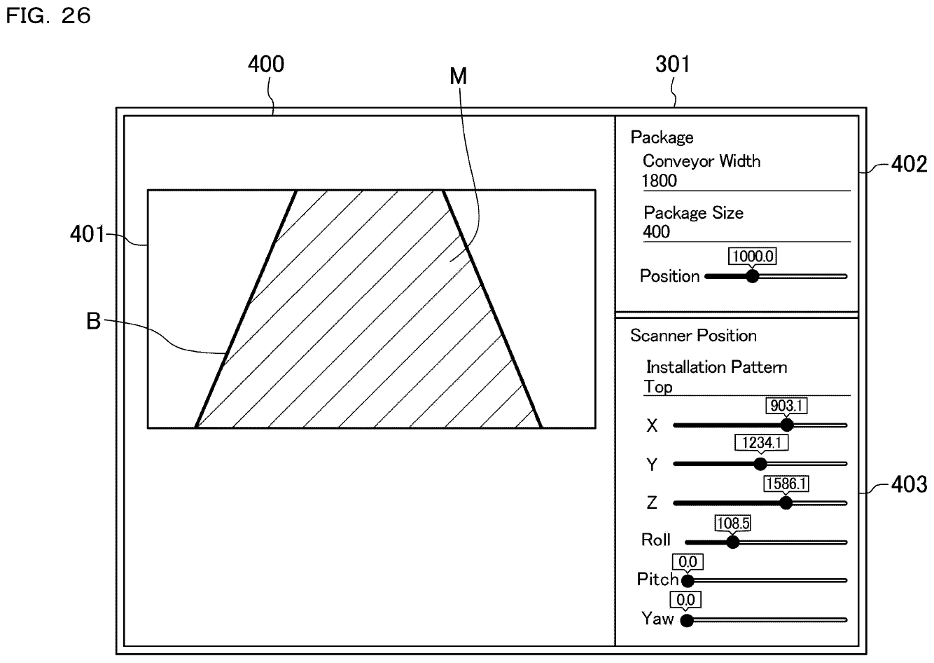

When the position parameters defining the position of the code reader 1 are changed, as shown in FIG. 26, the changes in the position parameters are reflected on the display user interface screen 400, and the calibration model is adjusted. The conveyor position M calculated by the adjusted calibration model can be aligned with the actual position of the conveyor on the installation confirmation image. At this time, the X-coordinate, Z-coordinate, X-direction roll angle, Y-direction pitch angle, and Z-direction yaw angle of the code reader 1 are adjusted.

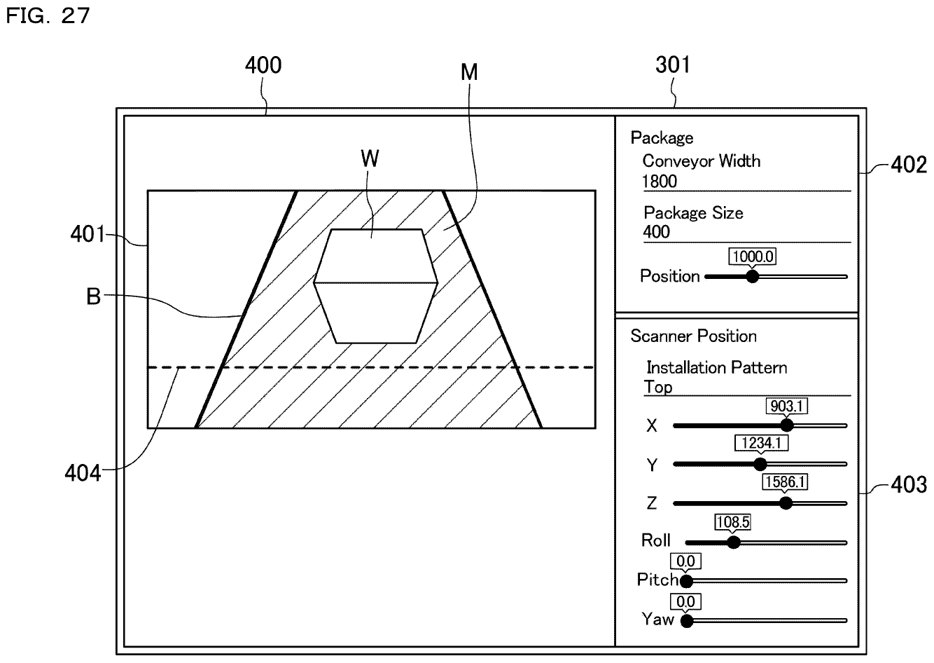

FIG. 27 is an example of displaying an image of a workpiece W transported by the conveyor B. The acquisition unit 101 directly or indirectly acquires the conveying speed of the conveyor B based on, for example, the output signal of the encoder 91 or setting values by the user. The control unit 107 causes the imaging unit 3 to capture an image of the workpiece W being transported on the conveyor B and generate a captured image. The display processing unit 108 displays an installation confirmation image in the image display area 401, which shows characteristic parts of the workpiece W (such as edges, to be described later) calculated by the adjusted calibration model in the captured image generated by the imaging unit 3.

The control unit 107 calculates the position of the characteristic part of the workpiece W in the coordinate system of the conveyor B at the time of image capture, based on the detection signal from the work sensor 92 and the conveying speed. For example, if the elapsed time from when the workpiece W is detected until the imaging time and the conveying speed are known, it can be determined how much the workpiece has moved since detection. The detection signal includes not only signals directly transmitted from the work sensor 92 to the controller 100, but also signals transmitted from the PLC to the controller 100 upon receiving the detection signal from the work sensor 92 in cases where the work sensor 92 is connected to the controller 100 via a PLC. The characteristic part of the workpiece W is not particularly limited, but can be, for example, the edge portion of the workpiece W or the code portion that the workpiece W has. The edge portion of the workpiece W is easy to detect, making it easier to improve the accuracy of adjustment. The method for calculating the characteristic part of the workpiece W is not limited to one, for example, the control unit 107 can calculate the characteristic part of the workpiece W in the captured image based on the detection signal from the work sensor 92 and the conveyor information.

The following explains specific examples of methods for identifying characteristic parts of the workpiece W. The control unit 107 can identify the edge portions of the workpiece W detected by performing edge detection processing on the captured image as characteristic parts. For example, when the workpiece W is positioned at a distant location, assuming it is at a distant location, super-resolution processing or optimal edge detection processing can be executed. For a code reader 1 installed directly above the workpiece W, it can determine whether the workpiece W is near or far in the Z direction. Additionally, for a code reader 1 installed on the side of the workpiece W, it can determine whether the workpiece W is near or far in the X direction.

Furthermore, the control unit 107 can also identify the detected part as a characteristic part by executing code detection processing on the captured image. The code detection processing can be performed similarly to the processing by the code detection unit 43. Additionally, the control unit 107 can also identify the part where decoding processing has succeeded as a characteristic part by executing decoding processing on the captured image. The decoding processing can be performed similarly to the processing by the decoding unit 44. In other words, the coordinates specified by executing image processing such as edge detection processing, code detection processing, or decoding processing on the captured image can be used as the coordinates of the position corresponding to the characteristic part of the workpiece W. Image processing may include object detection processing in addition to the above, and it may be rule-based detection processing or detection processing utilizing AI (Artificial Intelligence).

The control unit 107 acquires the position of the characteristic part of the workpiece W in the coordinate system of the conveyor B and the corresponding position of the characteristic part of the workpiece W in the UV coordinate system of the captured image. Then, the control unit 107 further adjusts the parameters of the adjusted calibration model in the conveying direction based on the position of the characteristic part of the workpiece W in the coordinate system of the conveyor B and the corresponding position of the characteristic part of the workpiece W in the UV coordinate system of the captured image.

In other words, the control unit 107 acquires the detection time (the time when the detection signal was output) of the work sensor 92 and the imaging time of the imaging unit 3, and calculates the elapsed time from the detection time to the imaging time. The control unit 107 estimates the leading edge position of the workpiece W based on the calculated elapsed time and the conveying speed of the workpiece W, and draws it as an edge display line 404 on the adjustment image.

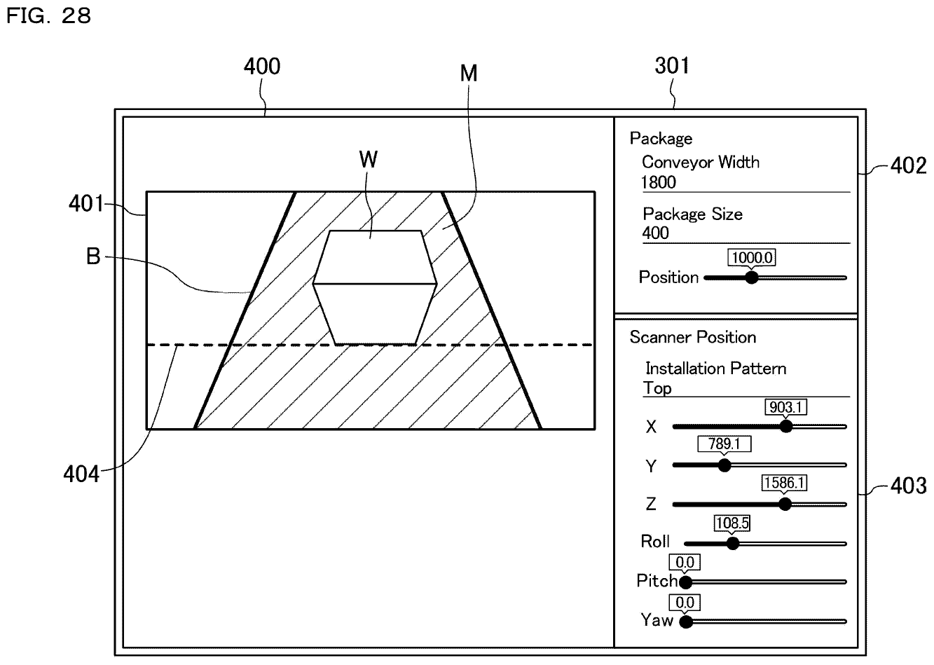

When the position parameters of the code reader 1 are changed to align the edge display line 404 with the corresponding edge portion of the workpiece W, the changes in the position parameters are reflected on the display user interface screen 400 as shown in FIG. 28. At this time, the Y-coordinate of the code reader 1 is adjusted. In other words, the operation of aligning the edge display line 404 with the corresponding edge portion of the workpiece W is an operation performed by the user operating the operation unit 302 etc. through the display unit 301, and is an operation for modifying the installation information. When the display processing unit 108 accepts the modification of the installation information from the user through the display unit 301, it changes and displays at least one of the conveyor position and the position of the characteristic part of the workpiece W on the installation confirmation image according to the modification. The operation for modifying the installation information may be an operation of directly inputting numerical values included in the installation information, for example, without going through the display unit 301.

Furthermore, the installation information can also be modified by directly moving the edge display line 404 vertically on the display user interface screen 400. In this way, the coordinates of the position corresponding to the characteristic part of the workpiece W in the UV coordinate system of the captured image can be the coordinates specified by the user as the characteristic part of the workpiece W for that captured image. Additionally, in the installation confirmation image, it is sufficient to show at least one of the conveyor position and the characteristic part of the workpiece W, without necessarily showing both the conveyor position and the characteristic part of the workpiece W.

The control unit 107 can cause the imaging unit 3 to capture images of the workpiece W conveyed by the conveyor B multiple times at different timings. In this case, the control unit 107 can adjust the parameters of the calibration model in the conveying direction based on the position of the characteristic part of the workpiece W in the coordinate system of the conveyor B and the corresponding position of the characteristic part in the UV coordinate system of each captured image, for each of the multiple captured images taken by the imaging unit 3 at different timings of the workpiece W conveyed by the conveyor B. In other words, since the UV coordinates of the edge portion specified by the user or the position detected by image processing may not necessarily accurately indicate the characteristic part of the workpiece W, the accuracy can be improved by repeating the parameter adjustment multiple times.

FIGS. 25 to 28 show a case where the code reader 1 is installed above the workpiece W, but the code reader 1 can also be installed at the side of the workpiece W as shown in FIG. 3 or FIG. 4A. The following explanation is about the case where the code reader 1 is installed at the side of the workpiece W.

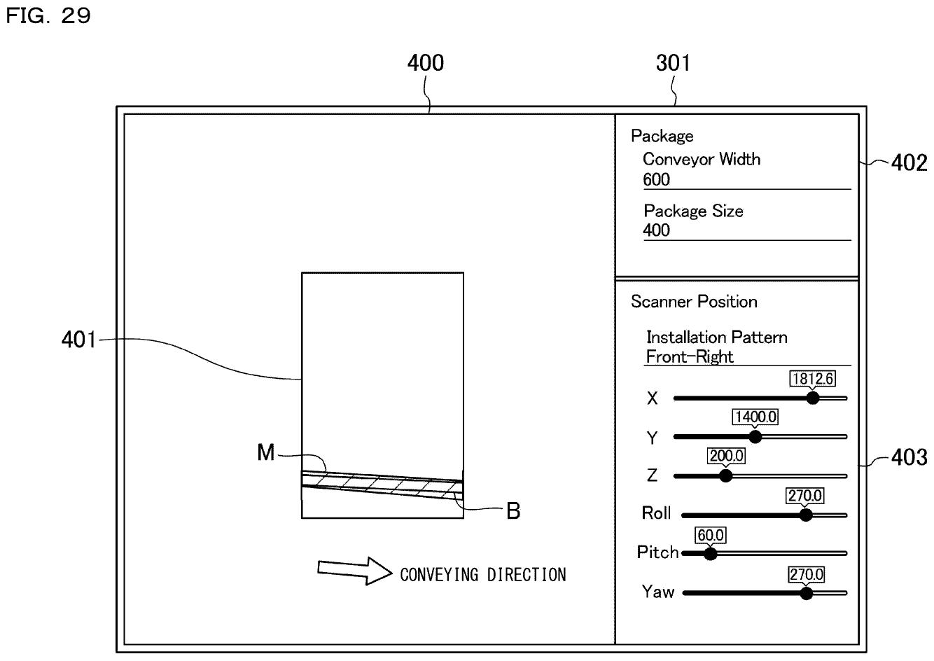

FIG. 29 shows an installation confirmation image when the code reader 1 is installed to capture the workpiece W from the side upstream of the workpiece W. In this example, the long axis direction of the image sensor 31b is aligned with the Z direction in the coordinate system of the conveyor B. Additionally, it shows a case where the workpiece W moves from downstream to upstream in the conveying direction. The control unit 107 can, for example, acquire the installation angle of the imaging unit 3 in the coordinate system of the conveyor B, and based on the acquired installation angle, determine the direction of the field of view of the imaging unit 3. If the image sensor 31b is a custom sensor capable of reading out in the short axis direction of the image sensor as shown in FIG. 19, the readout direction of the image sensor 31b can be aligned with the conveying direction.

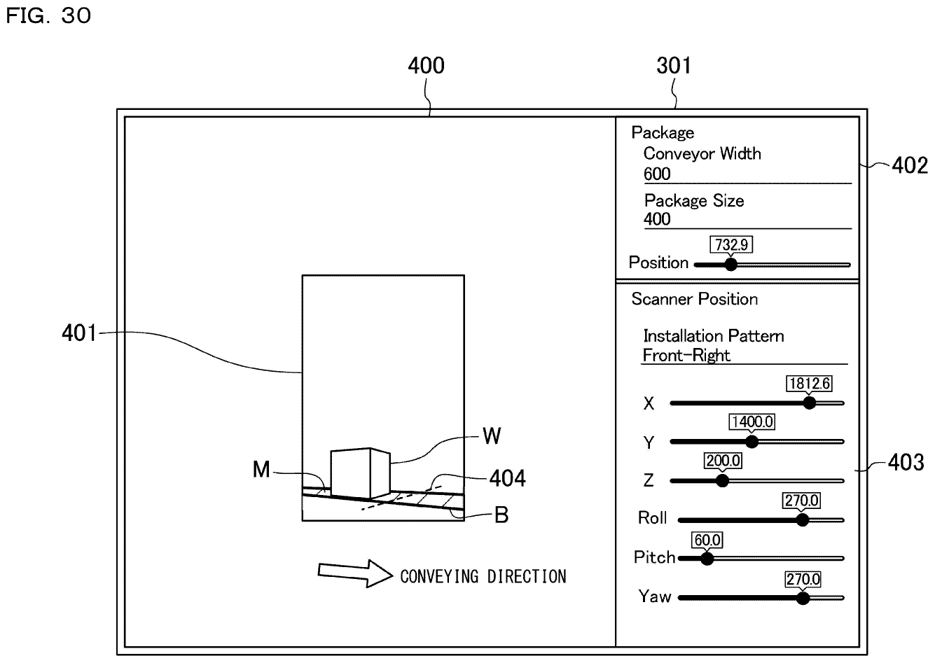

FIG. 30 shows an example of displaying an image captured from the upstream side of the conveyed workpiece W, and an installation confirmation image with edge display lines 404 drawn on the captured image is displayed in the image display area 401. The control unit 107 acquires the detection signal of the work sensor 92 and the conveyor information, and based on the acquired detection signal and conveyor information, controls the imaging unit 3 to send a trigger to the imaging unit 3 to generate the captured image in such a way that the characteristic part of the workpiece W is included in the installation confirmation image.

Specifically, when the field of view of the imaging unit 3 extends from the upstream side to the downstream side in the conveying direction, the control unit 107 identifies the leading edge (edge portion at the upstream end in the conveying direction) of the workpiece W as the characteristic part of the workpiece W. When the edge display line 404 is aligned with the corresponding edge portion of the workpiece W (edge portion at the upstream end in the conveying direction), the Y-coordinate of the code reader 1 is adjusted. In this way, when the field of view of the imaging unit 3 is directed from the downstream side to the upstream side of the conveyor B, the acquisition unit 101 obtains the user's specification of the leading edge of the workpiece W as the characteristic part of the workpiece W.

After the parameters of the calibration model have been adjusted in this manner, during operation, the control unit 107 determines the area where the workpiece W is imaged as the first partial area to be read as a signal from the image sensor 31b. Once the first partial area is determined, the signal from the first partial area is read from the image sensor 31b and becomes displayable as shown in FIG. 17.

The control unit 107 controls the imaging unit 3 such that when the field of view of the imaging unit 3 is directed from the downstream side to the upstream side of the conveyor B, the leading edge of the workpiece W is included in the installation confirmation image as a characteristic part of the workpiece W, that is, the leading edge of the workpiece W is included in the area from which signals are read out from the image sensor 31b.

During operation, the control unit 107 can also determine a second partial area in the image where image processing is to be executed. For example, when executing masking process as image processing, the area other than the workpiece W in the image can be set as the second partial area, and by executing the masking process on this second partial area, the area where decoding process is not to be executed can be identified. The second partial area can be set as an excluded range for code search, or even if a code is found as a result of code search, it can be set so that decoding process is not executed.

Furthermore, super-resolution processing can be executed as image processing. In this case, the portion of the workpiece W in the image is set as the second partial area, and by executing super-resolution processing on this second partial area, the reading success rate can be improved even for difficult-to-read codes. In this way, the control unit 107 can recognize the conveying state of the workpiece W being transported on the conveyor B based on, for example, the detection signal from the work sensor 92 and the conveying speed of the conveyor B. Then, based on the conveying state of the workpiece W and the adjusted calibration model, the control unit 107 can determine at least one of the first partial area from which signals are read out from the image sensor 31b, and the second partial area on which image processing is executed in the captured image.

The control unit 107 can determine at least one of a first partial area that includes the target workpiece while not including the adjacent workpiece, and a second partial area that includes the adjacent workpiece on which masking process is executed, when the field of view (FOV) of the imaging unit 3 includes both the target workpiece as the imaging target and the adjacent workpiece adjacent to the target workpiece. Specifically, as shown in FIG. 16, when the target workpiece is set as the reading target workpiece W1 and the adjacent workpiece is set as the forward workpiece W2, the control unit determines the first partial area (the same area as area E in FIG. 16) that includes the reading target workpiece W1 while not including the forward workpiece W2. In this case, the first partial area becomes the area from which signals are read out from the image sensor 31b. Also, as shown in FIG. 17, the control unit 107 can determine the second partial area (mask area F in FIG. 17) that includes the forward workpiece W2, and in this case, the second partial area becomes the area where the masking process is executed.

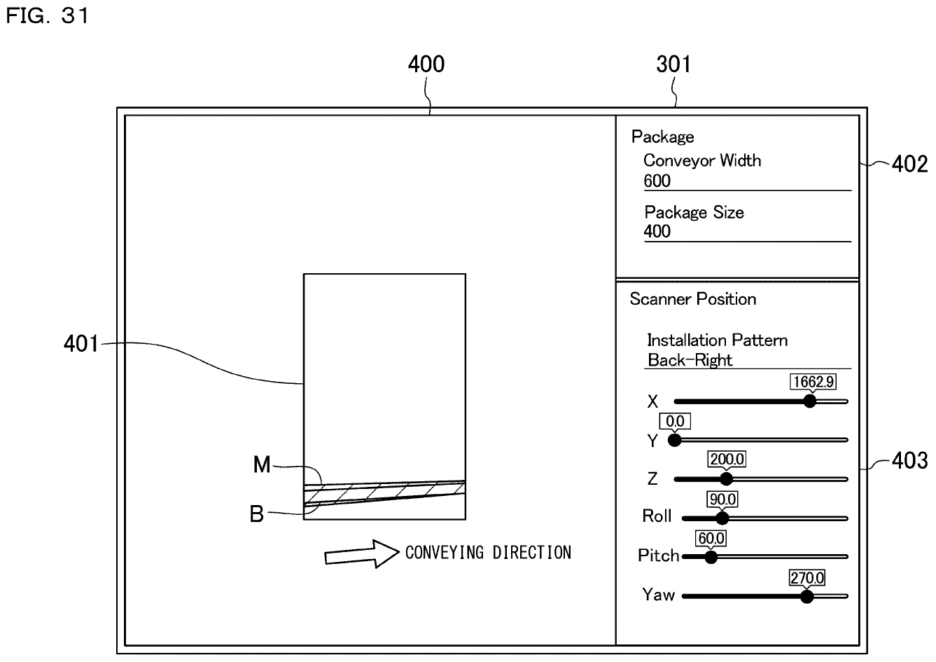

FIG. 31 shows the conveyor position M when the code reader 1 is installed to capture the workpiece W from the side at the downstream side of the workpiece W. In this example, similar to the example shown in FIG. 29, the long axis direction of the image sensor 31b is aligned with the Z direction in the coordinate system of the conveyor B.

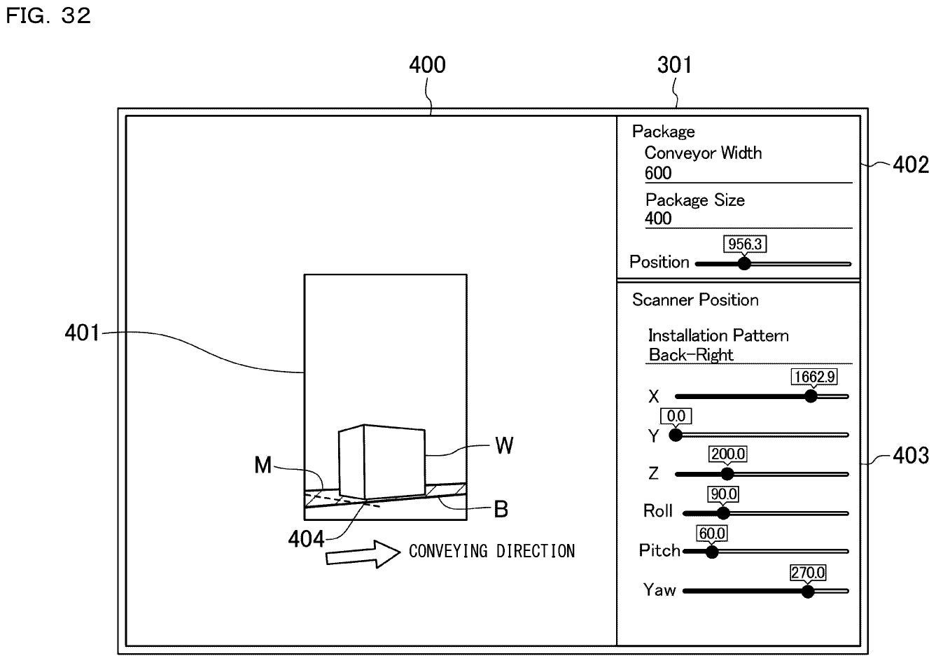

FIG. 32 shows an example of displaying an image captured from the downstream side of the transported workpiece W, where an edge display line 404 is drawn on the captured image. Specifically, when the field of view of the imaging unit 3 extends from the downstream side to the upstream side in the conveying direction, the control unit 107 identifies the trailing edge (edge portion at the downstream end in the conveying direction) of the workpiece W as the characteristic part of the workpiece W. By aligning the edge display line 404 with the corresponding edge portion of the workpiece W (edge portion at the downstream end in the conveying direction), the Y-coordinate of the code reader 1 is adjusted. In this way, when the field of view of the imaging unit 3 extends from the upstream side to the downstream side of the conveyor B, the acquisition unit 101 can also obtain a user's designation of the trailing edge of the workpiece W as the characteristic part of the workpiece W.

When the characteristic part of the workpiece W is the trailing edge of the workpiece W, the imaging unit 3 is controlled to include the characteristic part in the installation confirmation image, similar to the case when it is the leading edge. Specifically, when the field of view of the imaging unit 3 moves from the upstream side to the downstream side of the conveyor B, the control unit 107 controls the imaging unit 3 so that the trailing edge of the workpiece W is included in the installation confirmation image as the characteristic part of the workpiece W.

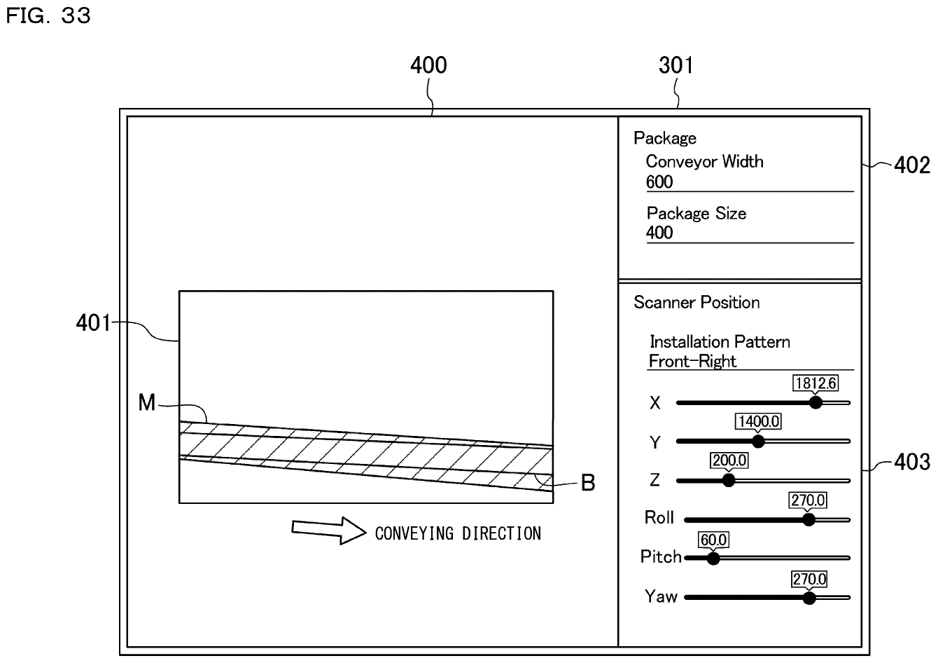

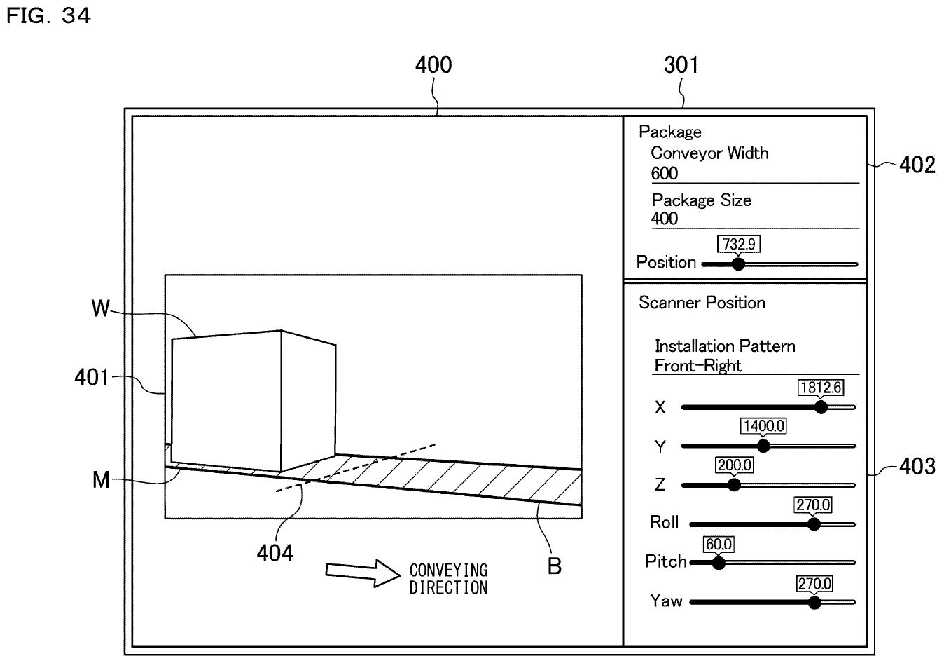

FIG. 33 relates to a modification of the example shown in FIG. 29, and in this modification, the short axis direction of the image sensor 31b is aligned with the Z direction in the coordinate system of the conveyor B. When the image sensor 31b is a custom sensor, the readout direction of the image sensor 31b can be aligned with the Z direction. In this modification as well, as shown in FIG. 34, the edge display line 404 is drawn on the captured image, so when the edge display line 404 is aligned with the corresponding edge portion of the workpiece W, the Y coordinate of the code reader 1 is adjusted.

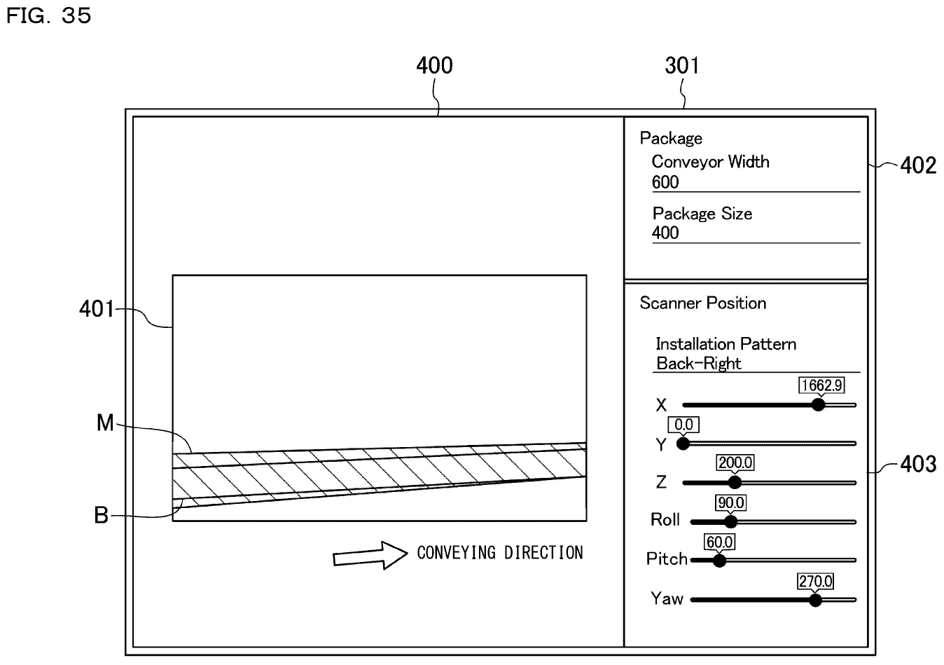

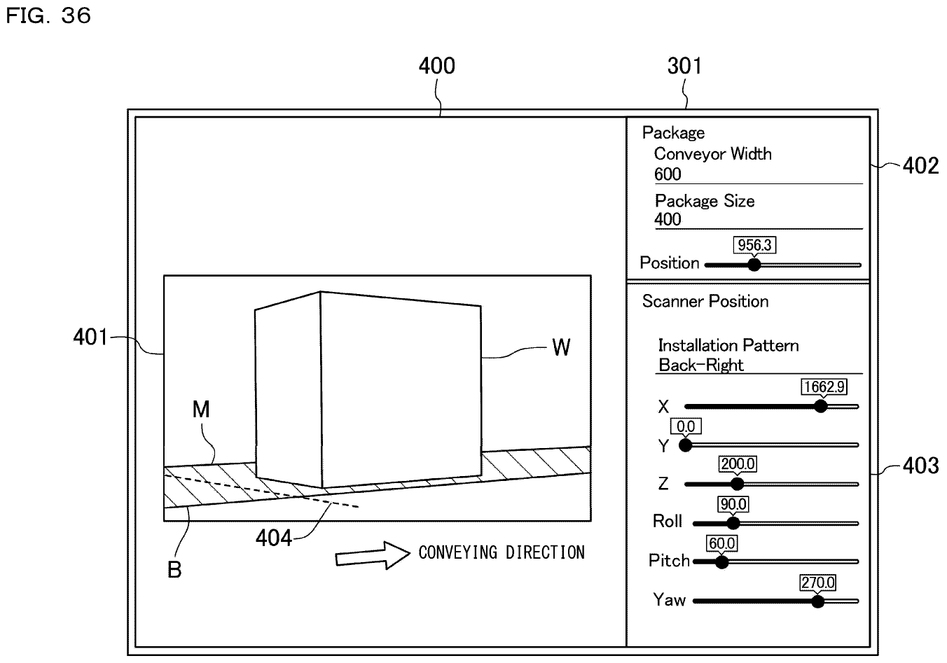

FIG. 35 relates to a modification of the example shown in FIG. 31, and in this modification, the short axis direction of the image sensor 31b is aligned with the Z direction in the coordinate system of the conveyor B. When the image sensor 31b is a custom sensor, the readout direction of the image sensor 31b will coincide with the Z direction. In this modification as well, as shown in FIG. 36, the edge display line 404 is drawn on the captured image, so by aligning the edge display line 404 with the corresponding edge portion of the workpiece W, the Y coordinate of the code reader 1 is adjusted.

Even when code readers are installed at multiple installation positions as shown in FIG. 3, according to the above configuration, during calibration, by transporting the workpiece W only once using the conveyor B, images as shown in FIG. 27, FIG. 30, FIG. 32, FIG. 34, and FIG. 36 can be collectively acquired for adjusting the conveying direction parameters of the calibration models for each code reader. Therefore, the burden on the user during calibration can be reduced.

As shown in FIG. 9, the controller 100 includes an output unit 109. The output unit 109 is a part that outputs an installation confirmation report including an installation confirmation image showing the conveyor position and characteristic parts of the workpiece W in the captured image. The installation confirmation report may include, along with the installation confirmation image, any one or more of the code reading test results by the decoding unit 44, installation date and time, installation location, installation information, camera information, and workpiece information. The installation confirmation report may be output in the form of an electronic file (electronic data) or may be output by being printed on paper media. By creating an installation confirmation report, the basis for the reading test results can be shown in images.

The controller 100 generates image output parameters and transmits them to the code reader 1. When the code reader 1 receives the image output parameters transmitted from the controller 100, it executes image output processing according to the received image output parameters. The image output parameters can be used to execute the output of setting images and the output of collection images.

The setting image is output to the setting device 300 etc. for user confirmation, and is a test image used in the code reading test at the time of setting, and a captured image used in installation adjustment. Based on this captured image, an installation confirmation image is generated.

The collection image is output to the collection and analysis device 200, and is used as an analysis image for the error analysis function to be described later, as a learning image, and for user confirmation when an error occurs.

### (Reading Error Analysis Function)

During the operation of the code reader system S, there are times when code reading fails. This is called a reading error, and since the causes of reading errors are diverse, it can be difficult for users to identify them. To address this, the code reader system S of the present embodiment has a reading error analysis function as a feature to facilitate error resolution by users by estimating the cause of reading errors based on images associated with the workpiece ID assigned to each workpiece W. In the reading error analysis function, it is possible to identify when and where on the conveyor B a workpiece W is located, enabling error analysis on a per-workpiece basis, making it easier to determine why a particular workpiece W could not be read and to identify the cause of the reading error. The reading error analysis function can be realized by the collection and analysis device 200, which is a personal computer as mentioned above. This personal computer can be cited as an example configuration including a microcomputer with a processor (including CPU and GPU), ROM, RAM, etc.

When the control unit 107 of the controller 100 acquires a detection signal from the work sensor 92, it generates a work ID for each workpiece W based on the acquired detection signal. The work ID is identification information for identifying the workpiece W and is different for each workpiece W. The work ID generated by the control unit 107 is associated with the image generated by the imaging unit 3 and is also associated with the result of the decoding process by the decoding unit 44.

As shown in FIG. 3, FIG. 4A, and FIG. 4B, in operation examples 1 and 2 where multiple code readers 1 capture images of a common workpiece W, multiple images are generated by the imaging units 3 of the multiple code readers 1. The image storage unit 201 (for example, SSD or HDD) of the collection and analysis device 200 stores multiple images (collection images) generated by the imaging units 3 of the multiple code readers 1, associated with corresponding workpiece IDs. Additionally, when the decoding unit 44 performs decoding processing on the code in each image, there are cases where the reading is successful and cases where it fails. The images of workpieces W for which reading was successful and the images of workpieces W for which reading failed are each associated with workpiece IDs.

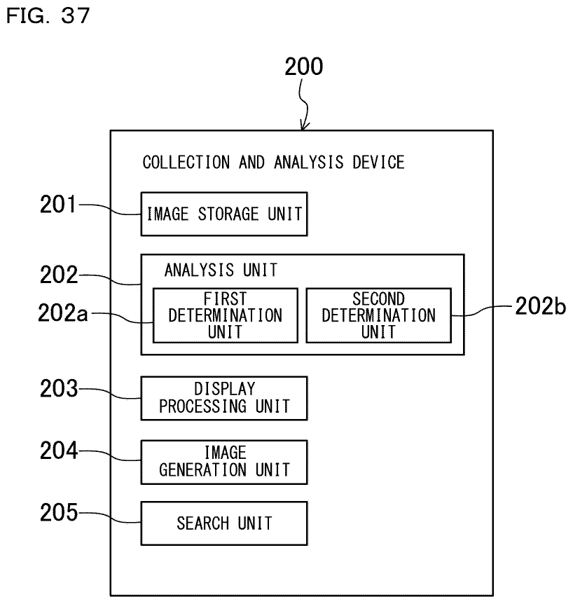

As shown in FIG. 37, the collection and analysis device 200 has an analysis unit 202 for estimating the error cause, and the analysis unit 202 is realized by a processor (for example, a GPU). Based on the results of the decoding process corresponding to each workpiece ID, the analysis unit 202 identifies the workpiece ID associated with the image that failed to be read as an error work ID, and leaves the workpiece IDs associated with other images, i.e., images that were successfully read, as they are. This allows the analysis unit 202 to automatically classify images associated with error work IDs and other images. Additionally, the analysis unit 202 estimates the error cause based on multiple images associated with the error work IDs.

Specifically, the analysis unit 202 includes a first determination unit 202a that determines the presence or absence of a code using images associated with the error work ID, and a second determination unit 202b that determines the presence or absence of a workpiece using images associated with the error work ID. The first determination unit 202a identifies the code region based on the images associated with the error work ID and detects the code from the identified code region. It can determine the presence or absence of the code through a process similar to that of the code detection unit 43, for example. The first determination unit 202a determines that a code was attached to the workpiece W associated with the error work ID if it detects a code in at least one of the images associated with the error work ID.

The first determination unit 202a has a machine learning model pre-trained with multiple code images, and is configured to determine the presence or absence of a code for an image corresponding to an error work ID using this machine learning model. Since the code itself does not change significantly for each user, unlike the detection of workpiece W, code detection can be pre-learned to save user effort. For the machine learning model of the first determination unit 202a, a machine learning model using, for example, a convolutional neural network (CNN) can be adopted. It should be noted that the first determination unit 202a may also use rule-based detection.

The second determination unit 202b determines that the workpiece W corresponding to the error work ID was being transported normally if it detects the workpiece W in at least one of the images associated with the error work ID. The determination result of the second determination unit 202b can also determine if the workpiece W was not being transported. The second determination unit 202b has a machine learning model that is trained using conveyor images (images of the conveyor) captured by multiple code readers 1 installed around the conveyor B, where the workpiece W is not included in the field of view. For example, the code reader 1 can acquire background images by capturing the conveyor B when the workpiece W is not included in the field of view. By inputting the background images as learning images into the machine learning model, it becomes possible to train the machine learning model. For the machine learning model of the second determination unit 202a, a machine learning model using a convolutional neural network (CNN) can be adopted, for example. For instance, the second determination unit 202a learns only the background images and then detects the difference between the features of the background images and the features of the images input during operation (i.e., the workpiece on the conveyor B). Additionally, the second determination unit 202a may learn not only background images but also images with workpieces W on the conveyor B. This can improve the accuracy of determining the presence or absence of workpieces if there is little variation in the appearance and size of the transported workpieces W.

The second determination unit 202b uses a machine learning model to determine the presence or absence of the workpiece W in the image corresponding to the error work ID. By inputting the image corresponding to the error work ID into the machine learning model of the second determination unit 202b, it is possible to accurately determine whether the workpiece W is present in that image. By training the machine learning model of the second determination unit 202b using conveyor images according to the installation conditions of the conveyor B and code reader 1 used by the user, it becomes less susceptible to scratches on the conveyor B and changes in exposure timing, thereby improving the detection accuracy of the workpiece W.

The second determination unit 202b is configured to be capable of learning with new conveyor images at predetermined time intervals or at timings specified by the user. Specifically, since the conveyor B deteriorates over time, by periodically relearning or additionally learning the machine learning model of the second determination unit 202b, detection corresponding to the current state of the conveyor B becomes possible, making erroneous determinations less likely to occur. The predetermined time intervals are, for example, intervals of several days, several weeks, or several months. It should be noted that the second determination unit 202b may also perform rule-based detection.

The analysis unit 202 estimates the error cause for each error work ID using the first determination unit 202a and the second determination unit 202b. The order of determination by the analysis unit 202 can also be specified. For example, the analysis unit 202 determines the presence or absence of the workpiece W by the second determination unit 202b for images associated with the error work ID that were determined to have no code by the first determination unit 202a. Although the determination by the first determination unit 202a may be performed after the determination by the second determination unit 202b, performing the determination by the second determination unit 202b after the determination by the first determination unit 202a can shorten the processing time. For example, if a code exists, the workpiece W exists, but even if the workpiece W exists, it is not known whether a code is attached. Therefore, the processing time can be shortened by terminating the process when a code is detected, assuming that the workpiece W also exists.

The error causes include a first type where a code exists in the image associated with the error work ID but reading fails, and a second type where no code exists in the image associated with the error work ID but the corresponding workpiece W was normally transported. When determining which of the first type or second type it belongs to, the determination results of the first determination unit 202a and the second determination unit 202b can be used. This allows for identifying whether the error cause is attributed to the code itself or to the fact that no code is attached to the workpiece W. For example, assuming about 8 code readers 1 are installed, if 5 images are captured per workpiece W, there would be 40 images per workpiece W, making it burdensome for the user to check each image individually. However, by determining whether it belongs to the first type or the second type and presenting this to the user, it becomes even easier for the user to implement error countermeasures.

The causes of reading errors may include a third type where the workpiece W corresponding to the error work ID does not exist or was not properly conveyed. When determining whether it belongs to the third type, for example, the determination result of the second determination unit 202b can be used. By including the third type in the causes of reading errors, it becomes possible to identify whether the workpiece W itself was not within the field of view of the imaging unit 3, making it even easier for users to implement error countermeasures. As an example belonging to the third type, there is a possibility that the workpiece W cannot be imaged when the position or conveying speed of an object detected by the work sensor 92 or encoder 91 no longer corresponds to the time of the code reader 1 due to some factor including program defects or mechanical failures. Additionally, cases where only a work ID is generated even though the workpiece W is not being transported, due to malfunctions of the work sensor 92 or encoder 91, can also be cited as examples belonging to the third type.

The analysis unit 202 can set the number of images that succeeded in decoding process, among multiple images associated with a workpiece ID, as a threshold for determining the workpiece ID as successfully read. If the number of images that succeeded in decoding process is equal to or greater than a predetermined number, the workpiece ID of that workpiece W is determined as successfully read. The analysis unit 202 is configured to variably set the number of images that serves as the threshold for determining a workpiece ID as successfully read. By being able to change the number of images serving as the threshold, the level of reading stability can be adjusted. For example, when there are multiple codes, the determination can be made per code type or per workpiece. If even one type of code among multiple types does not exceed the threshold, that workpiece W can be determined as a reading failure. Also, in a case where there are, for example, 5 decoding chances for one workpiece W, if 2 out of 3 types of decodes succeed 5 times, but one type of decode succeeds only once, this can be determined as a reading failure due to low reading stability.

The collection and analysis device 200 has a display processing unit 203, which is realized by a processor. The display processing unit 203 acquires the cause of reading errors estimated by the analysis unit 202 along with the error work ID, and displays on the display unit 301 the image associated with the error work ID together with the cause of the reading error corresponding to the acquired error work ID. The display unit 301 may be configured as a display device that can be installed separately from the main body of the setting device 300, or it may be integrated with the main body of the setting device 300.

The collection and analysis device 200 has an image generation unit 204. The image generation unit 204 is a part that generates a package image showing the appearance of the workpiece W by synthesizing multiple images associated with each workpiece ID. The package image may be generated by the collection and analysis device 200 or by the control unit 4 of the code reader 1.

When the workpiece W conveyed by the conveyor B is imaged multiple times by the imaging unit 3 at regular time intervals (regular distance intervals), partial images of the workpiece W are generated, sequentially captured from the upstream part to the downstream part in the conveying direction of the workpiece W. These partial images are images of the same workpiece W, so they are associated with the same workpiece ID. The image generation unit 204 synthesizes multiple partial images associated with the same workpiece ID in the order they were captured to generate a single package image. The date and time information based on the imaging date and time of the images used to generate the package image is appended with the internal time from the internal clock, etc. of the code reader 1. Here, the collection and analysis device 200 can convert the date and time information of the images to external time by receiving the correspondence relationship between the internal time of the code reader 1 and external time such as UTC from the controller 100.

When the image generation unit 204 generates a package image, it transmits the generated package image to the image storage unit 201. The image storage unit 201 stores the package image generated by the image generation unit 204 in association with the corresponding workpiece ID. At this time, the image storage unit 201 stores the package image along with date and time information based on the imaging date and time of the image used to generate the package image. The date and time information stored in the image storage unit 201 is also associated with the workpiece ID.

Furthermore, when multiple code readers 1 are used in operation, the image generation unit 204 generates package images for each code reader 1. For example, the image generation unit 204 extracts multiple images corresponding to each workpiece W for each of the multiple code readers 1. At this time, multiple images corresponding to each workpiece W can be extracted based on the workpiece ID. The image generation unit 204 can generate package images of the respective workpieces W by synthesizing the extracted multiple images.

The package images generated by the image generation unit 204 for each code reader 1 are stored in the image storage unit 201 in association with the corresponding workpiece ID. At this time, each package image can also be stored in the image storage unit 201 in a state associated with identification information that identifies the imaged code reader 1. When package images corresponding to each workpiece are generated for each of multiple code readers 1, each package image can be stored in the image storage unit 201.

The code reader system S further includes a search unit 205 that searches for the package image based on date and time information specified by the user, and the search unit 205 is realized by a processor. The search unit 205 may be provided in the collection and analysis device 200 or in the setting device 300. When a user specifies date and time information by operating, for example, the operation unit 302 of the setting device 300, the specified date and time information is accepted by the search unit 205. Upon receiving the date and time information, the search unit 205 searches for a package image synthesized from images captured at the imaging date and time specified by that date and time information, from among multiple package images stored in the image storage unit 201. The searched package image is displayed on the display unit 301 by the display processing unit 203. At this time, the work ID associated with the package image may also be displayed on the display unit 301. By having the package image storage and search function in the code reader system S, for example, when there is an inquiry about damage to the workpiece W from the person who ultimately handled the workpiece W after transportation, it is possible to confirm later what condition the workpiece W was in at which timing.

In addition, the search unit 205 can also search for package images from the workpiece ID. When a user operates the operation unit 302 of the setting device 300 to input a workpiece ID, the input workpiece ID is accepted by the search unit 205. Upon receiving the workpiece ID, the search unit 205 searches for the package image identified by that workpiece ID from among multiple package images stored in the image storage unit 201. The searched package image is displayed on the display unit 301 by the display processing unit 203.

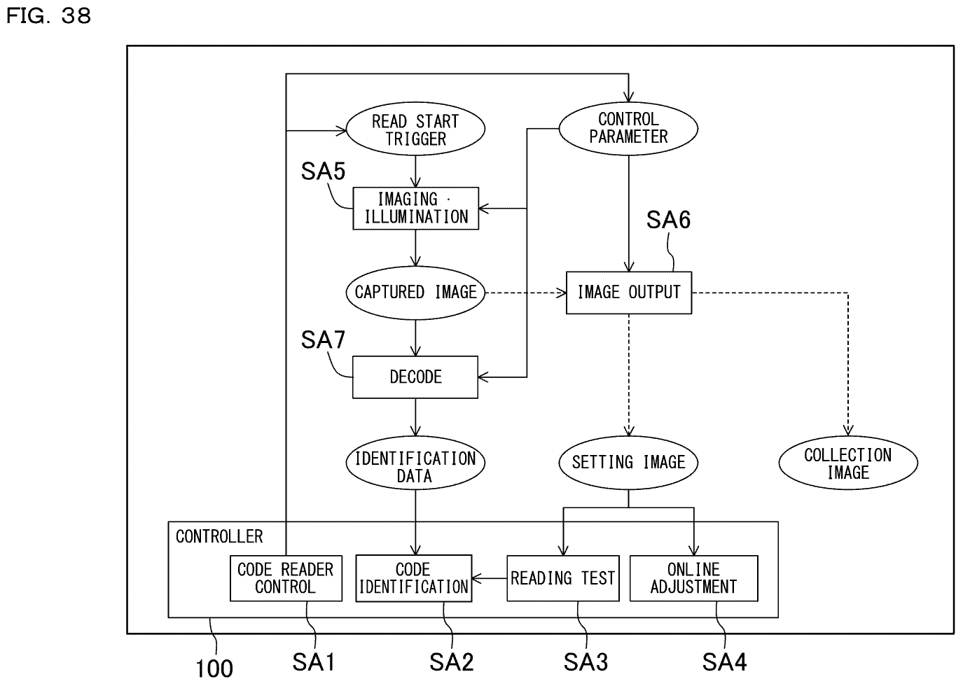

FIG. 38 is a flowchart showing an example of the process flow from image capture to image storage. The controller 100 executes a code reader control process (step SA1) that controls the code reader 1, a code identification process (step SA2) that identifies the code, a reading test process (step SA3) that executes a reading test of the code, and an online adjustment process (step SA4) during operation. First, the controller 100 executes the code reader control process SA1 and sends a read start trigger signal and control parameters to the code reader 1. Upon receiving the read start trigger signal, the code reader 1 executes illumination and imaging processing in step SA5. By performing step SA5, a captured image is generated. The captured image is sent to the controller 100 as a setting image by executing image output processing in step SA6. In the controller 100, the reading test process of step SA3 and the online adjustment process of step SA4 are executed based on the setting image. Additionally, the captured image is sent to the collection and analysis device 200 as a collection image and stored in the image storage unit 201.

In step SA7, the decoding unit 44 executes a decoding process on the captured image. The identification data for code identification generated by the decoding process is sent to the controller 100 and used in the code identification process of step SA2.

The controller 100, code reader 1, and dimension measurement unit 90 have a log function that accumulates logs within each device and outputs them to the collection and analysis device 200. The collection and analysis device 200 collects and accumulates logs output from the controller 100, code reader 1, and dimension measurement unit 90.

The format of the log data is not particularly limited, but for example, a line protocol can be used. The line protocol includes multiple fields such as a field indicating the log type, an identifier field, a log data field, a transmission time field, etc. This allows the collection and analysis device 200 to determine which device sent what kind of log and when.

The logs collected and stored in the collection and analysis device 200 include package logs, image collection logs, and system logs. The package log is a log for collecting detailed information about the workpiece W in chronological order. The controller 100 outputs the package log at the timing when the tracking of the workpiece W is completed (release point). The image collection log is an image generated by the aforementioned imaging unit 3, and the controller 100 outputs the image generated by the imaging unit 3 as an image collection log. The system log is a log related to the state changes of the entire system and events, and includes not only logs output from the controller 100 but also logs output from the code reader 1 and the dimension measurement unit 90.

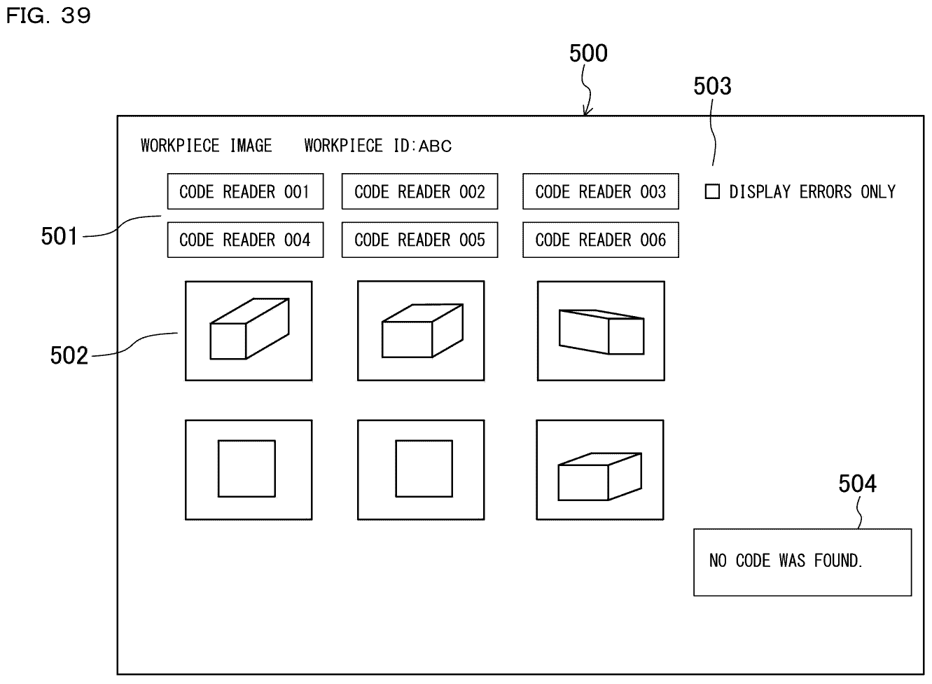

FIG. 39 shows an image display user interface screen 500 that the display processing unit 203 displays on the display unit 301. The image display user interface screen 500 includes a code reader display area 501, a workpiece image display area 502, and a checkbox 503 for displaying only errors. In the example shown in this FIG. 39, six code readers 001 to 006 are used as code readers in operation, and these six code readers 001 to 006 are displayed in the code reader display area 501. In the workpiece image display area 502, package images based on the images captured by each of the six code readers 001 to 006 are displayed. The package images displayed in the workpiece image display area 502 are thumbnail images, and by displaying thumbnail images, the computational load is reduced. The code reader 1 is not limited to the configuration with one imaging unit 3 as shown in FIG. 5, but may have a configuration with multiple imaging units 3 inside the housing of the code reader 1. In this configuration, even if it is a common housing, the code reader display area 501 may indicate that code readers are used on a per-imaging unit 3 basis as different code readers, and the workpiece image display area 502 may display package images based on images captured by each imaging unit 3.

In this example, since six code readers 001 to 006 capture images of the workpiece W from different directions, the package images displayed in the workpiece image display area 502 will be different images. When the user checks the checkbox 503 for displaying only errors, the search unit 205 detects this. Then, the search unit 205 searches for package images corresponding to error work IDs that failed to read the code, and the display processing unit 203 displays only the package images corresponding to the error work IDs in the workpiece image display area 502.

The display processing unit 203 can display on the display unit 301 the package image corresponding to each workpiece ID and the cause of the reading error for each workpiece ID. Specifically, the image display user interface screen 500 is provided with an error cause display area 504 for displaying the cause of the reading error. The analysis results by the analysis unit 202 are displayed in this error cause display area 504. For example, if the analysis unit 202 determines that there is no code, a message indicating that there is no code is displayed in the error cause display area 504. Also, if the analysis unit 202 determines that there is no workpiece W, a message indicating that there is no workpiece W is displayed in the error cause display area 504. In this way, by displaying the package image showing the appearance of the workpiece W along with the cause of the reading error, error resolution by the user becomes easier.

The display processing unit 203 can display statistical information based on the causes of reading errors corresponding to multiple error work IDs on the display unit 301. This statistical information includes, for example, the overall reading success rate, the effective reading rate excluding reading errors not caused by the code reader, and a breakdown of reading errors not caused by the code reader. This breakdown includes, for example, reading errors due to the absence of the workpiece itself, reading errors due to damage to the workpiece, and so on.

The display processing unit 203 can also display on the display unit 301 the package image corresponding to the error work ID for which code reading failed, in a manner that allows comparison with package images corresponding to other work IDs. “Other work IDs” include work IDs for which code reading was successful. For example, the display processing unit 203 generates an image display user interface screen, and on this image display user interface screen, it provides an area where the package image corresponding to the error work ID is displayed and an area where package images corresponding to other work IDs are displayed. By having the display processing unit 203 display the image display user interface screen on the display unit 301, the user can visually compare the package image for which code reading failed with the package images for which code reading succeeded, making it easier to visually identify the cause of the reading error.

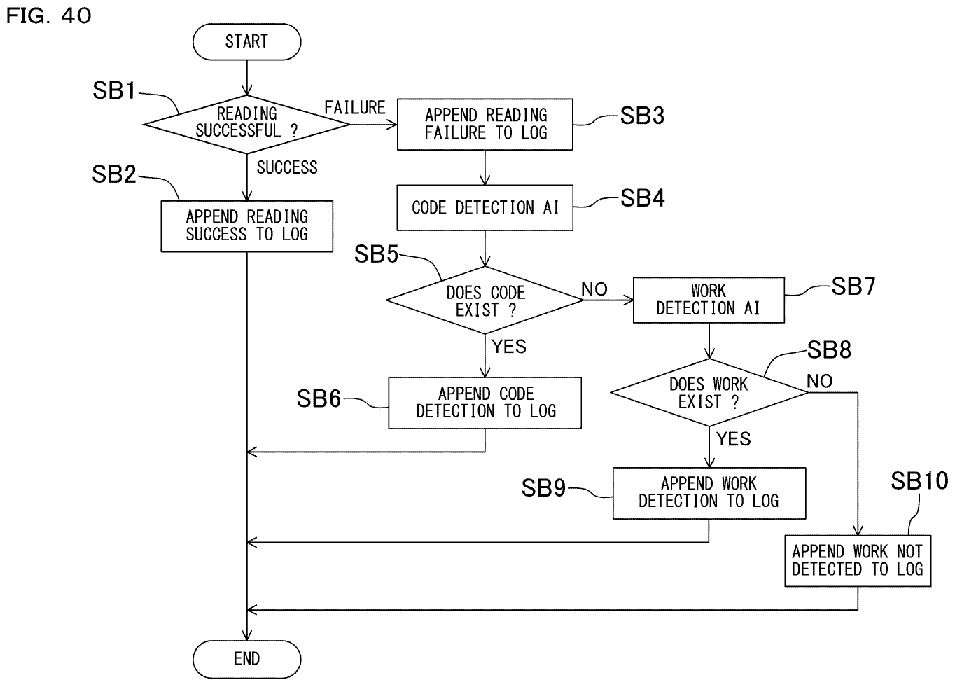

FIG. 40 is a flowchart showing the procedure from after the decoding process to appending the log.

In step SB1 after the start, the collection and analysis device 200 determines whether the code reading was successful or not. Whether the code reading was successful or not is determined based on the result of the decoding process. In addition to this, if the distance between adjacent workpieces W is narrower than a predetermined interval, there is a high risk of associating the information read in the decoding process with the wrong workpiece, so it may be considered as a reading failure regardless of the result of the decoding process.

If the code reading is successful, the process proceeds to step SB2, and the success of code reading is appended to the log and the process ends. “Append” means that the collection and analysis device 200 stores the log. If the code reading fails (step SB3), the failure of code reading is appended to the log and the process proceeds to step SB4.

In step SB4, the first determination unit (code detection AI) 202a of the analysis unit 202 executes the determination process for the presence or absence of a code. In step SB5, it determines whether the code exists or not. If the code exists, it proceeds to step SB6, appends to the log that the code exists, and ends. If the code does not exist, it proceeds to step SB7. In step SB7, the second determination unit (workpiece detection AI) 202b of the analysis unit 202 executes the determination process for the presence or absence of the workpiece W. In step SB8, it determines whether the workpiece W exists or not. If the workpiece W exists, it proceeds to step SB9, appends to the log that the workpiece W exists, and ends. If the workpiece W does not exist, it proceeds to step SB10, appends to the log that the workpiece W does not exist, and ends. The method for estimating the error cause based on the appended log is as described above. Additionally, when the workpiece W exists, it may execute a determination of whether the workpiece W is a box-type workpiece or a bag-type workpiece, or a determination of whether the workpiece W has any scratches.

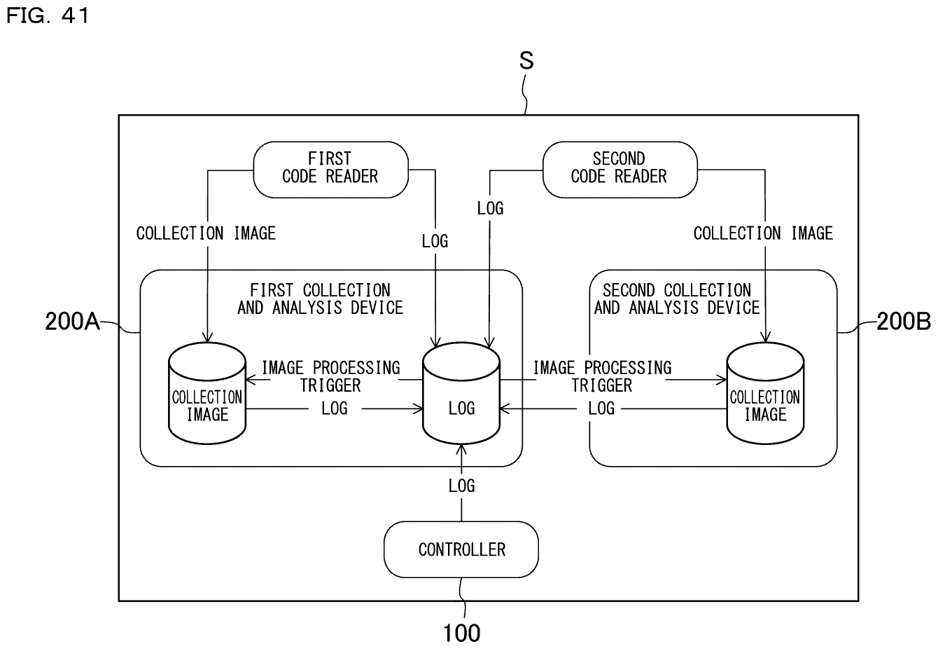

As shown in FIG. 41, the code reader system S may include multiple collection and analysis devices 200A and 200B. In the case shown in FIG. 41, the first collection and analysis device 200A and the second collection and analysis device 200B each constitute an image storage device, and multiple images and logs captured by multiple code readers 1 are distributed and stored in multiple collection and analysis devices 200A and 200B. For example, as the image data size per image increases, the processing load also increases accordingly, so there is a risk that memory processing may be delayed with a single collection and analysis device 200. In such cases, by distributing multiple images to multiple collection and analysis devices 200A and 200B for storage, the processing load can be distributed among multiple collection and analysis devices 200A and 200B, resolving the delay in memory processing. The collection and analysis devices 200A and 200B may be provided for each code reader 1, or for each group of multiple code readers 1. Additionally, multiple images sequentially generated by the code reader 1 may be distributed and stored in multiple collection and analysis devices 200A and 200B in the order they are generated. The number of collection and analysis devices 200 is not limited to two.

In the case where multiple collection and analysis devices 200A, 200B are provided, the analysis unit 202 can acquire multiple images related to error work IDs stored in a distributed manner in the multiple collection and analysis devices 200A, 200B, and estimate the cause of the reading error based on the acquired images.

The first collection and analysis device 200A can be set as the primary collection and analysis device, and the second collection and analysis device 200B can be set as the secondary collection and analysis device. In this case, the first collection and analysis device 200A executes main functions such as generating the log display screen and collecting logs. At the timing of log acquisition, the first collection and analysis device 200A sends an image processing trigger signal to the second collection and analysis device 200B.

The second collection and analysis device 200B collects and stores images output from the code reader 1, but stops major functions such as generating log display screens and collecting logs. When the second collection and analysis device 200B receives an image processing trigger signal from the first collection and analysis device 200A, it executes the generation process of package images and the automatic classification process of images. Additionally, it updates the log data of the first collection and analysis device 200A based on the analysis results from the analysis unit 202.

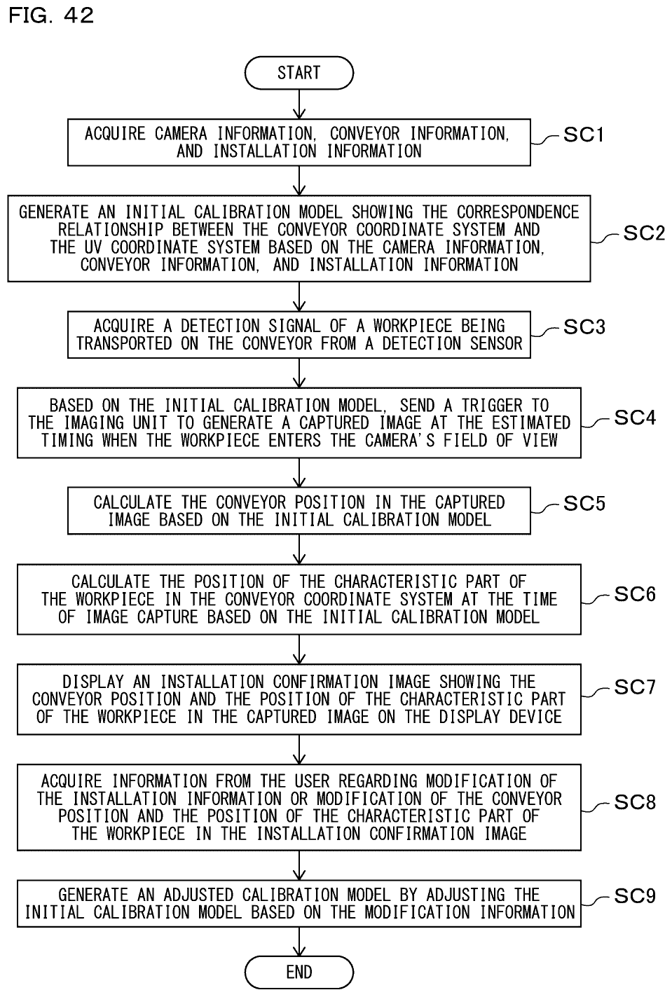

FIG. 42 is a control flowchart of the controller 100 when executing the generation and adjustment of the above-mentioned calibration model of the code reader system S. The details of each step correspond to the explanation in the above-described embodiment.

After the start, in step SC1, the controller 100 acquires camera information, conveyor information, and installation information. In step SC2, the controller 100 generates an initial calibration model showing the correspondence relationship between the conveyor coordinate system and the UV coordinate system based on the camera information, conveyor information, and installation information. After generating the initial calibration model, the calibration model is adjusted by transporting the workpiece W on the conveyor.

In step SC3, the controller 100 acquires a detection signal of the workpiece W being conveyed on the conveyor from the work sensor 92. In step SC4, based on the initial calibration model, the controller 100 sends a trigger to the imaging unit 3 to generate a captured image at the timing when it is estimated that the workpiece W has entered the camera's field of view. In step SC5, the controller 100 calculates the conveyor position in the captured image based on the initial calibration model. In step SC6, the controller 100 calculates the position of the characteristic part of the workpiece W in the conveyor coordinate system at the time of imaging, based on the initial calibration model. In step SC7, the controller 100 displays an installation confirmation image on the display device, showing the conveyor position M and the position of the characteristic part of the workpiece W in the captured image. In step SC8, the controller 100 acquires information from the user regarding the modification of installation information, or the modification of the conveyor position and the position of the characteristic part of the workpiece in the installation confirmation image. Here, an example of displaying the conveyor position and the position of the characteristic part of the workpiece W in the same captured image is shown, but this is not limited to this. In other words, after adjusting parameters other than the conveying direction using a captured image of only the conveyor without the workpiece W, the parameters of the conveying direction can be adjusted using another captured image including the workpiece W being conveyed on the conveyor.

In step SC9, the controller 100 adjusts the initial calibration model based on the modification information obtained in step SC8, generates an adjusted calibration model, and completes the generation and adjustment of the calibration model.

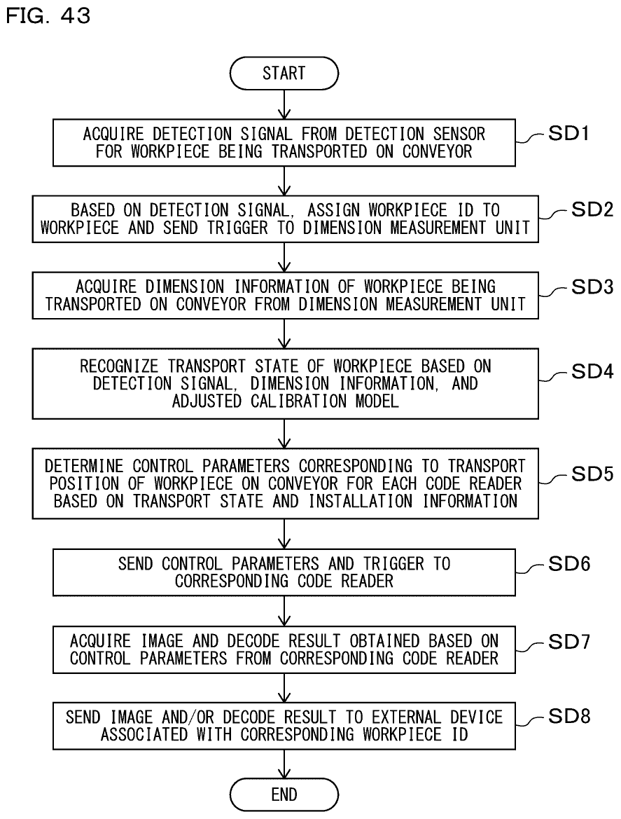

FIG. 43 is a control flowchart of the controller 100, showing the process from when the code reader system S detects a workpiece to when it transmits the reading result to the external device, using the adjusted calibration model generated in FIG. 42. The details of each step correspond to the explanations in the above-described embodiment.

In step SD1 after the start, the controller 100 acquires a detection signal of the workpiece W being transported on the conveyor from the work sensor 92. In step SD2, the controller 100 assigns a work ID to the workpiece W based on the detection signal and sends a trigger to the dimension measurement unit 90. In step SD3, the controller 100 acquires dimension information of the workpiece W being transported on the conveyor from the dimension measurement unit 90. In step SD4, the controller 100 recognizes the transport state of the workpiece W based on the detection signal, dimension information, and adjusted calibration model. In step SD5, the controller 100 determines control parameters corresponding to the transport position of the workpiece W on the conveyor for each code reader 1, based on the transport state and installation information. In step SD6, the controller 100 sends the control parameters and trigger to the corresponding code reader 1. In step SD7, the controller 100 acquires images and decode results obtained based on the control parameters from the corresponding code reader 1. In step SD8, the controller 100 sends the images and/or decode results to external devices (data communication device 93, collection and analysis device 200, setting device 300) associated with the corresponding work ID, and ends the control flow for one workpiece W. Then, the code reader system S repeats the above flow for each workpiece W sequentially transported on the conveyor.

### (Reading Stability Presentation Function)

The controller 100, based on the coordinate transformation coefficients between the imaging coordinate system of one or more code readers and the conveyor coordinate system, identifies at least one surface of multiple surfaces of the workpiece W in at least one image. Based on at least one image acquired from the code reader 1, the controller 100 measures evaluation data including at least one of capture information, which includes at least one of the area of the imaged region within the at least one surface of the workpiece W captured by the imaging unit 3 and the number of times the at least one surface was imaged, and information related to the reading of the code attached to the at least one surface. Then, the controller 100 outputs information indicating the stability of code reading using the imaging unit 3 for each of at least one surface of the workpiece W, based on the measured evaluation data. In this way, the controller 100 can estimate the reading stability of the code reader system S, so by using the controller 100, the method for estimating the reading stability of the code reader system can be executed.

To identify a specific surface of the workpiece W, for example, if the shape of the workpiece W is a rectangular parallelepiped, the coordinates of the vertices of the rectangular parallelepiped in the conveyor coordinate system can be converted to the imaging coordinate system using coordinate transformation coefficients. This allows for the identification of which part in the image corresponds to the particular surface.

Information related to code reading includes at least one of the reading margin when code decoding is successful, the number of matches of decoding results based on multiple images containing the same code, the contrast of the code, and the PPC indicating the number of pixels constituting each module of the code. The reading margin can be calculated, for example, using the method described in JP 2014-157519 A. The number of matches of decoding results refers to how many times the decoding of a particular code has been successful when focusing on that code. Therefore, the higher the number of matches of decoding results, the more chances there are to decode the code, making it usable as evaluation data for calculating reading stability.

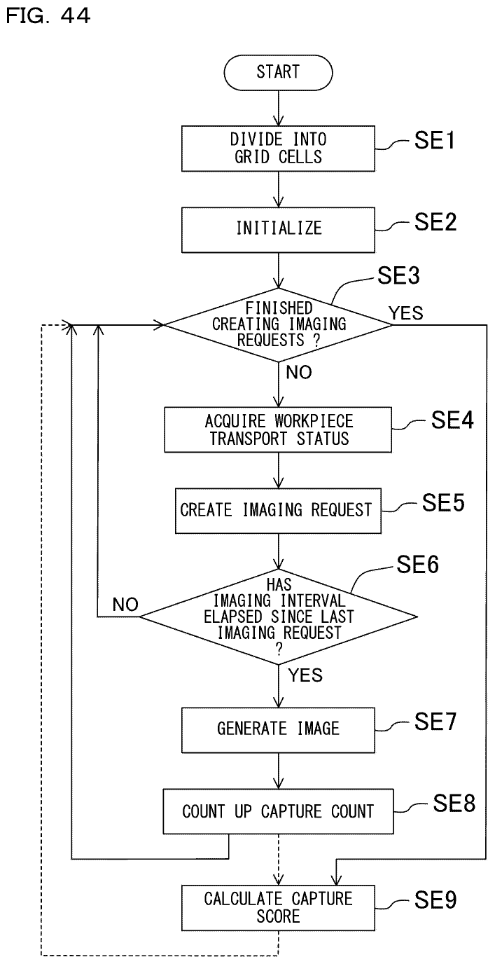

The details of the measurement of capture information by the controller 100 will be explained based on the flowchart shown in FIG. 44. This flowchart starts after a predetermined start operation is performed by the user. Before the start, the controller 100 acquires installation information indicating the position and orientation of the imaging unit 3 of the code reader 1 in the conveyor coordinate system, the ID of the workpiece W, and size information of the workpiece W (height dimension, width dimension, depth dimension, etc.). This information can be input by the user.

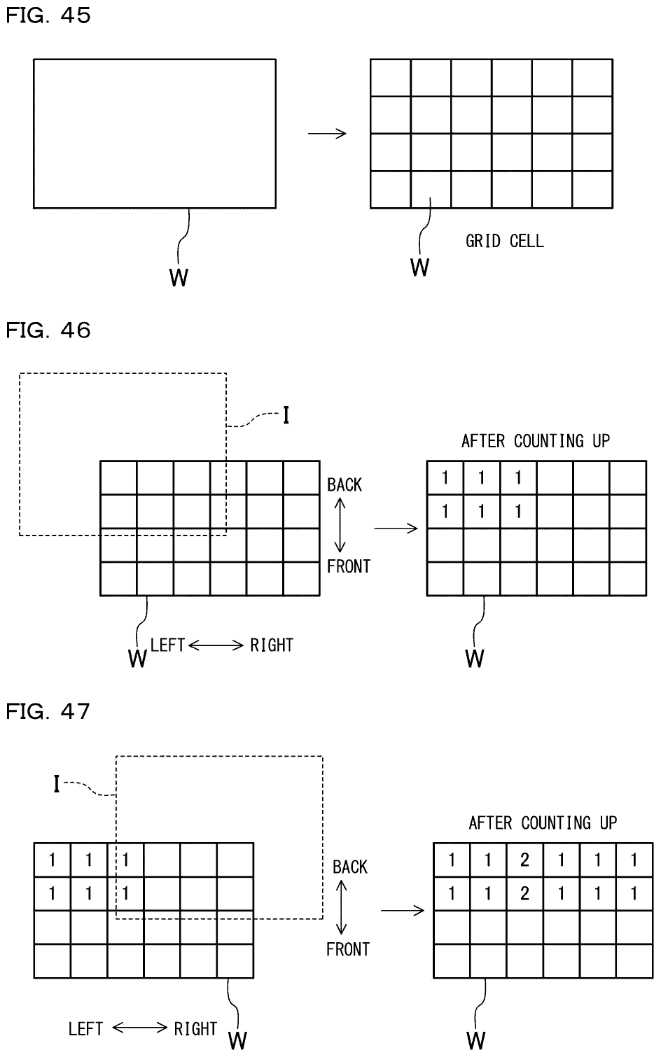

In step SE1 after the start, the controller 100 divides one surface of the workpiece W on which the code is attached, among multiple surfaces of the workpiece W, into multiple grid cells. FIG. 45 shows a case where the controller 100 has divided the top surface of the workpiece W into 24 grid cells, but the number of grid cells is not particularly limited. The shape of the grid cells may be rectangular or square.

The number of grid cells may be determined by the initial settings of the code reader system S, or may be specified by the user. The more grid cells there are, the more complex the processing becomes, but the estimation accuracy of the reading stability improves. Based on the area of the top surface of the workpiece W and the number of grid cells, the area of one grid cell can be calculated, so the approximate area of the imaged portion of the workpiece W can be determined based on the number of imaged cells.

In step SE2, if the number of captures is recorded in the capture count map to be described later, the controller 100 initializes that capture count. Then, proceeding to step SE3, the controller 100 determines whether the creation of a series of imaging requests for the workpiece W has been completed. If an imaging request to be sent to the code reader 1 has not been created, the process proceeds to step SE4, where the controller 100 acquires the current transport status of the workpiece W. The current transport status of the workpiece W refers to, for example, the X-direction position and Y-direction position of the workpiece W being transported by the conveyor B, as well as the height dimension, width dimension, and depth dimension of the workpiece W. The dimensions of the workpiece W can be obtained by the dimension measurement unit 90. In systems without a dimension measurement unit 90, only the depth dimension of the workpiece W can be determined based on the detection signal from the work sensor 92 and the conveying speed of the conveyor B.

In step SE5, the controller 100 creates an imaging request. The imaging request includes the imaging area by the imaging unit 3 and the number of captures per unit time (1 second) (frame rate: FPS). The imaging area by the imaging unit 3 can be determined by the offset amount to offset in the Y direction (corresponding to the V direction in the UV coordinate system) and the size in the V direction, and in this determination, for example, the installation information of the code reader 1 and the position and dimension information of the workpiece W can be used. The imaging FPS can also be determined using, for example, the installation information of the code reader 1 and the position and dimension information of the workpiece W.

In step SE6, the controller 100 determines whether the imaging interval has elapsed since the previous imaging request. The imaging interval is the reciprocal of the imaging FPS, for example, if it is 100 FPS, it becomes 1/100, and the imaging interval is 0.01 seconds (10 ms). If the imaging interval has not elapsed since the previous imaging request, the process proceeds to step SE3. On the other hand, if the imaging interval has elapsed since the previous imaging request, the process proceeds to step SE7.

In step SE7, an image is generated by causing the imaging unit 3 of the code reader 1 to capture an image. Step SE7 is a step of capturing at least one image of the workpiece W using the imaging unit 3. The imaging unit 3 can generate images captured at different timings, and as shown in FIG. 3, when equipped with multiple imaging units 3, it can generate images captured from different angles.

In step SE8, the number of grid cells included in the image area generated by the imaging unit 3 is counted up in the capture count map. Specifically, FIG. 46 schematically shows the top surface of the workpiece W divided into grid cells and the imaging area I (area enclosed by dashed lines) generated by the imaging unit 3, defining the left-right direction and depth direction. In the example of FIG. 46, the grid cells included in the imaging area I are about ¼ of the top surface of the workpiece W, located in the back left. In this case, only the grid cells included in the imaging area I are counted up, becoming “1” as shown after counting up. After step SE8, if the creation of the imaging request has not been completed in step SE3, steps SE4 to SE7 are executed again, followed by step SE8. It should be noted that instead of targeting the top surface of the workpiece W, any single surface such as the front surface, rear surface, side surface, or bottom surface can be targeted.

FIG. 47 shows a case where step SE8 is executed again, and similar to FIG. 46, it schematically shows the top surface of the workpiece W divided into grid cells and the imaging area I generated by the imaging unit 3. Due to the previous count up, the value of the ¼ grid cell located in the back left of the workpiece W's top surface has become “1”. In this current step SE8, the grid cells included in the imaging area I are cells located near the center rear to the right side of the workpiece W's top surface. As in the previous case, only the grid cells included in the imaging area I are counted up, and as shown after counting up, the value of grid cells included in the imaging area I in both the previous and current instances becomes “2”, while the value of grid cells included only in either the previous or current imaging area I becomes “1”. In this way, a map of capture counts is created. The number of times step SE8 is performed may be three or more. Thus, the controller 100 can divide one surface of the workpiece W into multiple grid cells and measure the number of times each grid cell has been captured by the imaging unit 3.

If it is determined in step SE3 that the creation of the imaging request has been completed, the process proceeds to step SE9. In step SE9, the controller 100 calculates a capture score based on the map of capture counts and the capture rate created as described above. The capture score can be calculated by multiplying the capture rate by the capture count. This is an example of information indicating the stability of reading using the imaging unit 3, and step SE9 is a step of measuring capture information including at least one of the area of the imaged region within at least one surface of the multiple surfaces of the workpiece W and the number of times at least one surface has been imaged.

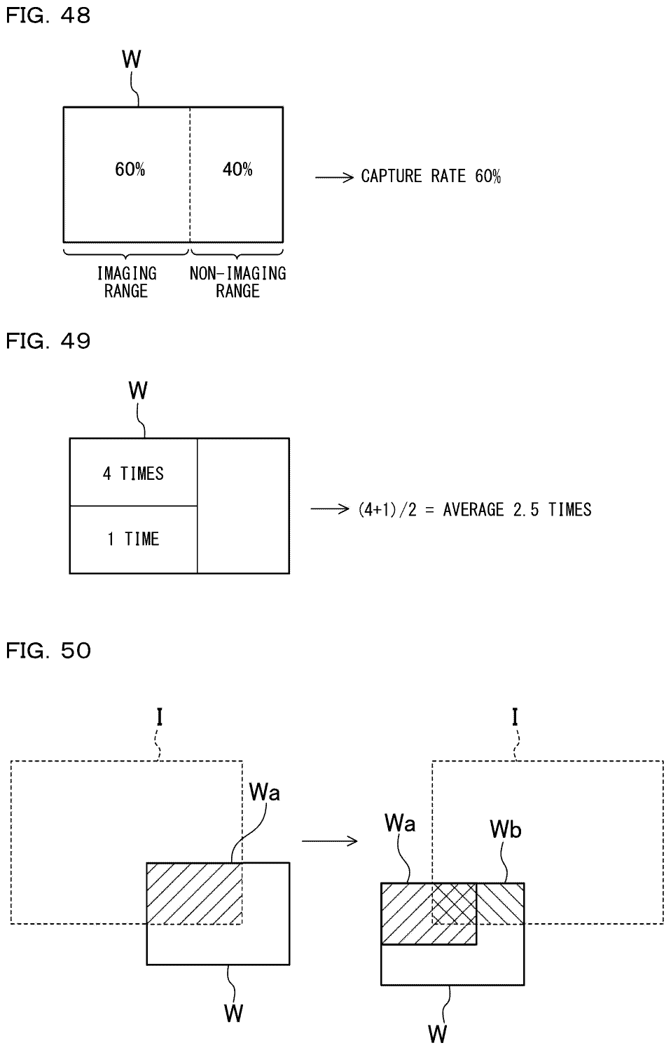

Here, the capture rate quantifies the ease of capturing the code attached to the reading surface of the workpiece W, and is indicated from 0 to 100%. For example, as shown in FIG. 48, if 60% of the left side of the top surface of the workpiece W can be captured by the imaging unit 3, the capture rate becomes 60%. In other words, the capture rate refers to the proportion of the area that can be imaged out of the reading surface.

For example, in the case shown in FIG. 46, the grid cells included in the imaging area I are approximately ¼ of the workpiece W's top surface, located in the back left. In this case, the area can be measured based on the number of grid cells captured by the imaging unit 3, and the capture rate becomes 25%. The controller 100 calculates the PPC (pixel per cell) indicating the number of pixels constituting each module of the code for each grid cell, and measures the capture rate excluding grid cells where the PPC is less than a predetermined value. Specifically, grid cells with calculated PPC less than the predetermined value are not used for measuring the capture rate. Even if a code is in the field of view, codes positioned far away, for example, are likely to have a PPC too small to be decoded, so by not using them for capture information measurement, the reliability of reading stability is improved.

The method for calculating the capture count may be the method of calculation using the grid cell division described above, or it may be the method shown in FIG. 49. FIG. 49 is a diagram explaining an example of a method for calculating the capture count, which calculates the average number of captures in the area determined to be within the imaging range in FIG. 48. In this case, as with the calculation of the capture rate, PPC is calculated for each grid cell, and grid cells with PPC below a predetermined value are not counted up. Incidentally, instead of the average value, the cumulative value (5 times in the case shown in FIG. 49) may be used as the capture count.

The controller 100 may display the map of capture counts and/or capture scores on a display device such as the display unit 301. This allows the user to quantitatively grasp the reading stability.

As factors that cause the capture rate shown in FIG. 48 to decrease, for example, cases where there is no dimension measurement unit 90, cases where the distance between workpieces W aligned in the conveying direction is short, and cases where the size of the workpiece W is large can be listed. When there is no dimension measurement unit 90, it becomes difficult to set the imaging area to match the workpiece W, causing the capture rate to decrease. Also, when the distance between workpieces W is short, the area where workpieces W can be imaged overlapping within the field of view becomes narrow, causing the capture rate to decrease. Furthermore, when the size of the workpiece W is large, the workpiece W may go outside the imaging area, causing the capture rate to decrease.

Factors that can cause a decrease in the capture count shown in FIG. 49 include, for example, cases where there is no dimension measurement unit 90, or when the conveying speed by the conveyor B is fast. The capture rate and capture count can sometimes have a trade-off relationship. For instance, if the imaging area is expanded to increase the capture rate, the code readout time becomes longer, causing the imaging FPS to decrease, which results in a lower capture count. Additionally, if one tries to increase the capture count by raising the imaging FPS, it becomes necessary to reduce the imaging area, leading to a decrease in the capture rate. Furthermore, in cases where there is no dimension measurement unit 90, due to the inability to accurately determine the size of the workpiece W, the imaging area is expanded to prevent a decrease in the capture rate, which lowers the imaging FPS. As a result, the number of captures decreases, consequently lowering the capture count.

After the imaging unit 3 has completed all imaging of the workpiece W, the controller 100 outputs capture scores, which are information indicating the stability of reading. This allows evaluation of the appropriateness of the current number of code readers 1 and installation positions of code readers 1 based on multiple captured images. As a separate example, as shown by the dashed line in FIG. 44, the controller 100 may output information indicating the stability of reading each time the workpiece W is captured by the imaging unit 3. In other words, this can be used for switching targets during imaging control, and when multiple workpieces W exist in the same field of view, workpieces W with sufficiently high reading stability can be skipped, and workpieces W with low reading stability can be prioritized for imaging, thus realizing optimal resource allocation. This step is a step of outputting information indicating the stability of reading.

In FIG. 50, the portion of the workpiece W included in the imaging area I on the top surface is indicated by the symbol Wa. In this case, the capture rate can be calculated by dividing the area of the portion marked with the symbol Wa by the area of the top surface of the workpiece W. As shown on the right side of FIG. 50, when a second imaging is performed, the portion Wa included in the imaging area I during the first imaging and the portion Wb included in the imaging area I during the second imaging may be different. In this case, the capture rate can be calculated by dividing the combined area of the portion marked with the symbol Wa and the portion marked with the symbol Wb by the area of the top surface of the workpiece W. The capture rate may be calculated by giving more weight to the overlapping portion of the area marked with the symbol Wa and the area marked with the symbol Wb compared to the non-overlapping portions marked with either symbol Wa or symbol Wb.

The area of the top surface of the workpiece W can be calculated, for example, based on the dimensions of the workpiece W obtained by the dimension measurement unit 90. If there is no dimension measurement unit 90, the length in the conveying direction can be calculated from the detection signal of the work sensor 92, and this length may be used as a provisional height of the workpiece W, or the width dimension may use the width of the conveyor B as a provisional dimension.

The areas of the portions marked with symbol Wa and symbol Wb can be obtained by converting the UV coordinates of the workpiece W portion (for example, vertices) in the image (field of view) to world coordinates and calculating. In the case of grid cell division, the areas of the portions marked with symbol Wa and symbol Wb can be calculated by counting the number of grid cells included in the imaging area and multiplying the unit grid area by the number of grid cells. In this way, the controller 100 can identify the surface of the workpiece W included in each image captured by the imaging unit 3 and measure the area of the identified surface.

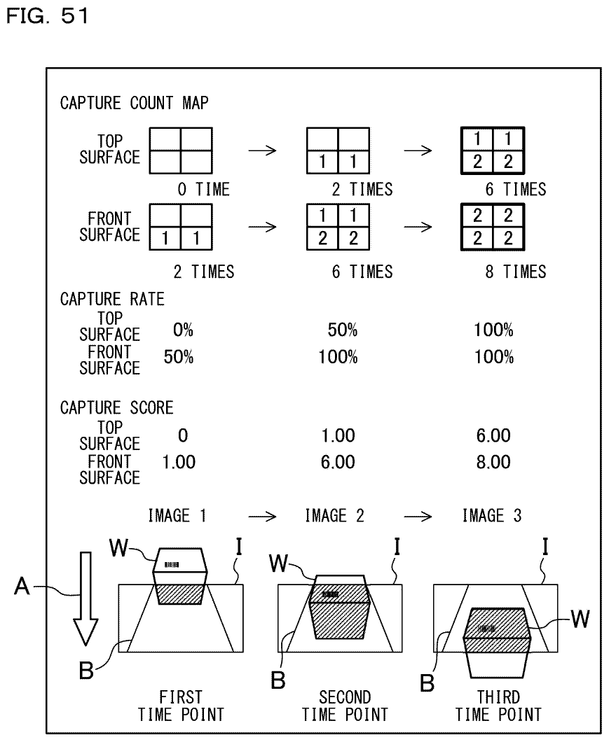

FIG. 51 is a diagram explaining the case where the workpiece W is imaged from downstream to upstream by the code reader 1A (shown in FIG. 2) installed on the downstream side of the conveying direction of the workpiece W. Arrow A indicates the conveying direction of the workpiece W. From left to right in FIG. 51 is the chronological order, with time progressing in the order of the first time point, the second time point, and the third time point.

At the first time point, since the top surface of the workpiece W is positioned outside the imaging area I, all values in the capture count map for the top surface become “0”. Only the lower part of the front surface of the workpiece W is included in the imaging area I, so only the values in the capture count map for the lower part of the front surface all become “1”. The capture rate at the first time point becomes 0% for the top surface of the workpiece W and 50% for the front surface of the workpiece W. The calculated capture score becomes 0 for the top surface of the workpiece W and 1.00 for the front surface of the workpiece W.

At the second time point, only the front part of the top surface of the workpiece W is included in the imaging area I, so the value of the capture count map for the front part of the top surface of the workpiece W becomes “1”. The entire front surface of the workpiece Wis included in the imaging area I, so “1” is added to all values of the capture count map for the front surface. The capture rate at the second time point becomes 50% for the top surface of the workpiece W and 100% for the front surface of the workpiece W. The calculated capture score becomes 1.00 for the top surface of the workpiece W and 6.00 for the front surface of the workpiece W.

At the third point in time, since the entire top surface of the workpiece W is included in the imaging area I, “1” is added to all values of the capture count map for the top surface of the workpiece W. Only the upper part of the front surface of the workpiece W is included in the imaging area I, so “1” is added to the value of the capture count map for the upper part of the front surface. The capture rate at the third point in time becomes 100% for the top surface of the workpiece W and 100% for the front surface of the workpiece W. The calculated capture score becomes 6.00 for the top surface of the workpiece W and 8.00 for the front surface of the workpiece W.

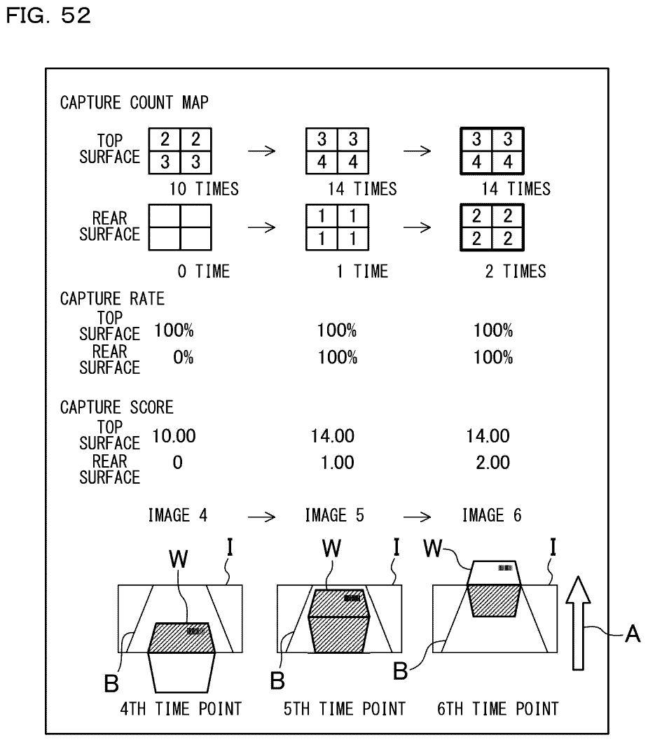

FIG. 52 is a diagram explaining the case where the workpiece W is imaged from upstream to downstream by the code reader 1B (shown in FIG. 2) installed on the upstream side of the workpiece W in the conveying direction. Arrow A indicates the conveying direction of the workpiece W. From left to right in FIG. 52 is the chronological order, and after the first to third time points shown in FIG. 51, time progresses in the order of the fourth time point, the fifth time point, and the sixth time point. For convenience in this explanation, time is shown to progress in the order of the first to third time points, followed by the fourth, fifth, and sixth time points, but when calculating and outputting in real-time, time may progress in the order of the first time point, fourth time point, second time point, fifth time point, third time point, and sixth time point. The imaging sequence is not limited to these.

At the fourth time point, since the rear surface of the workpiece W is positioned outside the imaging area I, all values in the capture count map for the rear surface become “0”. The entire top surface of the workpiece W is included in the imaging area I, so the values in the capture count map for the top surface are incremented. The capture rate at the fourth time point becomes 100% for the top surface of the workpiece W and 0% for the rear surface of the workpiece W. The calculated capture score becomes 10.00 for the top surface of the workpiece W and 0 for the rear surface of the workpiece W.

At the fifth time point, since the rear surface and top surface of the workpiece W are included in the imaging area I, the values of the capture count map for the rear surface and top surface of the workpiece W are added. The capture rate at the fifth time point becomes 100% for the top surface of the workpiece W and 100% for the rear surface of the workpiece W. The calculated capture score becomes 14.00 for the top surface of the workpiece W and 1.00 for the rear surface of the workpiece W.

At the sixth time point, since the entire rear surface of the workpiece W is included in the imaging area I, the value of the capture count map for the rear surface of the workpiece W is added. The capture rate at the sixth time point becomes 100% for the top surface of the workpiece W and 100% for the rear surface of the workpiece W. The calculated capture score becomes 14.00 for the top surface of the workpiece W and 2.00 for the rear surface of the workpiece W.

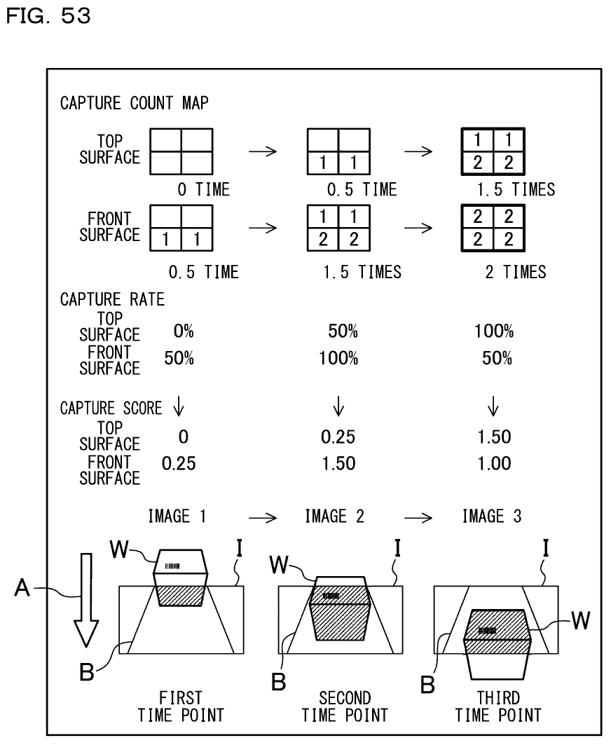

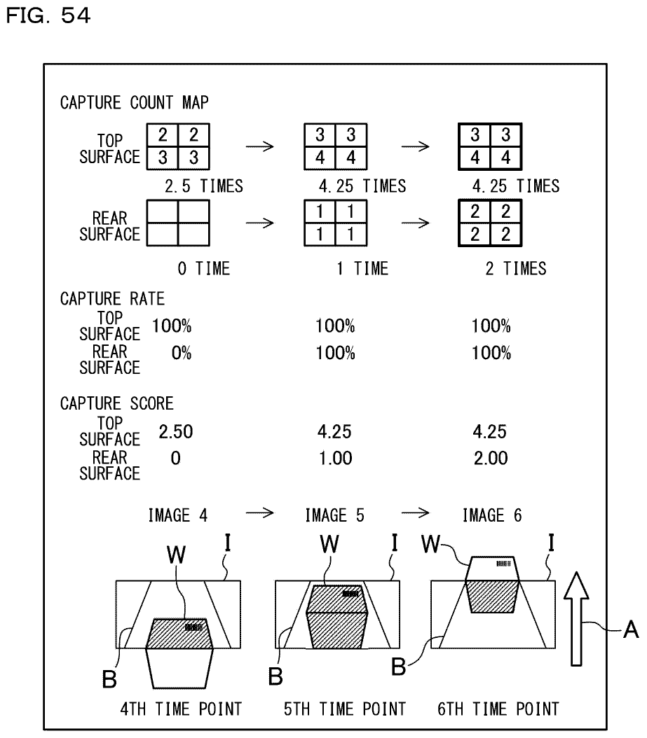

In FIGS. 51 and 52, the capture count is shown as a cumulative count, but as shown in FIGS. 53 and 54, the capture count can also be represented as an average value. In the example shown in FIG. 53, at the first time point, the average capture count for the top surface of workpiece W is 0 times, and the average capture count for the front surface is 0.5 times. Also, the capture rate for the top surface of workpiece W is 0% and 50% for the front surface, while the capture score is 0 for the top surface of workpiece W and 0.25 for the front surface. At the second time point, the average capture count for the top surface of workpiece W becomes 0.5 times, and the average capture count for the front surface becomes 1.5 times. Also, the capture rate for the top surface of workpiece W becomes 50% and 100% for the front surface, while the capture score becomes 0.25 for the top surface of workpiece W and 1.50 for the front surface. At the third time point, the average capture count for the top surface of workpiece W becomes 1.5 times, and the average capture count for the front surface becomes 2 times. Also, the capture rate for the top surface of workpiece W becomes 100% and 50% for the front surface, while the capture score becomes 1.50 for the top surface of workpiece W and 1.00 for the front surface.

In the example shown in FIG. 54, at the fourth time point, the average capture count for the top surface of the workpiece W becomes 2.5 times, and the average capture count for the rear surface becomes 0 times. Also, the capture rate for the top surface of the workpiece W becomes 100%, and for the rear surface, it becomes 0%. The capture score for the top surface of the workpiece W becomes 2.50, and for the rear surface, it becomes 0. At the fifth time point, the average capture count for the top surface of the workpiece W becomes 4.25 times, and the average capture count for the rear surface becomes 1 time. Also, the capture rate for both the top surface and rear surface of the workpiece W becomes 100%. The capture score for the top surface of the workpiece W becomes 4.25, and for the rear surface, it becomes 1.00. At the sixth time point, the average capture count for the top surface of the workpiece W becomes 4.25 times, and the average capture count for the rear surface becomes 2 times. Also, the capture rate for both the top surface and rear surface of the workpiece W becomes 100%. The capture score for the top surface of the workpiece W becomes 4.25, and for the rear surface, it becomes 2.00.

### (Simulation Function)

Information indicating the reading stability using the imaging unit 3 can be output based on an image actually captured by the imaging unit 3, as mentioned above. However, it can also be output based on a virtual image acquired by a virtual camera, without relying on an image actually captured by the imaging unit 3. This function is called a simulation function, and the code reader system S of the present embodiment can also be equipped with this simulation function.

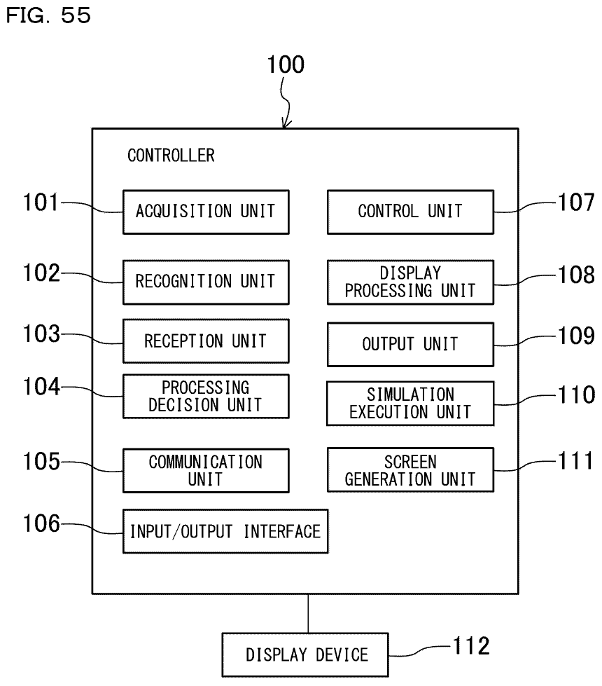

FIG. 55 is a block diagram of a controller 100 with a simulation function, and this controller 100 includes a simulation execution unit 110 that executes a simulation of the code reader system S. The reception unit 103 of the controller 100 is an example of an input acceptance unit that accepts from the user, as input information used for the simulation of the code reader system S, installation conditions (installation information of the code reader 1) of one or more imaging units 3, and transport conditions (such as conveying speed) of the workpiece W.

The simulation execution unit 110 transports a virtual workpiece having multiple surfaces in a virtual space based on the transport conditions of the workpiece W accepted by the reception unit 103. For example, the virtual workpiece can be transported by a virtual conveyor corresponding to the conveyor B installed in an actual logistics site. Based on design drawings and other information of the conveyor B, transport conditions such as width, length, orientation, and conveying speed are virtually set. By moving the virtual conveyor in the virtual space based on the set transport conditions, the virtual workpiece can be virtually transported. One or multiple virtual workpieces are supplied to the virtual conveyor when a predetermined time arrives. This time can be set arbitrarily.

The simulation execution unit 110 acquires the existence area of the virtual workpiece in the virtual image when the virtual workpiece is captured by one or more virtual cameras virtually provided based on the installation conditions of the imaging unit 3 accepted by the reception unit 103. In other words, the installation height and angle of the virtual camera are determined in the virtual space based on the installation conditions. By capturing the virtual workpiece with the virtual camera from the position determined in the virtual space, the existence area of the virtual workpiece in the virtual space can be acquired. The size and conveying speed of the virtual workpiece in the virtual space can be set arbitrarily.

The simulation execution unit 110 measures capture information including at least one of the area of the imaged region within at least one surface of multiple surfaces of a virtual workpiece and the number of times the at least one surface was imaged, based on multiple virtual images captured by one or more virtual cameras. Based on the measured capture information, it outputs information indicating the reading stability for at least one surface of the virtual workpiece using one or more virtual cameras. The method for measuring capture information and the method for outputting information indicating reading stability can use the techniques explained in the above-mentioned reading stability presentation function.

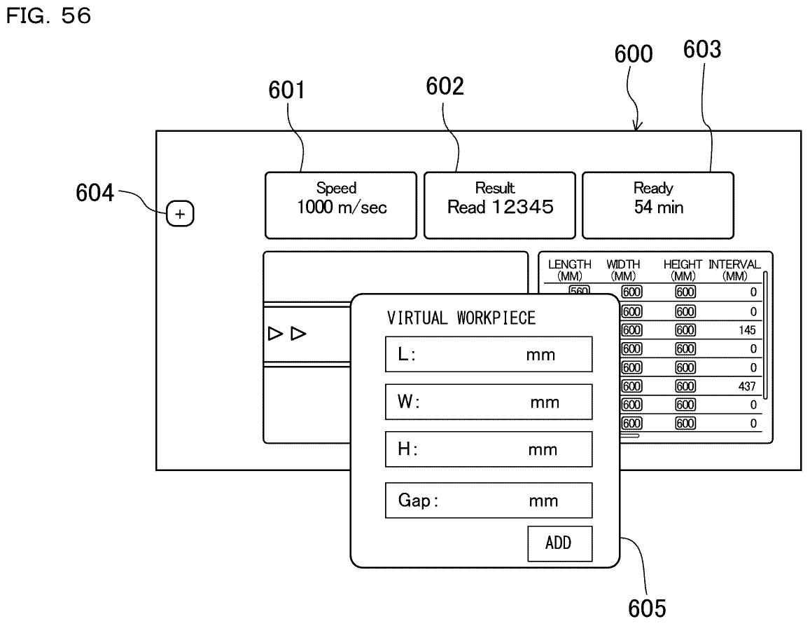

FIG. 56 shows a display screen 600 of the simulation function. The display screen 600 is generated by the screen generation unit 111 included in the controller 100 and displayed on the display device 112 included in the controller 100. The display screen 600 includes a setting area 601 for the conveying speed by the virtual conveyor, a reading result display area 602, a time display area 603, and so on. When the setting button 604 is operated, the screen generation unit 111 generates a setting window 605 for setting the dimensions and other parameters of the virtual workpiece, and displays it on the display device 112.

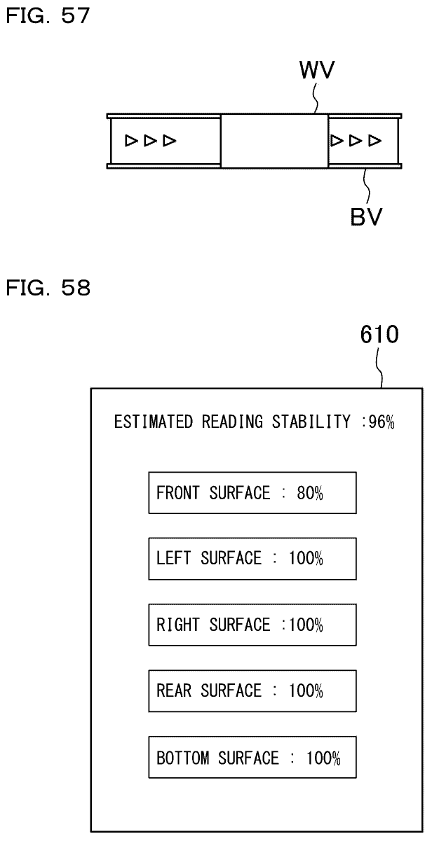

When the user performs an operation to start the simulation, the simulation execution unit 110 executes the aforementioned simulation. At this time, as shown in FIG. 57, the display screen 600 displays a virtual conveyor BV and virtual workpieces WV transported by the virtual conveyor BV. This display image is generated by the screen generation unit 111.

When the simulation by the simulation execution unit 110 is completed, as shown in FIG. 58, the screen generation unit 111 generates and displays on the display device 112 an estimated reading stability display screen 610 that shows the estimated reading stability for each surface (front, left, right, rear, bottom) of the virtual workpiece and the estimated reading stability for the entire virtual workpiece based on the estimated reading stability of each surface. In this way, it is possible to display the estimated reading stability for each surface of the virtual workpiece individually. The display format of the estimated reading stability for each surface of the virtual workpiece is not limited to the format shown in FIG. 58. For example, it can be visually displayed in a heat map format for each surface of the workpiece W. For instance, a format can be adopted where the surfaces of the workpiece W are colored and displayed by changing the color or brightness according to the high or low stability. In cases where one surface of the workpiece W is divided into multiple grid cells, a heat map format colored for each grid cell based on the information for each grid cell can be adopted. It should be noted that while the display of the estimated reading stability for each surface has been explained as part of the simulation function, the reading stability output based on images actually captured by the imaging unit 3 may also be used.

The controller 100 outputs a reading error when the reading stability is less than a predetermined value. Specifically, after calculating the reading stability, the controller 100 determines whether the calculated reading stability is less than a predetermined value, and if it is determined to be less than the predetermined value, outputs a reading error to, for example, the display device 112 for display. The display format of the reading error displayed on the display device 112 may be, for example, an icon, symbol, character, etc., or it may be a sentence explaining that an error has occurred.

The controller 100 may be equipped with an improvement proposal function that proposes improvements to the reading stability after obtaining the reading stability, if the obtained reading stability is below a predetermined value. In the improvement proposal function, when the obtained reading stability is below a predetermined value, the controller 100 proposes adding a dimension measurement unit 90 or adding a code reader 1. If a dimension measurement unit 90 is already installed, the controller 100 proposes adding a code reader 1. When proposing the addition of a code reader 1, the optimal installation location and the optimal number of additional units can also be estimated through the aforementioned simulation.

On the other hand, when multiple code readers 1 are installed, if the obtained reading stability is equal to or greater than a predetermined value, the controller 100 may propose reducing the number of code readers 1. By re-executing the above simulation with a reduced number of code readers 1, if the obtained reading stability can be secured at or above a predetermined value, proposing to the user to reduce one or more code readers 1 can lower the introduction cost of the code reader system S. For example, in the estimated reading stability display screen 610 shown in FIG. 58, for surfaces where the estimated reading stability is 100%, it may be possible to secure sufficient stability even if the number of corresponding code readers 1 is reduced. Therefore, for such surfaces, the above simulation may be re-executed with a reduced number of corresponding code readers 1.

When a dimension measurement unit 90 is installed, if the obtained reading stability is equal to or greater than a predetermined value, the controller 100 may propose omitting the dimension measurement unit 90. By re-executing the above simulation with the dimension measurement unit 90 omitted, if the obtained reading stability can be secured at or above a predetermined value, proposing to the user to omit the dimension measurement unit 90 can reduce the introduction cost of the code reader system S.

In addition, in the above simulation, it is possible to obtain the reading stability for both cases: when operating the dimension measurement unit 90 in combination with the code reader 1, and when operating the code reader 1 alone. Furthermore, in the above simulation, it is possible to obtain the reading stability for both cases: when operating a single code reader 1 and when operating multiple code readers 1. For example, by showing the reading stability when installing 6 code readers 1, the reading stability when installing 5 code readers, and the reading stability when installing 4 code readers, and enabling comparison of reading stabilities, it is possible to propose a minimum necessary installation while balancing reading stability and the number of units. The same applies to the dimension measurement unit 90, and by presenting to the user how the reading stability changes with or without the dimension measurement unit 90, a minimum necessary installation can be proposed.

Furthermore, it is possible to propose to the user how the reading stability changes when the transport pattern of the workpiece W is altered, by conducting the aforementioned simulation. As for transport patterns, examples can be given such as “a high ratio of small packages and few large packages,” “large packages flowing continuously,” or “80% larger than a predetermined size and 20% others.” In the initial settings of the code reader system S, these options may be prepared for the user to select, or the user may be allowed to input an arbitrary transport pattern, or transport patterns based on statistical data from the user's actual operations may be prepared. In any case, by conducting the aforementioned simulation, the reading stability for each transport pattern can be proposed to the user. The simulation can also be performed by combining the transport pattern of the workpiece W with the number of installed code readers 1.

Furthermore, it is possible to output processing results in conjunction with the user's actual transport pattern. For example, a simulation can be executed to output a reading error when a predetermined reading stability is not met. This allows for the anticipation of cases where reading stability decreases without actually transporting the workpiece W. Examples of cases where reading stability decreases include: a case where the supply speed of the workpiece W is too fast, causing the processing in controller 100 to fall behind, resulting in a decrease in capture rate and capture count; a case where the gaps between workpieces W are narrow and the workpiece W size is large, causing the front surface of the rear workpiece W to be hidden in the shadow of the forward workpiece W and unable to be captured, resulting in a decreased capture rate; and a case where the gaps between workpieces W are narrow and the workpiece W size is small, causing the supply speed of the workpiece W to be too fast for the processing in controller 100 to keep up, resulting in a decrease in capture rate and capture count. Based on the results of the above simulation, the controller 100 can also present to the user the reasons why the reading stability becomes low.

### (Simulation Device)

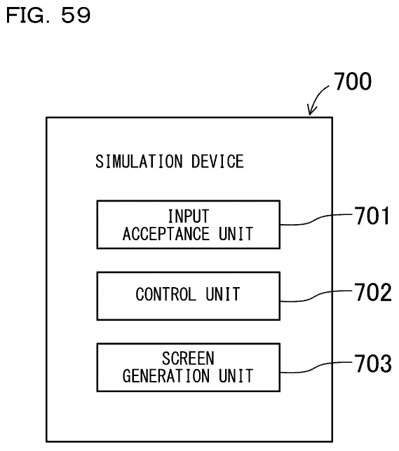

In the above embodiment, an example where the simulation function was installed in the code reader system S was explained, but this is not limited to that. The simulation executed by the controller 100 of the code reader system S can also be executed by the simulation device 700 shown in FIG. 59.

The simulation device 700 is a simulation device that performs a simulation of a code reader system S that reads codes attached to workpieces W conveyed on a conveyor B using one or multiple imaging units. The simulation device 700 includes an input acceptance unit 701 that accepts input information from the user for use in the simulation of the code reader system S, including installation conditions for one or multiple imaging units and conveying conditions for the workpieces W, and a control unit 702 that executes the simulation of the code reader system S based on the input information accepted by the input acceptance unit 701. The input information used for the simulation of the code reader system S includes installation conditions for one or multiple imaging units 3 (installation information for the code reader 1) and conveying conditions for the workpieces W (such as conveying speed). The installation conditions for the imaging units 3 and the conveying conditions for the workpieces W are accepted by the input acceptance unit 701 when input in the same manner as they would be input into the code reader system S.

The control unit 702 executes a simulation similar to the simulation executed by the controller 100 of the code reader system S. Specifically, the control unit 702 transports a virtual workpiece with multiple surfaces based on transport conditions, acquires the existence area of the virtual workpiece in a virtual image when captured by one or more virtual cameras virtually installed based on installation conditions, measures capture information including at least either the area of the captured region within at least one surface of the multiple surfaces of the virtual workpiece and the number of times the at least one surface was captured, based on multiple virtual images, and outputs information indicating the reading stability for at least one surface of the virtual workpiece using one or more virtual cameras, based on the capture information. The simulation device 700 may be configured to be connectable to the code reader 1 and the dimension measurement unit 90. This enables the simulation device 700 to be operated as a code reader system. Additionally, the simulation device 700 may further include a screen generation unit 703. This allows the simulation device 700 to generate, as shown in FIG. 58, a display screen 610 of estimated reading stability displaying the estimated reading stability for each surface (front, left, right, rear, bottom) of the virtual workpiece and the estimated reading stability for the entire virtual workpiece based on the estimated reading stability of each surface, which can be displayed on a display device by the screen generation unit 703.

The above-described embodiment is merely exemplary in all respects and should not be construed in a limiting way. Furthermore, all modifications and changes within the equivalent scope of the claims are within the scope of this invention. In this embodiment, the code reader 1 and the controller 100 are described as physically separate, but part of the controller 100 may be incorporated into the code reader 1. For example, by incorporating the acquisition unit 101, control unit 107, and display processing unit 108 of the controller 100 into the code reader 1, it is possible to create a code reader 1 that has the acquisition unit 101, control unit 107, and display processing unit 108. Additionally, the part that executes the simulation may be placed outside the housing of the controller 100.

Before operating the code reader system S, various settings can be made, for example, by executing the aforementioned simulation or by having the user make adjustments without executing the simulation. The code reader system S related to this embodiment is configured to be able to present information indicating the stability of reading to the user when test-transporting actual workpieces W on the conveyor B after setting, or to present information indicating the stability of reading to the user after the code reader system S has been fully put into operation.

The following is a detailed explanation. The output unit 109 acquires the installation information of the work sensor 92 and the dimension measurement unit 90, the installation information of the imaging unit 3, the conveying speed of the conveyor B, and the dimensions of the workpiece W. The work sensor 92 and the dimension measurement unit 90 are examples of sensors that detect the workpiece W being transported by the conveyor B and measure the dimensions of said workpiece W. It is possible to measure the dimensions of the workpiece W based on the detection signal of the workpiece W by the work sensor 92 and the conveying speed by the conveyor B, so a sensor that detects the workpiece W and measures the dimensions of said workpiece W can be configured with only the work sensor 92, without providing the dimension measurement unit 90. Also, it is possible to configure a sensor that detects the workpiece W and measures the dimensions of said workpiece W with only the dimension measurement unit 90, without providing the work sensor 92. Furthermore, the work sensor 92 and the dimension measurement unit 90 may be integrated, in which case it becomes a configuration equipped with multiple sensors that detect the workpiece W and measure the dimensions of said workpiece W. Thus, the sensor that detects the workpiece W and measures the dimensions of said workpiece W can be configured with a single sensor or multiple sensors, and its configuration is not particularly limited. The installation information of the work sensor 92 and the dimension measurement unit 90 includes the X coordinate, Y coordinate, Z coordinate, installation angle, etc. of the work sensor 92 and the dimension measurement unit 90, which are measured by the user and then input by operating the setting device 300 or the like. The output unit 109 can acquire the input installation information of the work sensor 92 and the dimension measurement unit 90.

The installation information of one or multiple cameras corresponds to the installation information of the code reader 1, and the output unit 109 can obtain the installation information of one or multiple cameras by acquiring the installation information of the code reader 1. Regarding the conveying speed of the conveyor B, for example, the output unit 109 can acquire the conveying speed that has been input in advance to external devices. As for the dimensions of the workpiece W, the output unit 109 can acquire them from the measurement results of the work sensor 92 or the dimension measurement unit 90.

The output unit 109 outputs information indicating the stability of code reading using the imaging unit 3 for each surface of the workpiece W, based on the installation information of the work sensor 92 and the dimension measurement unit 90 obtained as described above, the installation information of the imaging unit 3, the conveying speed of the conveyor B, and the dimensions of the workpiece W.

More specifically, the output unit 109 can output information indicating the stability of reading based on at least one of capture information including at least one of the area of the region captured by one or more imaging units 3 for each surface of the workpiece W and the number of times captured, and information related to reading a code attached to at least one surface. The output unit 109 calculates the area of the captured region and the number of times captured based on the images actually captured by one or more imaging units 3. Additionally, the output unit 109 can calculate the area of the captured region and the number of times captured based on the installation information of the work sensor 92 or the dimension measurement unit 90, the installation information of one or more imaging units 3, the conveying speed of the conveyor B, and the dimensions of the workpiece W.

Information related to the workpiece W includes, for example, size, gap between loads, and inclination with respect to the conveying direction. Since the reading stability varies depending on the size of the workpiece W, the gap between loads, and the inclination with respect to the conveying direction, the output unit 109 generates and outputs information indicating the reading stability considering these factors. Information related to the workpiece W can be acquired from the work sensor 92 or the dimension measurement unit 90 after the code reader system S starts operation, or it can be acquired based on information input by the user before the code reader system S starts operation.

The screen generation unit 111 acquires the result of the decoding process by the decoding unit 44 (the result of the decoding process of the code attached to the workpiece W) and the information indicating the reading stability for each surface of the workpiece W output from the output unit 109. Then, the screen generation unit 111 generates a screen to display on the display device 112, showing the result of the decoding process of the code attached to the workpiece W and the information indicating the reading stability for each surface of the workpiece W.

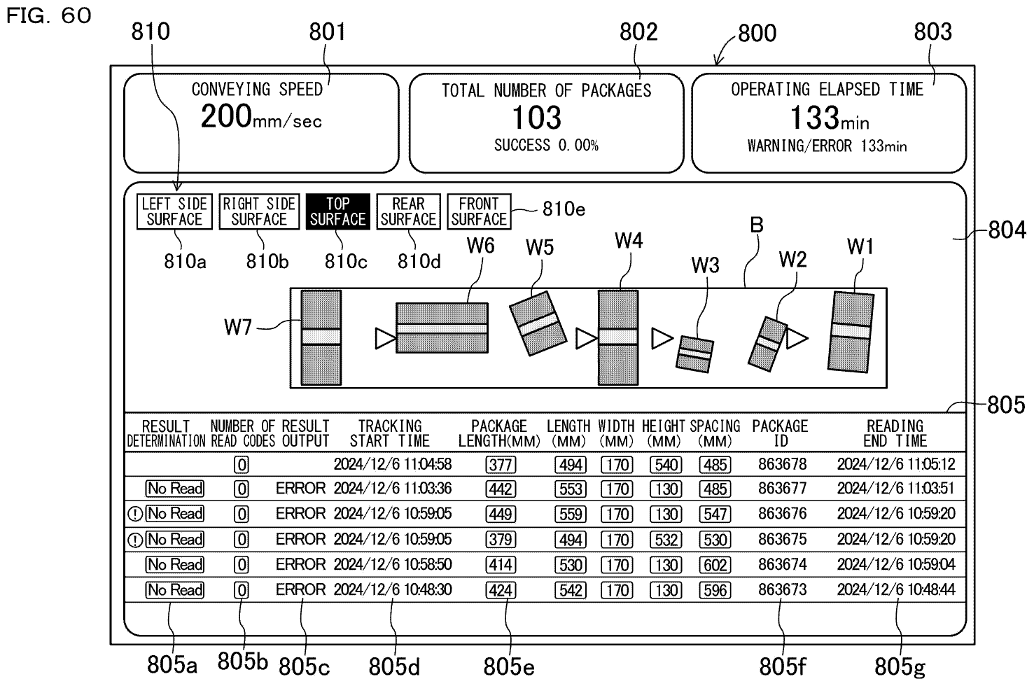

FIG. 60 shows a transport display screen 800 generated by the screen generation unit 111 and displayed on the display device 112. The transport display screen 800 includes a conveying speed display area 801 that displays the conveying speed of the conveyor B, a total package count display area 802 that displays the total number of workpieces W transported so far, and an operation elapsed time display area 803 that displays the operating time of the code reader system S.

Furthermore, the transport display screen 800 also includes an animation display area 804 that displays the state of the workpiece W being transported in an animation format. The animation display area 804 also displays an animation of the conveyor B. The animation of the conveyor B is generated by the screen generation unit 111 based on the size information of the conveyor B input during setup. The animation displayed in the animation display area 804 may be in color or monochrome.

FIG. 60 shows a case where an animation viewed from above the conveyor B is displayed, but this is not limited to this. Animations showing the conveyor B viewed from the side, from the front, or from an oblique upper angle may also be displayed. Specifically, the transport display screen 800 is provided with a viewpoint switching section 810. The viewpoint switching section 810 includes a left side button 810a for switching the viewpoint to the left side of the conveyor B, a right side button 810b for switching the viewpoint to the right side of the conveyor B, a top button 810c for switching the viewpoint to above the conveyor B, a rear button 810d for switching the viewpoint to the rear of the conveyor B, and a front button 810e for switching the viewpoint to the front of the conveyor B.

When the left side button 810a is operated, the screen generation unit 111 generates an animation viewing the conveyor B and the workpiece W from the left side and displays it in the animation display area 804. When the right side button 810b is operated, the screen generation unit 111 generates an animation viewing the conveyor B and the workpiece W from the right side and displays it in the animation display area 804. When the top button 810c is operated, the screen generation unit 111 generates an animation viewing the conveyor B and the workpiece W from above and displays it in the animation display area 804. When the rear button 810d is operated, the screen generation unit 111 generates an animation viewing the conveyor B and the workpiece W from the rear and displays it in the animation display area 804. When the front button 810e is operated, the screen generation unit 111 generates an animation viewing the conveyor B and the workpiece W from the front and displays it in the animation display area 804.

The animation of the workpiece W is generated by the screen generation unit 111 using the dimensions and relative position information of the workpiece W obtained based on the measurement results of the work sensor 92 or the dimension measurement unit 90. In FIG. 60, the animations of workpieces W1 to W7 are superimposed on the animation of the conveyor B. The animations of workpieces W1 to W7 move at the conveying speed of the conveyor B. It should be noted that the display of workpieces W1 to W7 is just an example, and the number of workpieces W displayed changes according to the conveying status and the supply status of the workpieces W. In the following explanation, for convenience, we will assume a situation where workpieces W1 to W7 are being conveyed.

Furthermore, the transport display screen 800 also includes an information display area 805 where information about workpieces W1 to W7 is displayed. The information display area 805 includes a result determination display section 805a that displays the decode results of the codes attached to workpieces W1 to W7. In the result determination display section 805a, the results of the decoding process are displayed in a list format for each of the multiple workpieces W1 to W7 detected by the work sensor 92 or the dimension measurement unit 90. In this embodiment, workpieces W1 to W7 are listed in a vertically aligned format, but this is not limited to such, and they can also be listed in a horizontally aligned format.

The information display area 805 includes a code count display section 805b that displays the number of read codes. The code count display section 805b displays a list of the number of codes read for each of the workpieces W1 to W7, similar to the decoding process results.

The information display area 805 includes a result output display section 805c where the results of the decoding process are displayed as a list of character strings. Additionally, the information display area 805 includes a tracking start time display section 805d that displays the tracking start times for workpieces W1 to W7.

The information display area 805 includes a dimension display section 805e that displays a list of dimensions for each of the workpieces W1 to W7. The dimension display section 805e shows the package length, length, width, and height of workpieces W1 to W7, as well as the spacing (gap between loads) between workpieces W1 to W7 aligned in the conveying direction. The package length refers to, for example, the dimension in the conveying direction of workpieces W2 and W5 that are conveyed in a diagonal state with respect to the conveying direction.

The information display area 805 includes an ID display section 805f that displays a list of IDs (package IDs) of workpieces W1 to W7. The ID display section 805f displays different combinations of numbers, symbols, characters, etc. for each of the workpieces W1 to W7.

The information display area 805 includes a time display section 805g that displays a list of the reading completion times of the codes attached to the workpieces W1 to W7.

The user can confirm the reading stability of the code attached to any arbitrary workpiece among the multiple workpieces W1 to W7 displayed on the transport display screen 800. Specifically, the transport display screen 800 is a list screen that displays a list of the decoding process results of the codes attached to the multiple workpieces W1 to W7, and accepts the selection of one workpiece as the target for confirming the reading stability from this list display. For example, this function is effective when a workpiece with a reading result that is an error exists, and the user wants to confirm the reading stability by selecting only that workpiece. It should be noted that the user may also select and confirm the reading stability of workpieces other than those with reading results that are errors.

When the workpiece W1 is an error workpiece, the user confirms the reading stability of the code attached to the workpiece W1. At this time, the user operates the operation unit 302 and selects the animation part of the workpiece W1 displayed in the animation display area 804. Alternatively, the user selects the part where the information of the workpiece W1 is displayed in the information display area 805. In this way, the user's selection operation can be accepted on the transport display screen 800.

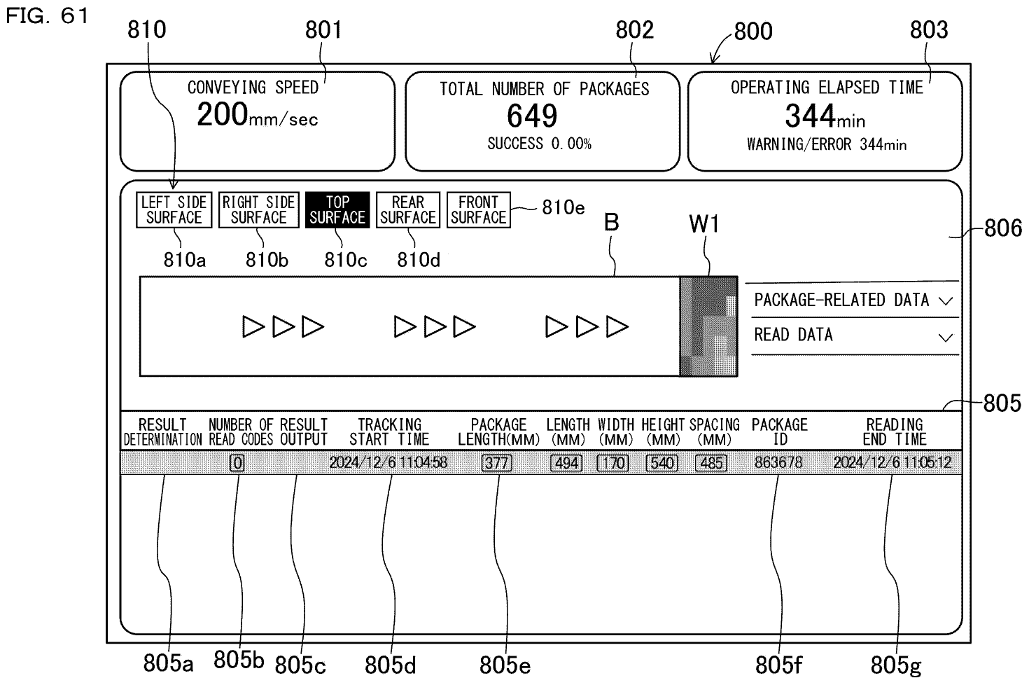

As shown in FIG. 61, the screen generation unit 111 generates a stability display screen 806 for displaying and comparing information indicating the reading stability of a selected workpiece (in this example, workpiece W1) and displays it on the display device 112.

Specifically, the screen generation unit 111 generates a stability display screen 806 that displays the reading stability for each surface of workpiece W1 in a heat map format on the display device 112. In the heat map format, each surface of workpiece W1 can be displayed colored according to the reading stability, with colors or brightness varying based on the stability. For example, each surface of workpiece W1 can be divided into grid cells, and each cell can be colored according to the reading stability, displaying the reading stability in a so-called mosaic format. The heat map may be such that the color becomes darker as the reading stability increases, or it may be such that the color becomes darker as the reading stability decreases. In addition to heat maps based on color density, heat maps based on differences in saturation may also be used. Note that comparison includes not only contrasting the reading stability of multiple locations but also showing the differences.

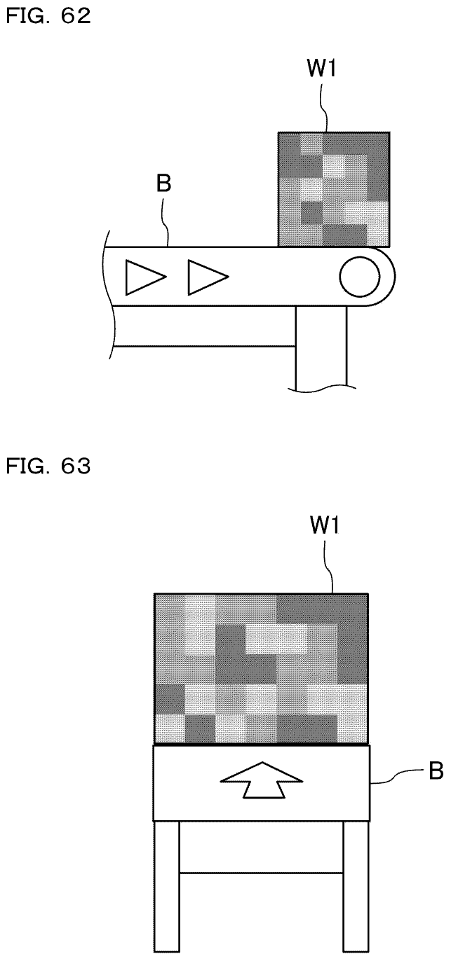

When the right side button 810b is operated, for example, with the workpiece W1 selected, as shown in FIG. 62, the screen generation unit 111 generates a stability display screen 806 including an animation viewing the workpiece W1 and the conveyor B from the right side, and displays it on the display device 112. Also, when the rear button 810d is operated, for example, with the workpiece W1 selected, as shown in FIG. 63, the screen generation unit 111 generates a stability display screen 806 including an animation viewing the workpiece W1 and the conveyor B from the rear, and displays it on the display device 112. In this way, the user can grasp the reading stability of each surface of the workpiece W1.

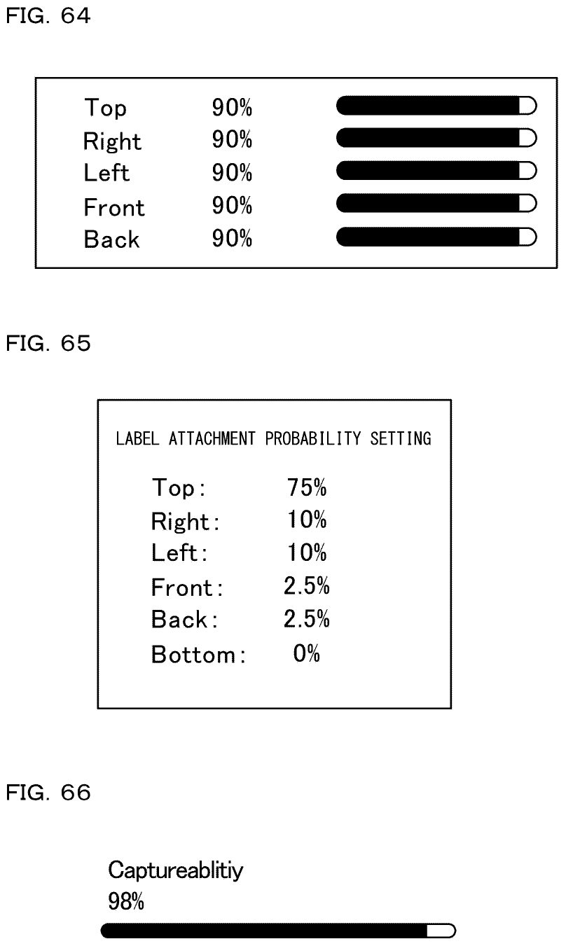

The output unit 109 can also output an estimated reading probability per workpiece W based on probability information indicating the probability that a code is attached to each surface of the workpiece W, and information indicating the reading stability for each surface of the workpiece W. FIG. 64 is an example of information indicating the reading stability of codes attached to each surface of the workpiece W. As shown, the output unit 109 can obtain the reading stability for each of the top surface, right side surface, left side surface, front surface, and rear surface of the workpiece W. The output unit 109 may also obtain the reading stability for the bottom surface, or it may obtain the reading stability for only some of the surfaces rather than all surfaces.

FIG. 65 is an example of probability information showing the probability that a code (label) is attached to each surface of the workpiece W. The output unit 109 acquires the probability that a code is attached to each of the top surface, right side surface, left side surface, front surface, rear surface, and bottom surface of the workpiece W based on user settings. Alternatively, it may be configured to set the probability that a code is attached only for the surfaces for which the above-mentioned reading stability is obtained, rather than for all surfaces. In either case, the user may be made to set each probability so that the total of the probabilities set by the user becomes 100%, or the probabilities may be automatically adjusted to maintain the ratio while making the total 100%.

FIG. 66 shows an example of displaying the estimated reading probability per workpiece W. The output unit 109 acquires the reading stability for each of the top surface, right side surface, left side surface, front surface, and rear surface of the workpiece W, as well as the probability that a code is attached to each of the top surface, right side surface, left side surface, front surface, rear surface, and bottom surface of the workpiece W. Based on these, it calculates the estimated reading probability per workpiece W. In the case of the examples shown in FIG. 64 and FIG. 65, it calculates 0.9×0.75 for the top surface of the workpiece W, 0.9×0.1 for the right side surface of the workpiece W, 0.9×0.1 for the left side surface of the workpiece W, 0.9×0.025 for the front surface of the workpiece W, 0.9×0.025 for the rear surface of the workpiece W, and 0×0 for the bottom surface of the workpiece W. By adding these, the estimated reading probability per workpiece W can be calculated.

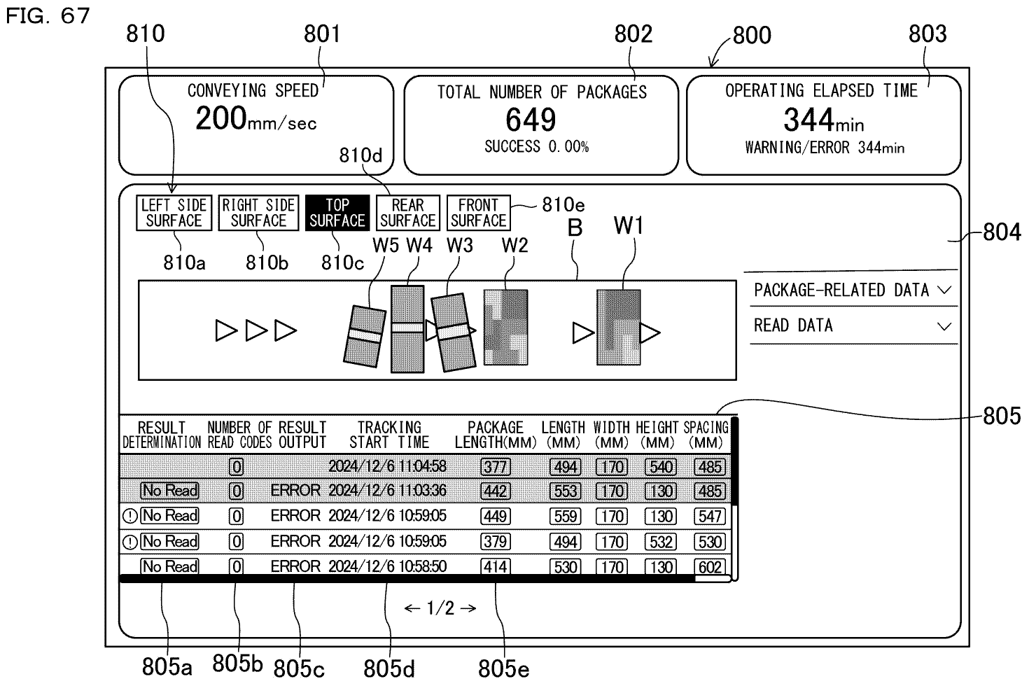

As shown in FIG. 67, the transport display screen 800 can also accept the selection of multiple workpieces for confirming reading stability from the list display of decoding process results for codes attached to multiple workpieces W1 to W5. Even if multiple workpieces W are similar, the reading stability may differ due to differences in the size of workpieces W before and after or gaps between loads. In such cases, by accepting the selection of multiple workpieces, the reading stability of each workpiece can be confirmed.

When the user performs an operation to select, for example, workpiece W1 and workpiece W2, the screen generation unit 111 generates a stability display screen 806 for comparing and displaying information indicating the reading stability of each surface of the two workpieces W1 and W2, and displays it on the display device 112. The number of selectable workpieces is not limited to two, and it is possible to select three or more workpieces. In this case, the screen generation unit 111 generates a stability display screen 806 for comparing and displaying information indicating the reading stability of each surface of the three or more selected workpieces, and displays it on the display device 112. Also, when multiple workpieces are selected, animations viewed from the side, front, and rear may be displayed, similar to when a single workpiece is selected.

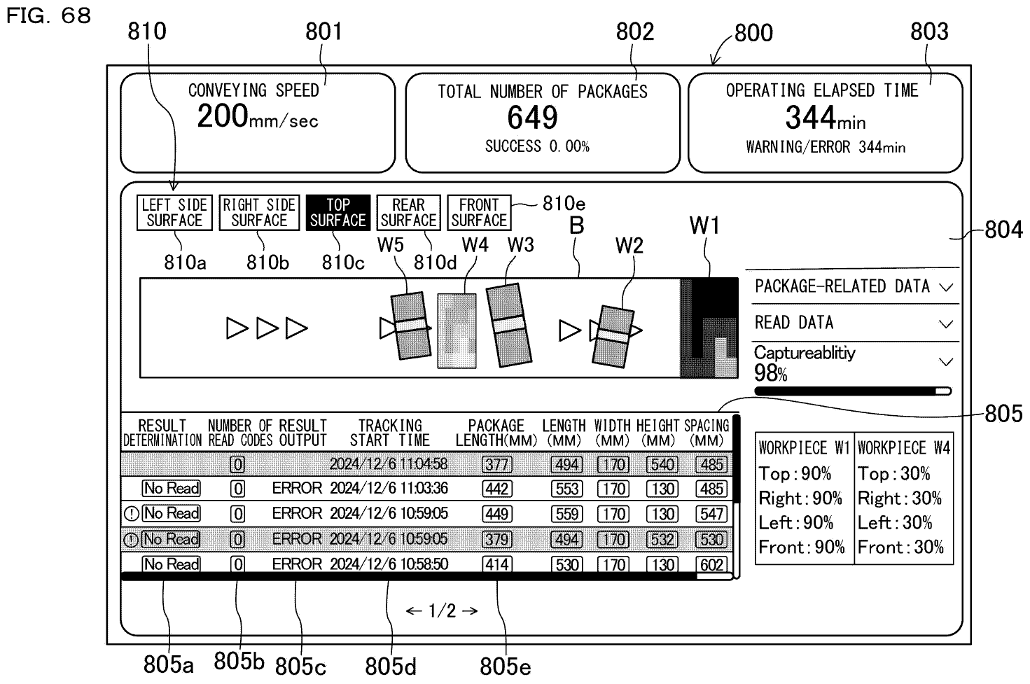

FIG. 68 shows a case where a workpiece W4 with a narrow gap between loads is being transported. In FIG. 68, the user has selected workpiece W1 and workpiece W4 with a narrow gap between loads. This allows for the display and comparison of information indicating the reading stability of each surface of workpiece W1 and workpiece W4. Since workpiece W4 has narrow gaps between loads both in front and behind, its reading stability is lower compared to workpiece W1, and therefore, it is displayed in a lighter color than workpiece W1. In this case, workpiece W4 becomes an error work.

In addition, in the example shown in FIG. 68, the reading stability of the codes attached to each surface of workpieces W1 and W4 can be displayed in the information display area 805. The user can confirm the reading stability of each surface of workpieces W1 and W4, and based on the results, consider countermeasures such as widening the gap between loads to improve the reading stability.

The output unit 109 can also output the reading stability of error workpieces for which decoding process has failed, associating it with error information estimated according to the magnitude of the reading stability. The error information indicates that there is an abnormality in the code attached to the workpiece W when the score is high and the reading stability is above a predetermined value. In other words, if the decoding process fails despite high reading stability, it is highly likely that there is no code on the workpiece W, or the code has become unreadable due to some reason. In such cases, information indicating that there is an abnormality in the code attached to the workpiece W is associated with the error workpiece as error information. This allows the user to infer that the cause of the error is an abnormality in the code.

Furthermore, as another error information, when the reading stability is less than a predetermined value, it may be information indicating that there is an abnormality in the conveyor B, or that the conveying speed of the conveyor B is inappropriate. In other words, if the reading stability is low, it can be considered that the transport state of the workpiece W is poor, and as a cause of this, a malfunction of the conveyor B can be cited. Therefore, information indicating that there is an abnormality in the conveyor B, or that the conveying speed of the conveyor B is inappropriate, is associated with the error work as error information. This allows the user to infer that there is an abnormality in the conveyor B as the cause of the error.

In the above example, although the same symbol (e.g., W1) is used to illustrate workpieces in different figures, it does not necessarily indicate the same workpiece common to each figure, but rather serves as an example for each individual figure.

Furthermore, in a scene where actual workpieces are transported, for workpieces other than rectangular parallelepiped shapes such as delivery bags, each surface can be identified as, for example, a circumscribed rectangular parallelepiped of the workpiece.

### INDUSTRIAL APPLICABILITY

As explained above, the present invention can be utilized in sites where workpieces are transported, for example, by conveyors or the like.

Further features of the embodiment related to this disclosure are defined by the following numbered statements:

### [Item 1]

A code reader system that reads codes attached to workpieces conveyed on a conveyor, comprising:
one or more cameras that capture images of the workpieces to generate at least one image;
a controller connected to the one or more cameras and acquiring the at least one image,
wherein the controller:
identifies at least one surface of multiple surfaces of the workpiece in the at least one image based on coordinate transformation coefficients between an imaging coordinate system of the one or more cameras and a conveyor coordinate system,
measures, based on the at least one image, evaluation data including at least one of
capture information including at least one of an area of a captured region within the at least one surface and a number of times the at least one surface was captured by the one or more cameras, and
information related to reading the code attached to the at least one surface, and
outputs information indicating reading stability for each of the at least one surface of the workpiece using the one or more cameras based on the evaluation data.

### [Item 2]

The code reader system according to Item 1,
wherein the controller outputs the information indicating the reading stability after all imaging of the workpiece by the one or more cameras is completed.

### [Item 3]

The code reader system according to Item 1,
wherein the controller outputs the information indicating the reading stability each time the workpiece is captured by the one or more cameras.

### [Item 4]

The code reader system according to Item 1, further comprising:
a simulation execution unit that executes a simulation of the code reader system;
an input acceptance unit that accepts input information for the simulation from a user, including installation conditions of the one or more cameras and conveying conditions of the workpiece,
wherein the simulation execution unit:
conveys a virtual workpiece having multiple surfaces based on the conveying conditions,
obtains an existence area of the virtual workpiece in a virtual image when the virtual workpiece is captured by one or more virtual cameras virtually installed based on the installation conditions,
identifies at least one surface of the multiple surfaces of the virtual workpiece in the virtual image based on coordinate transformation coefficients between an imaging coordinate system of the one or more virtual cameras and a virtual conveyor coordinate system,
measures, based on at least one virtual image, evaluation data including at least one of
capture information including at least one of an area of a region captured within the at least one surface and a number of times the at least one surface was captured by the one or more virtual cameras, and
information related to reading the code attached to the at least one surface, and
outputs information indicating a reading stability for each of the at least one surface of the virtual workpiece using the one or more virtual cameras based on the evaluation data.

### [Item 5]

The code reader system according to Item 1,
wherein the controller:
divides the at least one surface of the workpiece into multiple grid cells,
measures the area based on the number of grid cells captured by the one or more cameras.

### [Item 6]

The code reader system according to Item 1,
wherein the information related to reading the code includes at least one of a reading margin when decoding of the code is successful, a number of matches of decoding results based on multiple images including the code, a contrast of the code, and a PPC indicating the number of pixels constituting each module of the code.

### [Item 7]

The code reader system according to Item 1,
wherein the controller:
divides the at least one surface of the workpiece into multiple grid cells,
measures the number of times captured by the one or more cameras for each grid cell.

### [Item 8]

The code reader system according to Item 1,
wherein the controller:
outputs information indicating the reading stability of the at least one surface based on the area of the captured region of the at least one surface of the workpiece in the image and the number of times captured.

### [Item 9]

The code reader system according to Item 8,
wherein the controller:
divides at least the one surface of the workpiece into multiple grid cells,
measures the area based on the number of grid cells captured by the one or more cameras,
measures the number of times captured by the one or more cameras for each grid cell, outputs information indicating the reading stability of the at least one surface based on the area and the number of times.

### [Item 10]

The code reader system according to Item 1, further comprising:
a screen generation unit that generates a screen to display the reading stability of the at least one surface on a display device.

### [Item 11]

The code reader system according to Item 1,
wherein the controller outputs a reading error when the reading stability is less than a predetermined value.

### [Item 12]

The code reader system according to Item 1,
wherein the controller:
divides the at least one surface of the workpiece into multiple grid cells,
calculates a PPC indicating the number of pixels constituting each module of the code for each grid cell, and
measures the capture information excluding grid cells where the PPC is less than a predetermined value.

### [Item 13]

A method for estimating reading stability of a code reader system that reads codes attached to workpieces conveyed on a conveyor, comprising:
a step of acquiring at least one image by capturing the workpiece with one or more cameras;
a step of identifying at least one surface of multiple surfaces of the workpiece in the at least one image based on coordinate transformation coefficients between an imaging coordinate system of the one or more cameras and a conveyor coordinate system;
a step of measuring evaluation data, based on the at least one image, including at least one of
capture information including at least one of an area of a region captured within the at least one surface and a number of times the at least one surface was captured by the one or more cameras, and
information related to reading the code attached to the at least one surface; and
a step of outputting information indicating reading stability for each of the at least one surface of the workpiece using the one or more cameras based on the evaluation data.

What is claimed is:

1. A code reader system for reading a code attached to a workpiece conveyed on a conveyor, comprising:
one or more sensors that detect the workpiece and measure dimensions of the workpiece;
one or more cameras that capture at least one image of the workpiece;
a decoding unit that performs decoding processing on the at least one image;
an output unit that outputs information indicating a reading stability for each surface of the workpiece using the one or more cameras, based on installation information of the one or more sensors, installation information of the one or more cameras, conveying speed of the conveyor, and the dimensions of the workpiece;
a screen generation unit that generates a screen to be displayed on a display device, showing results of the decoding processing of the code attached to the workpiece and the information indicating the reading stability for each surface of the workpiece.

2. The code reader system according to claim 1, wherein
the screen generation unit generates a screen that displays the reading stability for each surface of the workpiece in a heat map format on the display device.

3. The code reader system according to claim 1, wherein
the screen generation unit generates
a list screen that displays a list of the results of the decoding processing for multiple workpieces detected by the one or more sensors, and accepts selection of one workpiece for confirming the reading stability from the list screen, and
a screen for displaying information indicating the reading stability of the one workpiece.

4. The code reader system according to claim 1, wherein
the screen generation unit generates
a list screen that displays a list of the results of the decoding processing for multiple workpieces detected by the one or more sensors, and accepts selection of at least two workpieces for confirming the reading stability from the list screen, and
a screen for comparing and displaying information indicating the reading stability of the at least two workpieces.

5. The code reader system according to claim 1, wherein
the output unit outputs an estimated reading probability per workpiece based on probability information indicating probability that a code is attached to each surface of the workpiece and information indicating the reading stability for each surface of the workpiece.

6. In the code reader system according to claim 1, wherein
the output unit outputs the reading stability of an error workpiece for which the decoding processing failed, associating with error information estimated according to a magnitude of the reading stability.

7. The code reader system according to claim 6, wherein
the error information is information indicating that there is an abnormality in the code attached to the workpiece when the reading stability is equal to or greater than a predetermined value.

8. The code reader system according to claim 6, wherein
the error information is information indicating that there is an abnormality in the conveyor or that the conveying speed of the conveyor is inappropriate when the reading stability is less than a predetermined value.

9. The code reader system according to claim 1, wherein
the output unit outputs information indicating the reading stability based on at least one of capture information and information related to reading the code attached to at least one surface, and
the capture information includes at least one of an area of a region captured within the at least one surface and a number of times the at least one surface was captured by the one or more cameras.

10. The code reader system according to claim 9, wherein
the output unit calculates the area of the region and the number of times captured based on an image actually captured by the one or more cameras.

11. The code reader system according to claim 9, wherein
the output unit calculates the area of the region and the number of times imaging captured based on the installation information of the one or more sensors, the installation information of the one or more cameras, the conveying speed of the conveyor, and the dimensions of the workpiece.

12. A method for estimating reading stability of a code reader system that reads codes attached to a workpiece conveyed on a conveyor, the method comprising:
a step in which one or more sensors detect the workpiece and measure dimensions of the workpiece;
a step in which one or more cameras capture the workpiece and generate at least one image;
a step in which an output unit outputs information indicating the reading stability using the one or more cameras for each surface of the workpiece, based on installation information of the one or more sensors, installation information of the one or more cameras, conveying speed of the conveyor, and dimensions of the workpiece; and
a step in which a screen generation unit generates a screen to be displayed on a display device, showing results of decoding processing of the code attached to the workpiece and information indicating the reading stability for each surface of the workpiece.

13. A simulation device that performs a simulation of a code reader system that reads codes attached to workpieces conveyed on a conveyor using one or more cameras, comprising:
an input acceptance unit that accepts input information for the simulation from a user, including installation conditions of the one or more cameras and transport conditions of the workpieces;
a control unit that executes the simulation based on the input information accepted by the input acceptance unit;
wherein the control unit:
transports a virtual workpiece having multiple surfaces based on the transport conditions,
obtains an existence area of the virtual workpiece in a virtual image when captured by one or more virtual cameras virtually installed based on the installation conditions,
identifies at least one surface of the multiple surfaces of the virtual workpiece in the virtual image based on coordinate transformation coefficients between an imaging coordinate system of the one or more virtual cameras and a virtual conveyor coordinate system,
measures, based on at least one virtual image, evaluation data including at least one of
capture information comprising at least one of an area of a region captured within the at least one surface and a number of times the at least one surface was captured by the one or more virtual cameras, and
information related to reading a virtual code attached to the at least one surface, and
outputs information indicating a reading stability using the one or more virtual cameras for each of the at least one surface of the virtual workpiece based on the evaluation data.

14. The simulation device according to claim 13, wherein
the control unit outputs information indicating the reading stability each time the virtual workpiece is captured by the one or more virtual cameras.

15. The simulation device according to claim 13, wherein
the control unit:
divides the at least one surface of the virtual workpiece into multiple grid cells, and measures the area based on the number of grid cells captured by the one or more virtual cameras.

16. The simulation device according to claim 13, wherein
the control unit:
divides the at least one surface of the virtual workpiece into multiple grid cells, and measures the number of times captured by the one or more virtual cameras for each grid cell.

17. The simulation device according to claim 13, wherein
the control unit:
outputs information indicating the reading stability of the at least one surface based on the area of the captured region of the virtual workpiece in the virtual image and the number of times captured.

18. The simulation device according to claim 13, further comprising:
a screen generation unit that generates a screen for displaying the reading stability of the at least one surface on a display device.

19. The simulation device according to claim 13, wherein
the control unit:
divides the at least one surface of the virtual workpiece into multiple grid cells,
calculates a PPC indicating the number of pixels constituting each module of the code for each grid cell, and
measures capture information excluding grid cells where the PPC is less than a predetermined value.
